(19) United States
(12) Patent Application Publication
(10) Pub. No.: US 2024/0019715 A1
(43) Pub. Date: Jan. 18, 2024

(54) AIR FLOATING VIDEO DISPLAY APPARATUS

(71) Applicant: Maxell, Ltd., Kyoto (JP)

(72) Inventors: Katsuyuki WATANABE, Kyoto (JP); Takuya SHIMIZU, Kyoto (JP); Koji HIRATA, Kyoto (JP); Koji FUJITA, Kyoto (JP); Toshinori SUGIYAMA, Kyoto (JP)

(73) Assignee: Maxell, Ltd., Kyoto (JP)

(21) Appl. No.: 18/268,329

(22) PCT Filed: Dec. 13, 2021
(86) PCT No.: PCT/JP2021/045901

§ 371 Date: Jun. 20, 2023

(30) Foreign Application Priority Data
Dec. 21, 2020 (JP) 2020-211142
Jun. 30, 2021 (JP) 2021-109317

(51) Int. Cl. G02B 30/56; G06F 3/01

(52) U.S. Cl. CPC G02B 30/56; G06F 3/011; G06F 3/016

(57) ABSTRACT

An air floating video display apparatus includes a display apparatus configured to display a video, a retroreflector configured to reflect video light from the display apparatus and form an air floating video in air by the reflected light, a sensor configured to detect a touch operation by a finger of a user on one or more objects displayed in the air floating video, and a controller. When the user performs the touch operation on the object, the controller assists the touch operation for the user based on a detection result of the touch operation by the sensor.

### TECHNICAL FIELD

The present invention relates to an air floating video display apparatus.

### BACKGROUND ART

As an air floating information display system, a video display apparatus configured to display a video directly toward the outside and a display method for displaying a video as a space screen have already been known. Further, for example, Patent Document 1 discloses a detection system for reducing erroneous detection of operations on an operation plane of a displayed space image.

### RELATED ART DOCUMENTS

### Patent Documents

Patent Document 1: Japanese Unexamined Patent Application Publication No. 2019-128722

### SUMMARY OF THE INVENTION

### Problems to be Solved by the Invention

However, the touch operation on the air floating video is not performed on a physical button, touch panel, or the like. Therefore, the user may not be able to recognize whether the touch operation has been made in some cases.

An object of the present invention is to provide a more favorable air floating video display apparatus.

### Means for Solving the Problems

In order to solve the problem described above, for example, the configuration described in claims is adopted. Although this application includes a plurality of means for solving the problem, one example thereof can be presented as follows. That is, an air floating video display apparatus includes: a display apparatus configured to display a video; a retroreflector configured to reflect video light from the display apparatus and form an air floating video in air by the reflected light; a sensor configured to detect a position of a finger of a user who performs a touch operation on one or more objects displayed in the air floating video; and a controller, and the controller controls video processing on the video displayed on the display apparatus based on the position of the finger of the user detected by the sensor, thereby displaying a virtual shadow of the finger of the user on a display plane of the air floating video having no physical contact surface.

### Effects of the Invention

According to the present invention, it is possible to realize a more favorable air floating video display apparatus. Other problems, configurations, and effects will become apparent in the following description of embodiments.

### BRIEF DESCRIPTIONS OF THE DRAWINGS

FIG. 1A is a diagram showing an example of usage form of an air floating video display apparatus according to one embodiment of the present invention;

FIG. 1B is a diagram showing an example of usage form of the air floating video display apparatus according to one embodiment of the present invention;

FIG. 2A is a diagram showing an example of a configuration of a main part and a configuration of a retroreflection portion of the air floating video display apparatus according to one embodiment of the present invention;

FIG. 2B is a diagram showing an example of a configuration of a main part and a configuration of a retroreflection portion of the air floating video display apparatus according to one embodiment of the present invention;

FIG. 3A is a diagram showing an example of a method of installing the air floating video display apparatus;

FIG. 3B is a diagram showing another example of a method of installing the air floating video display apparatus;

FIG. 3C is a diagram showing a configuration example of the air floating video display apparatus;

FIG. 4 is a diagram showing another example of the configuration of the main part of the air floating video display apparatus according to one embodiment of the present invention;

FIG. 5 is an explanatory diagram for describing the function of a sensing apparatus used in the air floating video display apparatus;

FIG. 6 is an explanatory diagram of the principle of a three-dimensional video display used in the air floating video display apparatus;

FIG. 7 is an explanatory diagram of a measurement system for evaluating the characteristics of a reflective polarizing plate;

FIG. 8 is a characteristic diagram showing transmittance characteristics of a transmission axis of the reflective polarizing plate with respect to a light beam incident angle;

FIG. 9 is a characteristic diagram showing transmittance characteristics of a reflection axis of the reflective polarizing plate with respect to a light beam incident angle;

FIG. 10 is a characteristic diagram showing transmittance characteristics of a transmission axis of the reflective polarizing plate with respect to a light beam incident angle;

FIG. 11 is a characteristic diagram showing transmittance characteristics of a reflection axis of the reflective polarizing plate with respect to a light beam incident angle;

FIG. 12 is a cross-sectional view showing an example of a specific configuration of a light source apparatus;

FIG. 13 is a cross-sectional view showing an example of a specific configuration of the light source apparatus;

FIG. 14 is a cross-sectional view showing an example of a specific configuration of the light source apparatus;

FIG. 15 is a layout drawing showing a main part of the air floating video display apparatus according to one embodiment of the present invention;

FIG. 16 is a cross-sectional view showing a configuration of a display apparatus according to one embodiment of the present invention;

FIG. 17 is a cross-sectional view showing an example of a specific configuration of the light source apparatus;

FIG. 18A is a cross-sectional view showing an example of a specific configuration of the light source apparatus;

FIG. 18B is a cross-sectional view showing an example of a specific configuration of the light source apparatus;

FIG. 19A is a cross-sectional view showing an example of a specific configuration of the light source apparatus;

FIG. 19B is a cross-sectional view showing an example of a specific configuration of the light source apparatus;

FIG. 20 is an explanatory diagram for describing light source diffusion characteristics of the video display apparatus;

FIG. 21A is an explanatory diagram for describing diffusion characteristics of the video display apparatus;

FIG. 21B is an explanatory diagram for describing diffusion characteristics of the video display apparatus;

FIG. 22A is an explanatory diagram for describing diffusion characteristics of the video display apparatus;

FIG. 22B is an explanatory diagram for describing diffusion characteristics of the video display apparatus;

FIG. 23 is a cross-sectional view showing a configuration of the video display apparatus;

FIG. 24 is an explanatory diagram for describing the principle of generation of a ghost image in a conventional technique;

FIG. 25 is a cross-sectional view showing the configuration of the display apparatus according to one embodiment of the present invention;

FIG. 26 is a diagram for describing a display example on the display apparatus according to one embodiment of the present invention;

FIG. 27A is a diagram for describing an example of a method of assisting a touch operation using a virtual shadow;

FIG. 27B is a diagram for describing the example of the method of assisting the touch operation using the virtual shadow;

FIG. 28A is a diagram for describing the example of the method of assisting the touch operation using the virtual shadow;

FIG. 28B is a diagram for describing the example of the method of assisting the touch operation using the virtual shadow;

FIG. 29A is a diagram for describing the example of the method of assisting the touch operation using the virtual shadow;

FIG. 29B is a diagram for describing the example of the method of assisting the touch operation using the virtual shadow;

FIG. 30A is a diagram for describing another example of the method of assisting the touch operation using the virtual shadow;

FIG. 30B is a diagram for describing the example of the method of assisting the touch operation using the virtual shadow;

FIG. 31A is a diagram for describing the example of the method of assisting the touch operation using the virtual shadow;

FIG. 31B is a diagram for describing the example of the method of assisting the touch operation using the virtual shadow;

FIG. 32A is a diagram for describing the example of the method of assisting the touch operation using the virtual shadow;

FIG. 32B is a diagram for describing the example of the method of assisting the touch operation using the virtual shadow;

FIG. 33 is a diagram for describing a setting method of a virtual light source;

FIG. 34 is a configuration diagram showing an example of a method of detecting a position of a finger;

FIG. 35 is a configuration diagram showing another example of the method of detecting the position of the finger;

FIG. 36 is a configuration diagram showing still another example of the method of detecting the position of the finger;

FIG. 37 is a diagram for describing a method of assisting a touch operation by displaying an input content;

FIG. 38 is a diagram for describing a method of assisting a touch operation by highlighting an input content;

FIG. 39 is a diagram for describing an example of a method of assisting a touch operation by vibration;

FIG. 40 is a diagram for describing another example of the method of assisting the touch operation by vibration;

FIG. 41 is a diagram for describing still another example of the method of assisting the touch operation by vibration;

FIG. 42A is a diagram for describing a display example of an air floating video according to one embodiment of the present invention;

FIG. 42B is a diagram for describing a display example of the air floating video according to one embodiment of the present invention;

FIG. 43 is a diagram for describing a configuration example of the air floating video display apparatus according to one embodiment of the present invention;

FIG. 44 is a diagram for describing a configuration example of a part of the air floating video display apparatus according to one embodiment of the present invention;

FIG. 45 is a diagram for describing a display example of the air floating video according to one embodiment of the present invention; and

FIG. 46 is a diagram for describing a configuration example of the air floating video display apparatus according to one embodiment of the present invention.

### DETAILED DESCRIPTION OF PREFERRED EMBODIMENTS

Hereinafter, embodiments of the present invention will be described in detail with reference to the drawings. Note that the present invention is not limited to the described embodiments, and various changes and modifications can be made by those skilled in the art within the scope of the technical idea disclosed in this specification. In all the drawings for describing the present invention, components having the same function are denoted by the same reference characters, and description thereof is not repeated in some cases. In the following description of the embodiments, a video floating in the air is expressed by the term “air floating video”. Instead of this term, expressions such as “aerial image”, “space image”, “aerial floating video”, “air floating optical image of a display image”, “aerial floating optical image of a display image”, etc. may be used. The term “air floating video” mainly used in the description of the embodiments is used as a representative example of these terms.

The following embodiments relate to a video display apparatus capable of transmitting a video by video light from a video light emitting source through a transparent member partitioning a space such as glass and displaying the video as an air floating video outside the transparent member.

According to the following embodiments, for example, it is possible to realize an air floating video display apparatus suitable for an ATM of a bank, a ticket vending machine of a station, a digital signage, or the like. For example, at present, though a touch panel is generally used in an ATM of a bank, a ticket vending machine of a station, or the like, it becomes possible to display high-resolution video information above a transparent glass surface or a light-transmitting plate material in a state of floating in space by using the glass surface or the light-transmitting plate material. At this time, by making the divergence angle of the emitted video light small, that is, an acute angle, and further aligning the video light with a specific polarized wave, only the normal reflected light is efficiently reflected with respect to the retroreflector, so that the light utilization efficiency can be increased, the ghost image which is generated in addition to the main air floating image and is a problem in the conventional retroreflective system can be suppressed, and a clear air floating video can be obtained. Also, with the apparatus including the light source of the present embodiment, it is possible to provide a novel and highly usable air floating video display apparatus (air floating video display system) capable of significantly reducing power consumption. Further, it is also possible to provide an air floating video display apparatus for vehicle capable of displaying a so-called unidirectional air floating video which can be visually recognized inside and/or outside the vehicle. Incidentally, in any of the following embodiments, a plate-like member may be used as the retroreflector. In this case, it may be expressed as a retroreflection plate.

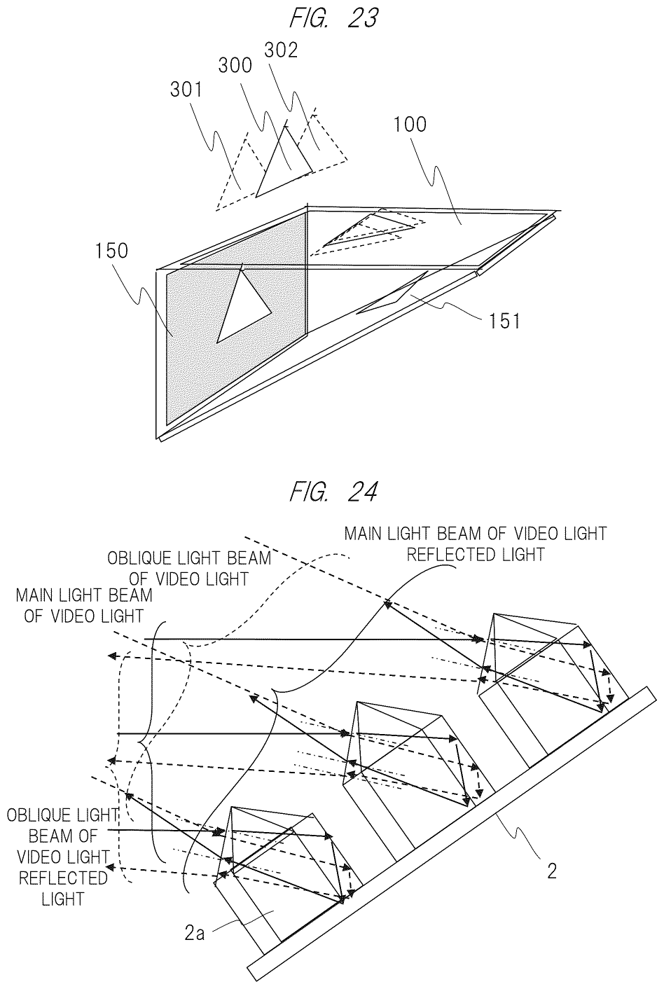

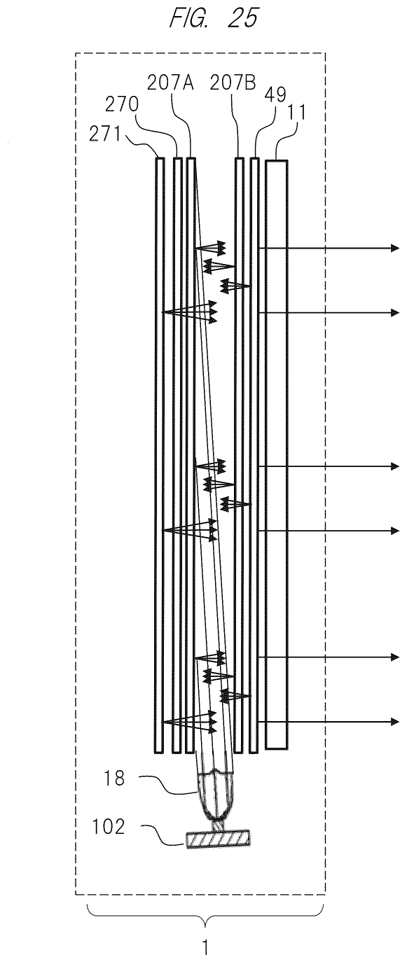

On the other hand, in the conventional technique, an organic EL panel or a liquid crystal panel is combined as a high-resolution color display video source 150 with a retroreflector 151. In the conventional technique, since video light is diffused at a wide angle, ghost images 301 and 302 are generated by the video light obliquely entering a retroreflector 2a as shown in FIG. 24 in addition to the reflection light normally reflected by the retroreflector 151, thereby deteriorating the image quality of the air floating video. Further, as shown in FIG. 23, multiple images such as the first ghost image 301 and the second ghost image 302 are generated in addition to a normal air floating video 300. Therefore, the ghost image similar to the air floating video is monitored by a person other than an observer, and there is a significant problem in terms of security.

<Air Floating Video Display Apparatus>

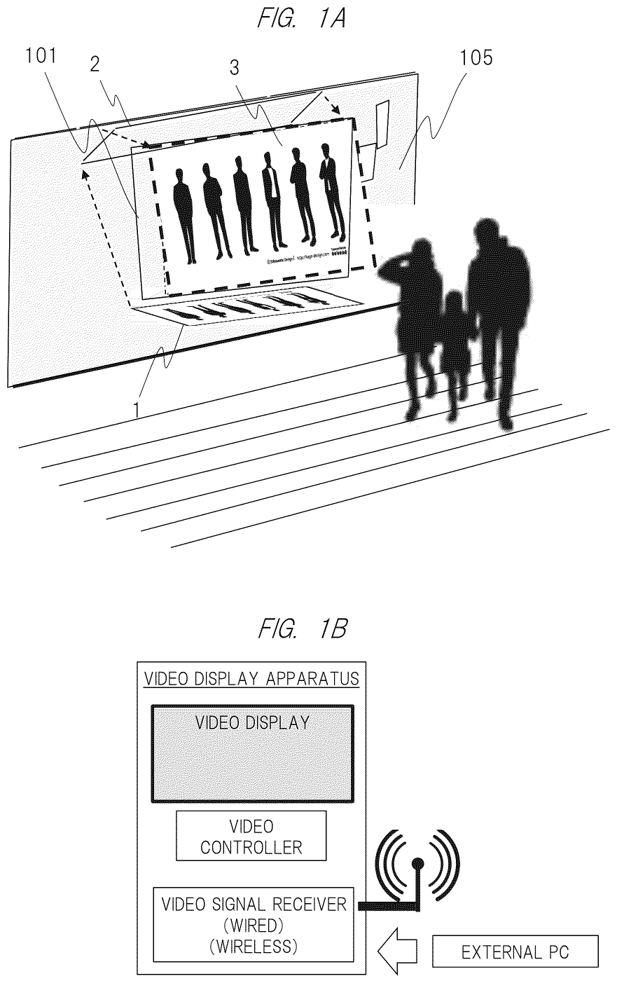

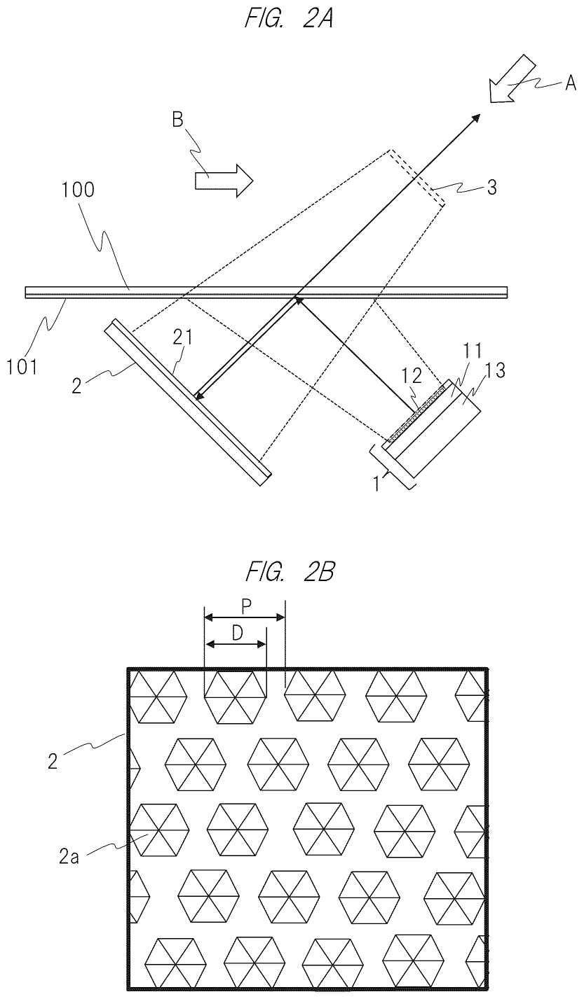

FIG. 1A and FIG. 1B are diagrams showing an example of usage form of an air floating video display apparatus according to one embodiment of the present invention, and are diagrams showing an entire configuration of the air floating video display apparatus according to the present embodiment. Although a specific configuration of the air floating video display apparatus will be described in detail with reference to FIG. 2A, FIG. 2B, and the like, light of a specific polarized wave with narrow-angle directional characteristics is emitted from a video display apparatus 1 as a video light flux, once enters a retroreflector 2, is retroreflected and passes through a transparent member 100 (glass or the like), thereby forming an aerial image (air floating video 3) which is a real image on the outside of the glass surface.

In a store or the like, a space is partitioned by a show window (referred to also as “window glass”) 105 which is a translucent member such as glass. With the air floating video display apparatus of the present embodiment, the floating video can be displayed in one direction to the outside and/or the inside of the store (space) through such a transparent member.

In FIG. 1A, the inner side of the window glass 105 (the inside of the store) is shown in the depth direction, and the outer side thereof (e.g., a sidewalk) is shown on the front side. On the other hand, it is also possible to form an aerial image at a desired position in the store by reflecting the light with a reflector configured to reflect a specific polarized wave provided on the window glass 105.

FIG. 1B is a schematic block diagram showing a configuration of the display apparatus 1 described above. The display apparatus 1 includes a video display configured to display an original image of an aerial image, a video controller configured to convert an input video in accordance with the resolution of a panel, and a video signal receiver configured to receive a video signal. The video signal receiver is configured to handle signals input via a wired communication such as HDMI (High-Definition Multimedia Interface) input and signals input via a wireless communication such as Wi-Fi (Wireless Fidelity), can function independently as a video receiver/display, and can also display video information from a tablet, a smartphone, and the like. Further, if a stick PC or the like is connected, it can be provided with the capability of calculation processing, video analysis processing, and the like.

FIG. 2A and FIG. 2B are diagrams each showing an example of a configuration of the main part and a configuration of a retroreflection portion of the air floating video display apparatus according to one embodiment of the present invention. The configuration of the air floating video display apparatus will be described more specifically with reference to FIG. 2A and FIG. 2B. As shown in FIG. 2A, the display apparatus 1 which diverges video light of a specific polarized wave at a narrow angle is provided in the oblique direction of the transparent member 100 such as glass. The display apparatus 1 includes a liquid crystal display panel 11 and a light source apparatus 13 configured to generate light of a specific polarized wave having narrow-angle diffusion characteristics.

The video light of the specific polarized wave from the display apparatus 1 is reflected by a polarization separator 101 having a film selectively reflecting the video light of the specific polarized wave and provided on the transparent member 100 (in the drawing, the polarization separator 101 is formed in a sheet shape and is adhered to the transparent member 100), and enters the retroreflector 2. A λ/4 plate 21 is provided on the video light incident surface of the retroreflector 2. The video light passes through the λ/4 plate 21 twice, that is, when the video light enters the retroreflector 2 and when the video light is emitted from the retroreflector 2, whereby the video light is subjected to polarization conversion from the specific polarized wave to the other polarized wave. Here, since the polarization separator 101 which selectively reflects the video light of the specific polarized wave has a property of transmitting the polarized light of the other polarized wave subjected to the polarization conversion, the video light of the specific polarized wave after the polarization conversion transmits through the polarization separator 101. The video light that has transmitted through the polarization separator 101 forms the air floating video 3, which is a real image, on the outside of the transparent member 100.

Note that the light that forms the air floating video 3 is a set of light beams converging from the retroreflector 2 to the optical image of the air floating video 3, and these light beams go straight even after passing through the optical image of the air floating video 3. Therefore, the air floating video 3 is a video having high directivity, unlike diffused video light formed on a screen by a general projector or the like. Therefore, in the configuration of FIG. 2A and FIG. 2B, when the user visually recognizes the air floating video 3 from the direction of an arrow A, the air floating video 3 is visually recognized as a bright video. However, when another person visually recognizes the video from the direction of an arrow B, the air floating video 3 cannot be visually recognized as a video at all. These characteristics are very suitable for use in a system that displays a video requiring high security or a highly confidential video that is desired to be kept secret from a person facing the user.

Note that, depending on the performance of the retroreflector 2, the polarization axes of the video light after reflection are not aligned in some cases. In this case, a part of the video light whose polarization axes are not aligned is reflected by the polarization separator 101 described above and returns to the display apparatus 1. This light is reflected again on the video display surface of the liquid crystal display panel 11 constituting the display apparatus 1, so that a ghost image is generated and the image quality of the air floating image is deteriorated in some cases.

Therefore, in the present embodiment, an absorptive polarizing plate 12 is provided on the video display surface of the display apparatus 1. The video light emitted from the display apparatus 1 is transmitted through the absorptive polarizing plate 12, and the reflected light returning from the polarization separator 101 is absorbed by the absorptive polarizing plate 12, whereby the re-reflection described above can be suppressed. Thus, it is possible to prevent deterioration in image quality due to a ghost image of an air floating image.

The polarization separator 101 described above may be formed of, for example, a reflective polarizing plate or a metal multilayer film that reflects a specific polarized wave.

Then, FIG. 2B shows a surface shape of a retroreflector manufactured by Nippon Carbide Industries Co., Inc. used in this study as the typical retroreflector 2. The light beam that enters regularly arranged hexagonal columns is reflected by the wall surfaces and bottom surfaces of the hexagonal columns and emitted as retroreflected light in a direction corresponding to the incident light, and an air floating video which is a real image is displayed based on the video displayed on the display apparatus 1.

The resolution of the air floating image largely depends on the outer shape D and pitch P of the retroreflection portions of the retroreflector 2 shown in FIG. 2B, in addition to the resolution of the liquid crystal display panel 11. For example, when a 7-inch WUXGA (1920×1200 pixels) liquid crystal display panel is used, even if one pixel (one triplet) is about 80 μm, one pixel of the air floating image is about 300 μm if the diameter D of the retroreflection portion is 240 μm and the pitch is 300 μm, for example. Therefore, the effective resolution of the air floating video is reduced to about ⅓.

Therefore, in order to make the resolution of the air floating video equal to the resolution of the display apparatus 1, it is desired that the diameter and the pitch of the retroreflection portions are close to one pixel of the liquid crystal display panel. On the other hand, in order to suppress the occurrence of moire caused by the retroreflector and the pixels of the liquid crystal display panel, it is preferable to design each pitch ratio so as not to be an integral multiple of one pixel. Further, the shape is preferably arranged such that any one side of the retroreflection portion does not overlap with any one side of one pixel of the liquid crystal display panel.

On the other hand, in order to manufacture the retroreflector at a low cost, the retroreflector may be molded by using the roll press method. Specifically, this is a method of aligning retroreflection portions and shaping the retroreflection portions on a film, in which the retroreflector 2 having a desired shape is obtained by forming a reverse shape of the portion to be shaped on a roll surface, applying an ultraviolet curable resin on a fixing base material, shaping a necessary portion by passing the resin between rolls, and curing the resin by irradiation with ultraviolet rays.

<<Method of Installing Air Floating Video Display Apparatus>>

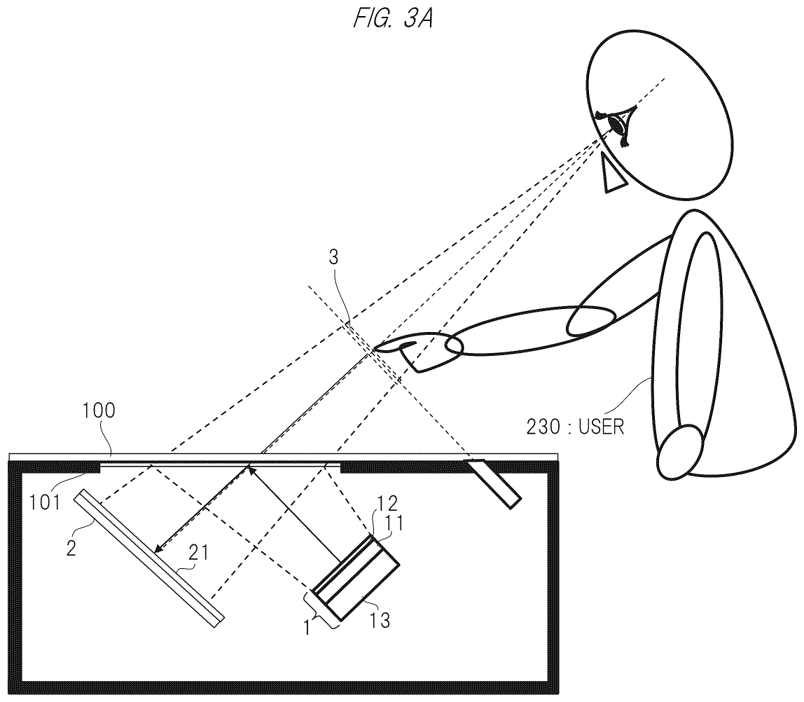

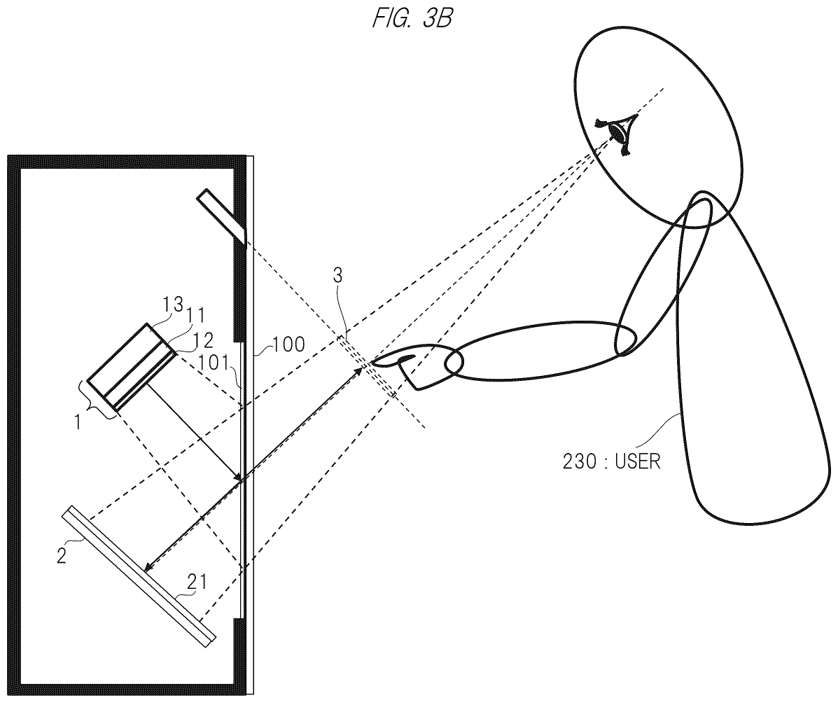

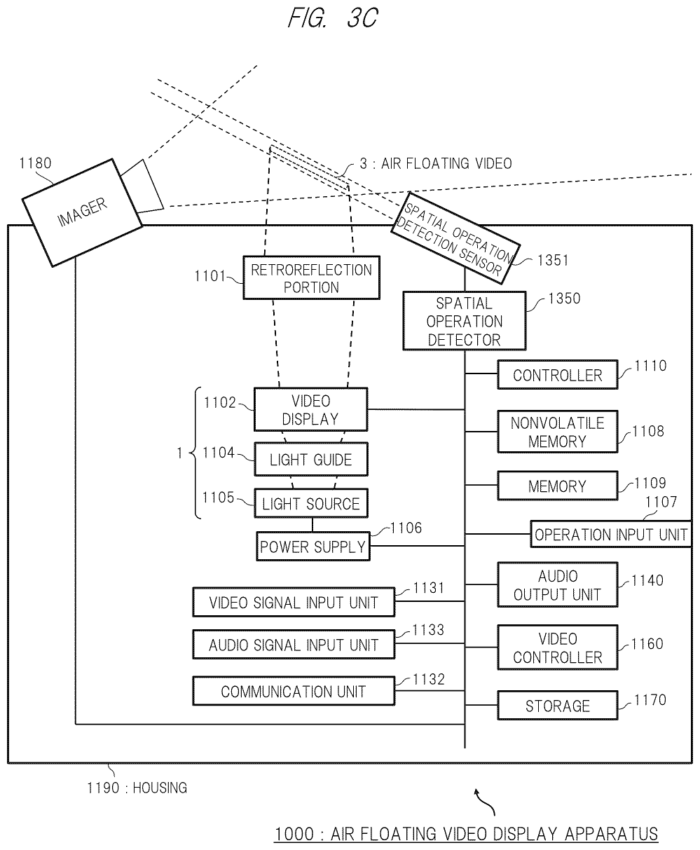

Next, a method of installing the air floating video display apparatus will be described. The installation method of the air floating video display apparatus can be freely changed according to the usage form. FIG. 3A is a diagram showing an example of the method of installing the air floating video display apparatus. The air floating video display apparatus shown in FIG. 3A is installed horizontally such that the surface on the side on which the air floating video 3 is formed faces upward. In other words, in FIG. 3A, the air floating video display apparatus is installed such that the transparent member 100 faces upward, and the air floating video 3 is formed above the air floating video display apparatus.

FIG. 3B is a diagram showing another example of the method of installing the air floating video display apparatus. The air floating video display apparatus shown in FIG. 3B is installed vertically such that the surface on the side on which the air floating video 3 is formed faces sideward (toward a user 230). In other words, in FIG. 3B, the air floating video display apparatus is installed such that the transparent member 100 faces sideward, and the air floating video 3 is formed sideward with respect to the air floating video display apparatus (toward the user 230).

<<Configuration of Air Floating Video Display Apparatus>>

Next, a configuration of an air floating video display apparatus 1000 will be described. FIG. 3C is a block diagram showing an example of an internal configuration of the air floating video display apparatus 1000.

The air floating video display apparatus 1000 includes a retroreflection portion 1101, a video display 1102, a light guide 1104, a light source 1105, a power supply 1106, an operation input unit 1107, a nonvolatile memory 1108, a memory 1109, a controller 1110, a video signal input unit 1131, an audio signal input unit 1133, a communication unit 1132, a spatial operation detection sensor 1351, a spatial operation detector 1350, an audio output unit 1140, a video controller 1160, a storage 1170, an imager 1180, and the like.

Each component of the air floating video display apparatus 1000 is arranged in a housing 1190. Note that the imager 1180 and the spatial operation detection sensor 1351 shown in FIG. 3C may be provided outside the housing 1190.

The retroreflection portion 1101 in FIG. 3C corresponds to the retroreflector 2 in FIG. 2A and FIG. 2B. The retroreflection portion 1101 retroreflects the light modulated by the video display 1102. Of the reflected light from the retroreflection portion 1101, the light output to the outside of the air floating video display apparatus 1000 forms the air floating video 3.

The video display 1102 in FIG. 3C corresponds to the liquid crystal display panel 11 in FIG. 2A. The light source 1105 in FIG. 3C corresponds to the light source apparatus 13 in FIG. 2A. The video display 1102, the light guide 1104, and the light source 1105 in FIG. 3C correspond to the display apparatus 1 in FIG. 2A.

The video display 1102 is a display that generates a video by modulating transmitted light based on a video signal input under the control of the video controller 1160 to be described below. The video display 1102 corresponds to the liquid crystal display panel 11 in FIG. 2A. As the video display 1102, for example, a transmissive liquid crystal panel is used. Alternatively, as the video display 1102, for example, a reflective liquid crystal panel using a method of modulating reflected light, a DMD (Digital Micromirror Device: registered trademark) panel, or the like may be used.

The light source 1105 is configured to generate light for the video display 1102, and is a solid-state light source such as an LED light source or a laser light source. The power supply 1106 converts an AC current input from the outside into a DC current, and supplies power to the light source 1105. Further, the power supply 1106 supplies a necessary DC current to each unit in the air floating video display apparatus 1000.

The light guide 1104 guides the light generated by the light source 1105 and irradiates the video display 1102 with the light. A combination of the light guide 1104 and the light source 1105 may be referred to also as a backlight of the video display 1102. Various configurations are possible as the combination of the light guide 1104 and the light source 1105. A specific configuration example of the combination of the light guide 1104 and the light source 1105 will be described later in detail.

The spatial operation detection sensor 1351 is a sensor that detects an operation on the air floating video 3 by a finger of the user 230. For example, the spatial operation detection sensor 1351 senses a range superimposing on the entire display range of the air floating video 3. Note that the spatial operation detection sensor 1351 may sense only a range superimposing on at least a part of the display range of the air floating video 3.

Specific examples of the spatial operation detection sensor 1351 include a distance sensor using invisible light such as infrared light, an invisible light laser, an ultrasonic wave, or the like. Also, the spatial operation detection sensor 1351 may be configured to be able to detect coordinates on a two-dimensional plane by combining a plurality of sensors. Further, the spatial operation detection sensor 1351 may be composed of a ToF (Time of Flight) type LiDAR (Light Detection and Ranging) or an image sensor.

The spatial operation detection sensor 1351 is only required to perform sensing for detecting a touch operation or the like on an object displayed as the air floating video 3 by a finger of the user. Such sensing can be performed by using an existing technique.

The spatial operation detector 1350 acquires a sensing signal from the spatial operation detection sensor 1351, and determines whether or not the finger of the user 230 has touched an object in the air floating video 3 and calculates the position (touch position) where the finger of the user 230 has touched the object, based on the sensing signal. The spatial operation detector 1350 is composed of, for example, a circuit such as a FPGA (Field Programmable Gate Array). Also, a part of the functions of the spatial operation detector 1350 may be implemented by software, for example, by a program for spatial operation detection executed by the controller 1110.

The spatial operation detection sensor 1351 and the spatial operation detector 1350 may be built in the air floating video display apparatus 1000, or may be provided outside separately from the air floating video display apparatus 1000. When provided separately from the air floating video display apparatus 1000, the spatial operation detection sensor 1351 and the spatial operation detector 1350 are configured to be able to transmit information and signals to the air floating video display apparatus 1000 via a wired or wireless communication connection path or video signal transmission path.

Also, the spatial operation detection sensor 1351 and the spatial operation detector 1350 may be provided separately. Thereby, it is possible to construct a system in which the air floating video display apparatus 1000 without the spatial operation detection function is provided as a main body and only the spatial operation detection function can be added as an option. Further, the configuration in which only the spatial operation detection sensor 1351 is provided separately and the spatial operation detector 1350 is built in the air floating video display apparatus 1000 is also possible. In a case such as when it is desired to arrange the spatial operation detection sensor 1351 more freely with respect to the installation position of the air floating video display apparatus 1000, the configuration in which only the spatial operation detection sensor 1351 is provided separately is advantageous.

The imager 1180 is a camera having an image sensor, and is configured to image the space near the air floating video 3 and/or the face, arms, fingers, and the like of the user 230. A plurality of imagers 1180 may be provided. By using a plurality of imagers 1180 or by using an imager with a depth sensor, it is possible to assist the spatial operation detector 1350 in the detection processing of the touch operation on the air floating video 3 by the user 230. The imager 1180 may be provided separately from the air floating video display apparatus 1000. When the imager 1180 is provided separately from the air floating video display apparatus 1000, the imager 1180 may be configured to be able to transmit imaging signals to the air floating video display apparatus 1000 via a wired or wireless communication connection path or the like.

For example, when the spatial operation detection sensor 1351 is configured as an object intrusion sensor that detects whether or not an object has intruded a plane (intrusion detection plane) including the display plane of the air floating video 3, the spatial operation detection sensor 1351 may not be able to detect information indicating how far an object (e.g., a finger of the user) that has not intruded the intrusion detection plane is away from the intrusion detection plane or how close the object is to the intrusion detection plane.

In such a case, it is possible to calculate the distance between the object and the intrusion detection plane by using information such as depth calculation information of the object based on the captured images of the plurality of imagers 1180 or depth information of the object by the depth sensor. Further, these pieces of information and various kinds of information such as the distance between the object and the intrusion detection plane are used for various kinds of display control for the air floating video 3.

Alternatively, the spatial operation detector 1350 may detect a touch operation on the air floating video 3 by the user 230 based on the image captured by the imager 1180 without using the spatial operation detection sensor 1351.

Further, the imager 1180 may capture an image of the face of the user 230 who operates the air floating video 3, and the controller 1110 may perform the identification processing of the user 230. Also, in order to determine whether or not another person is standing around or behind the user 230 who operates the air floating video 3 and the person is peeking at the operation of the user 230 on the air floating video 3, the imager 1180 may capture an image of a range including the user 230 who operates the air floating video 3 and the surrounding region of the user 230.

The operation input unit 1107 is, for example, an operation button or a light receiver of a remote controller, and receives an input of a signal regarding an operation different from the spatial operation (touch operation) by the user 230. The operation input unit 1107 may be used by, for example, an administrator to operate the air floating video display apparatus 1000 apart from the above-described user 230 who performs the touch operation on the air floating video 3.

The video signal input unit 1131 is connected to an external video output device and receives an input of video data. The audio signal input unit 1133 is connected to an external audio output device and receives an input of audio data. The audio output unit 1140 can output audio based on the audio data input to the audio signal input unit 1133. Also, the audio output unit 1140 may output a built-in operation sound or error warning sound.

The nonvolatile memory 1108 stores various kinds of data used in the air floating video display apparatus 1000. The data stored in the nonvolatile memory 1108 include, for example, data for various operations to be displayed in the air floating video 3, display icons, data of objects to be operated by user, layout information, and the like. The memory 1109 stores video data to be displayed as the air floating video 3, data for controlling the apparatus, and the like.

The controller 1110 controls the operation of each unit connected thereto. Also, the controller 1110 may perform arithmetic operation based on information acquired from each unit in the air floating video display apparatus 1000 in cooperation with a program stored in the memory 1109. The communication unit 1132 communicates with an external device, an external server, or the like via a wired or wireless interface. Various kinds of data such as video data, image data, and audio data are transmitted and received through communication via the communication unit 1132.

The storage 1170 is a storage device that records various kinds of information, for example, various kinds of data such as video data, image data, and audio data. In the storage 1170, for example, various kinds of information, for example, various kinds of data such as video data, image data, and audio data may be recorded in advance at the time of product shipment. In addition, the storage 1170 may record various kinds of information, for example, various kinds of data such as video data, image data, and audio data acquired from an external device, an external server, or the like via the communication unit 1132.

The video data, the image data, and the like recorded in the storage 1170 are output as the air floating video 3 via the video display 1102 and the retroreflection portion 1101. Video data, image data, and the like of display icons, an object to be operated by a user, and the like which are displayed as the air floating video 3 are also recorded in the storage 1170.

Layout information of display icons, an object, and the like displayed as the air floating video 3, information of various kinds of metadata related to the object, and the like are also recorded in the storage 1170. The audio data recorded in the storage 1170 is output as audio from, for example, the audio output unit 1140.

The video controller 1160 performs various kinds of control related to a video signal to be input to the video display 1102. For example, the video controller 1160 performs the control of video switching for determining which of a video signal stored in the memory 1109 or a video signal (video data) input to the video signal input unit 1131 is to be input to the video display 1102.

Also, the video controller 1160 may perform the control to form a composite video as the air floating video 3 by generating a superimposed video signal obtained by superimposing the video signal stored in the memory 1109 and the video signal input from the video signal input unit 1131 and inputting the superimposed video signal to the video display 1102.

Further, the video controller 1160 may perform the control to perform image processing on the video signal input from the video signal input unit 1131, the video signal to be stored in the memory 1109, or the like. Examples of the image processing include scaling processing for enlarging, reducing, and deforming an image, brightness adjustment processing for changing luminance, contrast adjustment processing for changing a contrast curve of an image, and retinex processing for decomposing an image into light components and changing weighting for each component.

In addition, the video controller 1160 may perform special effect video processing or the like for assisting a spatial operation (touch operation) of the user 230 to the video signal to be input to the video display 1102. The special effect video processing is performed based on, for example, the detection result of the touch operation of the user 230 by the spatial operation detector 1350 and the captured image of the user 230 by the imager 1180.

As described above, the air floating video display apparatus 1000 has various functions. However, the air floating video display apparatus 1000 does not need to have all of these functions, and may have any configuration as long as the apparatus has a function of forming the air floating video 3.

<Air Floating Video Display Apparatus (2)>

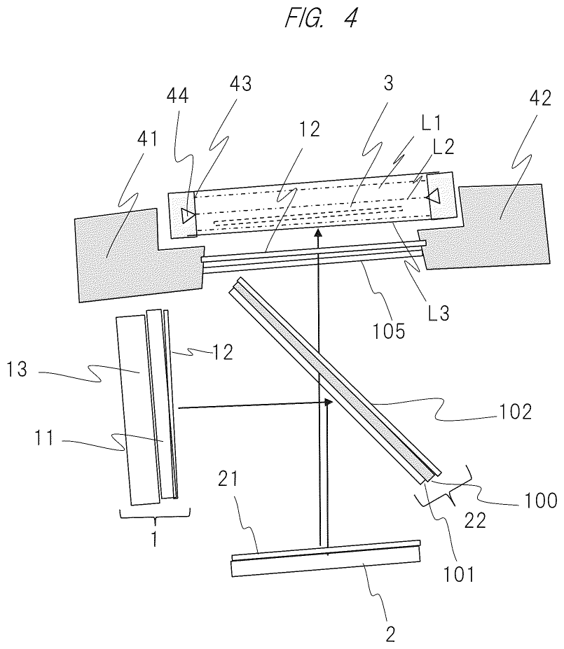

FIG. 4 is a diagram showing another example of the configuration of the main part of the air floating video display apparatus according to one embodiment of the present invention. The display apparatus 1 includes the liquid crystal display panel 11 as a video display element and the light source apparatus 13 configured to generate light of a specific polarized wave having narrow-angle diffusion characteristics. The display apparatus 1 is composed of, for example, a liquid crystal panel of selected size from a small-sized liquid crystal display panel having a screen size of about 5 inches to a large-sized liquid crystal display panel having a screen size exceeding 80 inches. A returning mirror 22 has the transparent member 100 as a base. On a surface of the transparent member 100 on the side of the display apparatus 1, the polarization separator 101 that selectively reflects the video light of a specific polarized wave like a reflective polarizing plate is provided, and reflects the video light from the liquid crystal display panel 11 toward a retroreflection plate 2. Thus, the returning mirror 22 has a function as a mirror. The video light of a specific polarized wave from the display apparatus 1 is reflected by the polarization separator 101 provided on the transparent member 100 (in the drawing, the sheet-shaped polarization separator 101 is adhered) and enters the retroreflection plate 2. Note that an optical film having polarization separation characteristics may be deposited on the surface of the transparent member 100 instead of the polarization separator 101.

The λ/4 plate 21 is provided on the light incident surface of the retroreflection plate, and the video light is made to pass through the λ/4 plate 21 twice to convert a specific polarized wave into the other polarized wave having a phase different by Thereby, the video light after the retroreflection is transmitted through the polarization separator 101 and the air floating video 3, which is a real image, is displayed on the outside of the transparent member 100.

Here, in the above-described polarization separator 101, the polarization axes are not aligned due to retroreflection, and thus a part of the video light is reflected and returns to the display apparatus 1. This light is reflected again on the video display surface of the liquid crystal display panel 11 constituting the display apparatus 1, so that a ghost image is generated and the image quality of the air floating image is significantly deteriorated.

Therefore, in the present embodiment, the absorptive polarizing plate 12 may be provided on the video display surface of the display apparatus 1. By transmitting the video light emitted from the display apparatus 1 and absorbing the reflected light from the polarization separator 101 described above, the deterioration of the image quality of the air floating image due to the ghost image is prevented. Further, in order to reduce the deterioration in image quality due to sunlight or illumination light outside the set, an absorptive polarizing plate 102 is preferably provided on the surface of the transparent member 100 on the transmission output side of the video light.

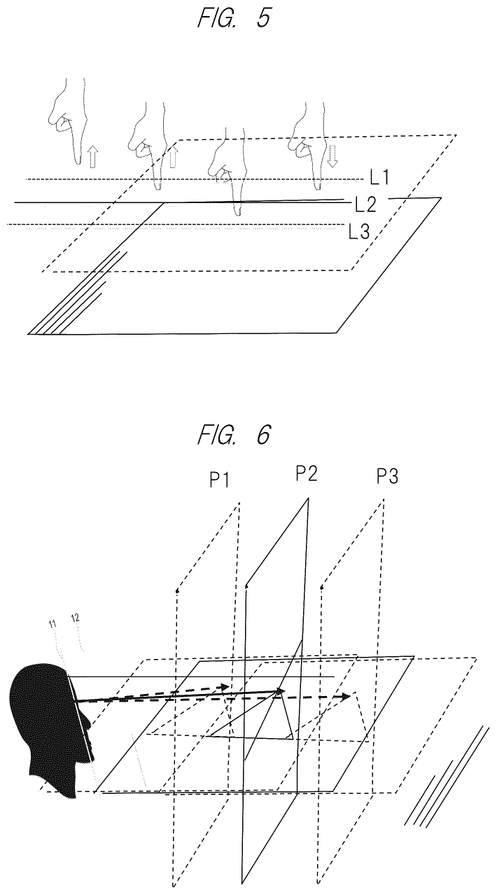

Then, sensors 44 having a TOF (Time of Fly) function are arranged in a plurality of layers as shown in FIG. 5 so as to sense a relationship of a distance and a position between an object and the sensors 44 with respect to the air floating video obtained by the air floating video display apparatus described above, so that coordinates in a depth direction and a moving direction and a moving speed of the object can be sensed in addition to coordinates in a plane direction of the object. In order to read a two-dimensional distance and position, a plurality of combinations of an infrared light emitting portion and a light receiving portion are linearly arranged, light from a light emitting point is irradiated on an object, and reflected light is received by the light receiving portion. The distance to the object becomes clear by the product of the difference between the light emitting time and the light receiving time and the speed of light. Also, the coordinates on the plane can be read from the coordinates at a portion where the difference between the light emitting time and the light receiving time is the smallest by the plurality of light emitting portions and light receiving portions. As described above, three-dimensional coordinate information can also be obtained by combining the coordinates of an object on a (two-dimensional) plane and a plurality of the above-described sensors.

Further, a method of obtaining a three-dimensional air floating video as the above-described air floating video display apparatus will be described with reference to FIG. 6. FIG. 6 is an explanatory diagram of the principle of the three-dimensional video display used in the air floating video display apparatus. Horizontal lenticular lenses are arranged in accordance with the pixels of the video display screen of the liquid crystal display panel 11 of the display apparatus 1 shown in FIG. 4. As a result, in order to display the motion parallaxes from the three directions of the motion parallaxes P1, P2, and P3 in the horizontal direction of the screen as shown in FIG. 6, videos from the three directions are set as one block for each three pixels, video information from the three directions is displayed for each pixel, and the light emission direction is controlled by the action of the corresponding lenticular lens (indicated by vertical lines in FIG. 6) to separately emit the light in three directions. As a result, a stereoscopic image of three parallaxes can be displayed.

<Reflective Polarizing Plate>

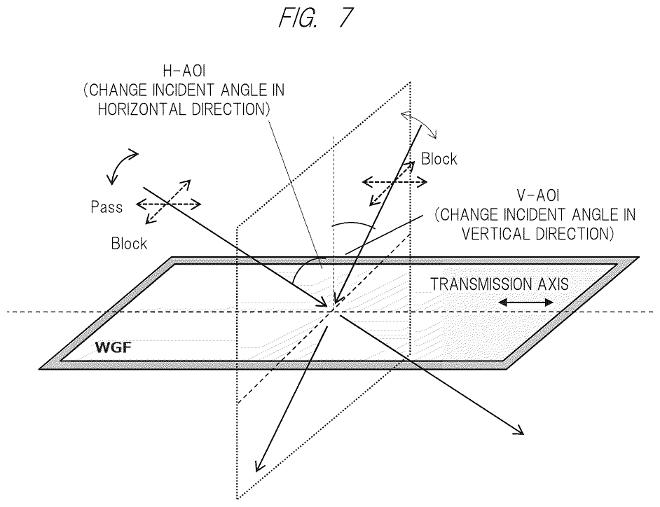

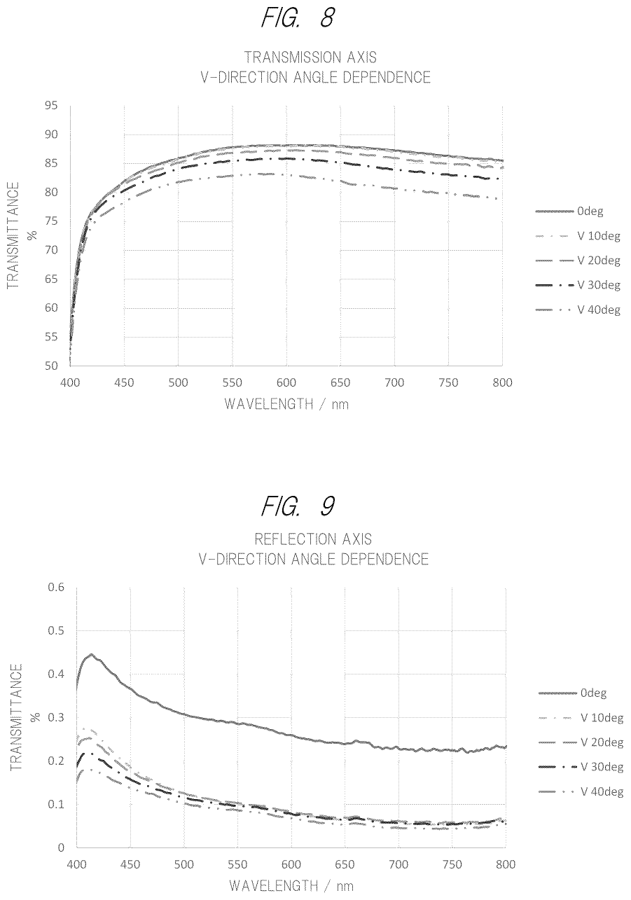

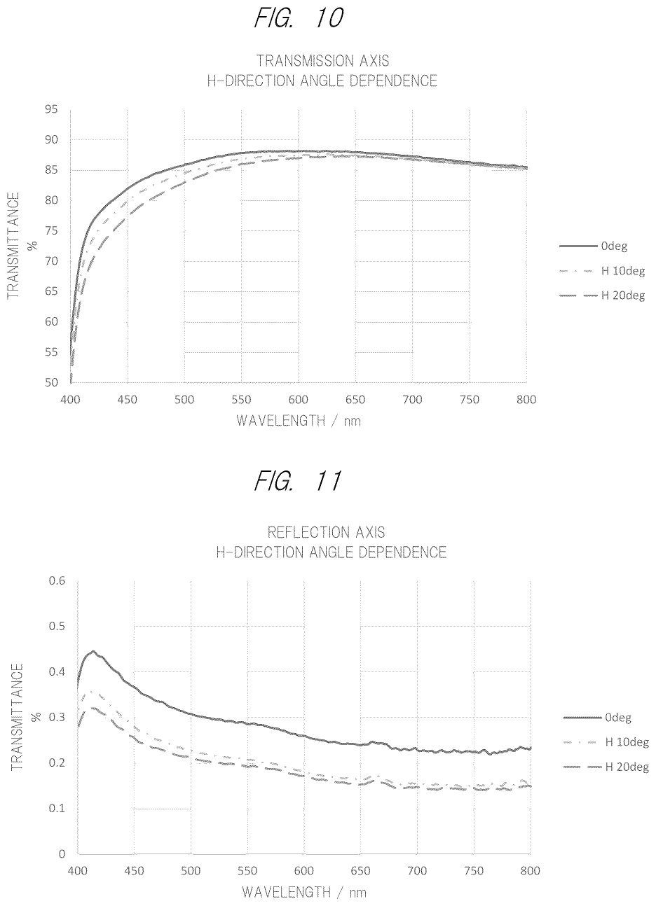

In the air floating video display apparatus according to the present embodiment, the polarization separator 101 is used to improve the contrast performance, which determines the video quality, more than a general half mirror. The characteristics of a reflective polarizing plate will be described as an example of the polarization separator 101 of the present embodiment. FIG. 7 is an explanatory diagram of a measurement system for evaluating the characteristics of the reflective polarizing plate. FIG. 8 and FIG. 9 show the transmission characteristics and the reflection characteristics with respect to the light beam incident angle from the direction perpendicular to the polarization axis of the reflective polarizing plate in FIG. 7 as V-AOI, respectively. Similarly, FIG. 10 and FIG. 11 show the transmission characteristics and the reflection characteristics with respect to the light beam incident angle from the direction horizontal to the polarization axis of the reflective polarizing plate as H-AOI, respectively.

In the characteristic graphs in FIG. 8 to FIG. 11, the values of angle (deg) in the margin on the right side are shown in descending order of the value of the vertical axis, that is, transmittance (%). For example, in FIG. 8, in the range where the horizontal axis represents the light with a wavelength of approximately 400 nm to 800 nm, the transmittance is highest when the angle in the vertical (V) direction is 0 degrees (deg), and the transmittance decreases in the order of 10 degrees, 20 degrees, 30 degrees, and 40 degrees. Also, in FIG. 9, in the range where the horizontal axis represents the light with a wavelength of approximately 400 nm to 800 nm, the transmittance is highest when the angle in the vertical (V) direction is 0 degrees (deg), and the transmittance decreases in the order of degrees, 20 degrees, 30 degrees, and 40 degrees. Further, in FIG. 10, in the range where the horizontal axis represents the light with a wavelength of approximately 400 nm to 800 nm, the transmittance is highest when the angle in the horizontal (H) direction is 0 degrees (deg), and the transmittance decreases in the order of 10 degrees and 20 degrees. In addition, in FIG. 11, in the range where the horizontal axis represents the light with a wavelength of approximately 400 nm to 800 nm, the transmittance is highest when the angle in the horizontal (H) direction is 0 degrees (deg), and the transmittance decreases in the order of degrees and 20 degrees.

As shown in FIG. 8 and FIG. 9, in the reflective polarizing plate having the grid structure, the characteristics for the light from the direction perpendicular to the polarization axis are deteriorated. Therefore, the specification along the polarization axis is desirable, and the light source of the present embodiment capable of emitting the video light from the liquid crystal display panel at a narrow angle is an ideal light source. Similarly, the characteristics in the horizontal direction are deteriorated with respect to oblique light. In consideration of the above characteristics, a configuration example of the present embodiment in which a light source capable of emitting video light from a liquid crystal display panel at a narrower angle is used as a backlight of the liquid crystal display panel will be described below. Thereby, a high-contrast air floating video can be provided.

<Display Apparatus>

Next, the display apparatus 1 of the present embodiment will be described with reference to the drawings. The display apparatus 1 of the present embodiment includes a video display element 11 (liquid crystal display panel) and the light source apparatus 13 constituting a light source thereof, and FIG. 12 shows the light source apparatus 13 together with the liquid crystal display panel as a developed perspective view.

In the liquid crystal display panel (video display element 11), as indicated by arrows 30 in FIG. 12, an illumination light flux having narrow-angle diffusion characteristics, that is, characteristics similar to laser light with strong directivity (straightness) and a polarization plane aligned in one direction is received by the light from the light source apparatus 13 as a backlight apparatus. The liquid crystal display panel (video display element 11) modulates the received illumination light flux in accordance with an input video signal. The modulated video light is reflected by the retroreflector 2 and transmitted through the transparent member 100, thereby forming an air floating image as a real image (see FIG. 2A).

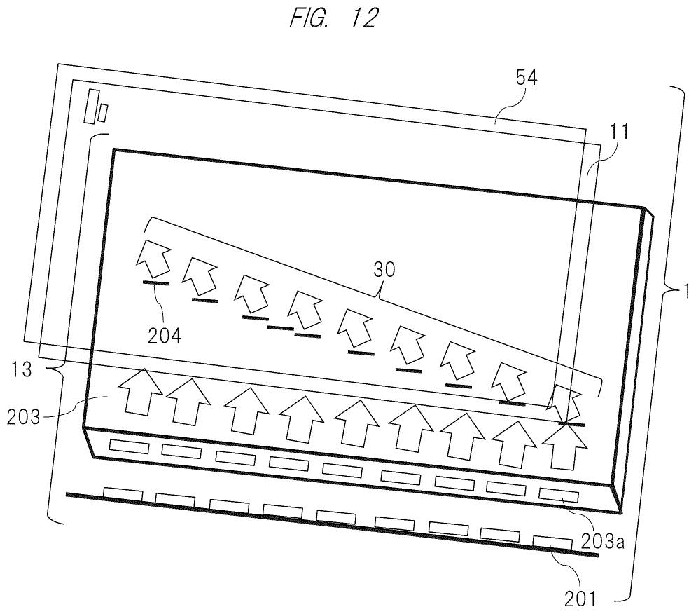

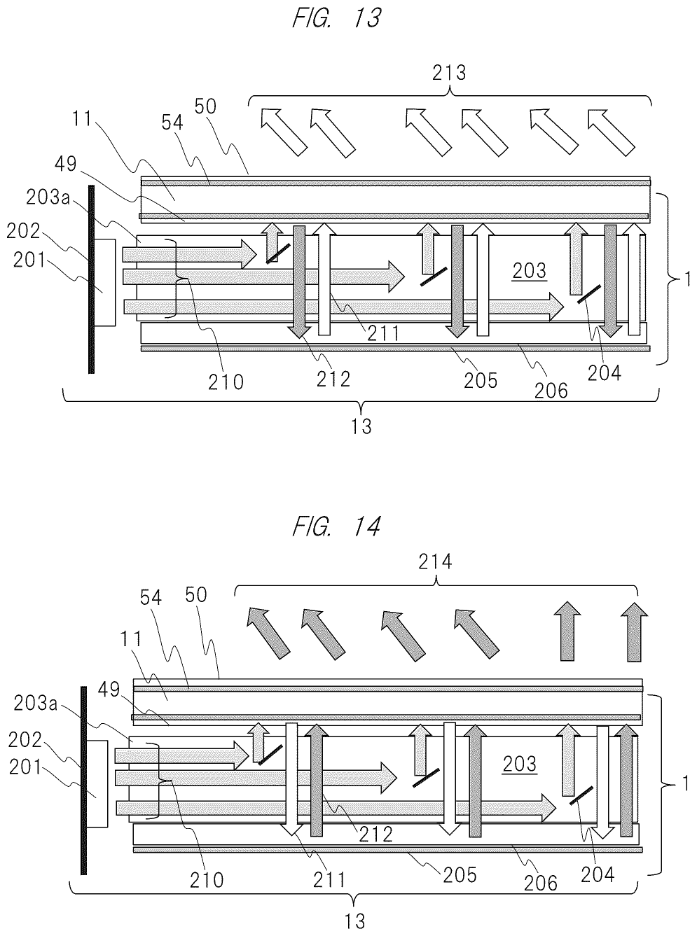

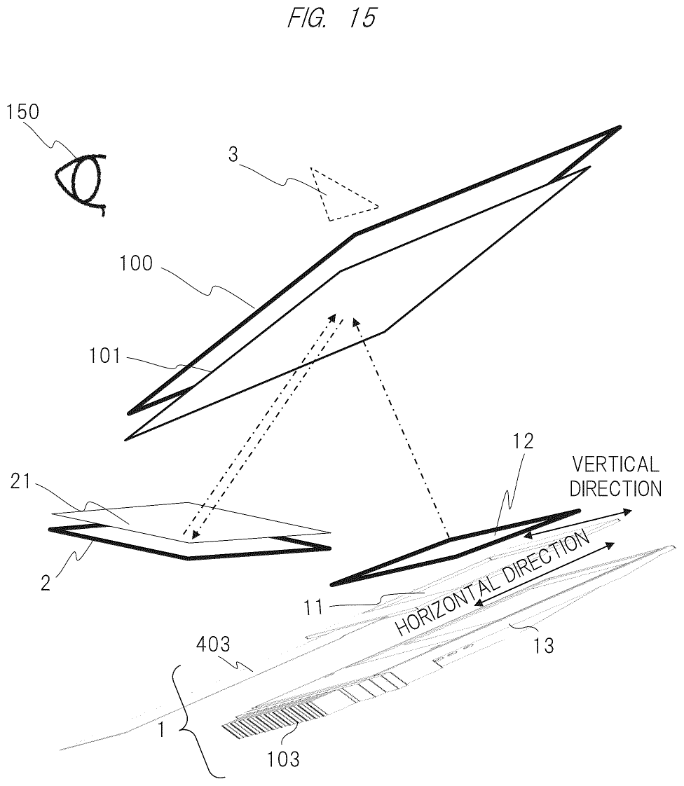

Further, in FIG. 12, the display apparatus 1 includes the liquid crystal display panel 11, a light direction conversion panel 54 configured to control the directional characteristics of the light flux emitted from the light source apparatus 13, and a narrow-angle diffusion plate as needed (not shown). Namely, polarizing plates are provided on both surfaces of the liquid crystal display panel 11, and video light of a specific polarized wave is emitted at the light intensity modulated by the video signal (see the arrows 30 in FIG. 12). Thus, a desired video is projected as the light of a specific polarized wave having high directivity (straightness) toward the retroreflector 2 via the light direction conversion panel 54, reflected by the retroreflector 2, and then transmitted toward the eyes of an observer outside the store (space), thereby forming the air floating video 3. Note that a protective cover 50 (see FIG. 13 and FIG. 14) may be provided on the surface of the light direction conversion panel 54 described above.

In the present embodiment, in order to improve the utilization efficiency of the light flux 30 emitted from the light source apparatus 13 and significantly reduce power consumption, in the display apparatus 1 including the light source apparatus 13 and the liquid crystal display panel 11, the directivity of the light from the light source apparatus 13 (see the arrows 30 in FIG. 12) can be controlled by a transparent sheet (not shown) provided on the surface of the transparent member 100 (window glass 105 or the like) such that a floating video can be formed at a desired position after the light is projected toward the retroreflector 2 and reflected by the retroreflector 2. Specifically, the transparent sheet controls the imaging position of the floating video while providing high directivity by an optical component such as a Fresnel lens or a linear Fresnel lens. According to this configuration, the video light from the display apparatus 1 efficiently reaches an observer outside the show window 105 (e.g., a sidewalk) with high directivity (straightness) like laser light. As a result, it is possible to display a high-quality floating video with high resolution and to significantly reduce power consumption of the display apparatus 1 including an LED element 201 of the light source apparatus 13.

<Example of Display Apparatus (1)>

FIG. 13 shows an example of a specific configuration of the display apparatus 1. In FIG. 13, the liquid crystal display panel 11 and the light direction conversion panel 54 are arranged on the light source apparatus 13 in FIG. 12. The light source apparatus 13 is formed of, for example, plastic or the like on a case shown in FIG. 12, and is configured to accommodate the LED element 201 and a light guide 203 therein. Also, as shown in FIG. 12 and the like, in order to convert the divergent light from each LED element 201 into a substantially parallel light flux, the end surface of the light guide 203 is provided with a lens shape in which the cross-sectional area gradually increases toward the opposite surface with respect to the light receiving portion and which has a function of gradually reducing the divergence angle when making total reflection plural times during the propagation therein. The liquid crystal display panel 11 constituting the display apparatus 1 is attached to the upper surface of the display apparatus 1. Further, the LED (Light Emitting Diode) element 201 which is a semiconductor light source and an LED substrate 202 on which a control circuit thereof is mounted may be attached to one side surface (an end surface on the left side in this example) of the case of the light source apparatus 13, and a heat sink which is a member for cooling heat generated in the LED element and the control circuit may be attached to an outer surface of the LED substrate 202.

Also, to a frame (not shown) of the liquid crystal display panel attached to the upper surface of the case of the light source apparatus 13, the liquid crystal display panel 11 attached to the frame, an FPC (Flexible Printed Circuits) board (not shown) electrically connected to the liquid crystal display panel 11, and the like are attached. Namely, the liquid crystal display panel 11 which is a video display element generates a display video by modulating the intensity of transmitted light based on a control signal from a control circuit (not shown) constituting an electronic device together with the LED element 201 which is a solid-state light source. At this time, since the generated video light has a narrow diffusion angle and only a specific polarization component, it is possible to obtain a novel and unconventional video display apparatus which is close to a surface-emitting laser video source driven by a video signal. Note that, at present, it is impossible to obtain a laser light flux having the same size as the image obtained by the above-described display apparatus 1 by using a laser apparatus for both technical and safety reasons. Therefore, in the present embodiment, for example, light close to the above-described surface-emitting laser video light is obtained from a light flux from a general light source including an LED element.

Subsequently, the configuration of the optical system accommodated in the case of the light source apparatus 13 will be described in detail with reference to FIG. 13 and FIG. 14.

Since FIG. 13 and FIG. 14 are cross-sectional views, only one of a plurality of LED elements 201 constituting the light source is shown, and the light from these elements is converted into substantially collimated light by the shape of a light-receiving end surface 203a of the light guide 203. Therefore, the light receiving portion on the end surface of the light guide and the LED element are attached while maintaining a predetermined positional relationship.

Note that each of the light guides 203 is formed of, for example, a translucent resin such as acrylic. Although not shown in FIG. 13 and FIG. 14, the light-receiving surface of the LED light at one end of the light guide 203 has, for example, a conical convex outer peripheral surface obtained by rotating a parabolic cross section, and the central region at the top of the outer peripheral surface has a concave portion in which a convex portion (i.e., a convex lens surface) is formed. Further, the central region of the flat surface portion at the other end of the light guide 203 has a convex lens surface protruding outward (or may be a concave lens surface recessed inward). These configurations will be described later with reference to FIG. 16 and others. Note that the external shape of the light receiving portion of the light guide to which the LED element 201 is attached is a paraboloid shape that forms a conical outer peripheral surface, and is set within a range of an angle at which light emitted from the LED element in the peripheral direction can be totally reflected inside the paraboloid, or has a reflection surface formed thereon.

On the other hand, each of the LED elements 201 is arranged at a predetermined position on the surface of the LED substrate 202 which is a circuit board for the LED elements. The LED substrate 202 is arranged and fixed to the LED collimator (the light-receiving end surface 203a) such that each of the LED elements 201 on the surface thereof is located at the central portion of the concave portion described above.

With such a configuration, the light emitted from the LED elements 201 can be extracted as substantially parallel light due to the shape of the light-receiving end surface 203a of the light guide 203, and the utilization efficiency of the generated light can be improved.

As described above, the light source apparatus 13 is configured by attaching a light source unit, in which a plurality of LED elements 201 as light sources are arranged, to the light-receiving end surface 203a which is a light receiving portion provided on the end surface of the light guide 203. Also, in the light source apparatus 13, the divergent light flux from the LED elements 201 is converted into substantially parallel light by the lens shape of the light-receiving end surface 203a on the end surface of the light guide, is guided through the inside of the light guide 203 (in the direction parallel to the drawing) as indicated by arrows, and is emitted toward the liquid crystal display panel 11 arranged substantially parallel to the light guide 203 (in the upward direction in the drawing) by a light flux direction converter 204. The uniformity of the light flux that enters the liquid crystal display panel 11 can be controlled by optimizing the distribution (density) of the light flux direction converter 204 by the shape inside the light guide or the shape of the surface of the light guide.

The above-described light flux direction converter 204 emits the light flux propagating through the inside of the light guide toward the liquid crystal display panel 11 (in the upward direction in the drawing) arranged substantially in parallel to the light guide 203 by the shape of the surface of the light guide or by providing a portion having a different refractive index inside the light guide. At this time, if the relative luminance ratio when comparing the luminance at the center of the screen with the luminance of the peripheral portion of the screen in a state in which the liquid crystal display panel 11 squarely faces the center of the screen and the viewpoint is placed at the same position as the diagonal dimension of the screen is 20% or more, there is no problem in practical use, and if the relative luminance ratio exceeds 30%, the characteristics will be even better.

Note that FIG. 13 is a cross-sectional layout drawing for describing the configuration and action of the light source of the present embodiment that performs polarization conversion in the light source apparatus 13 including the light guide 203 and the LED element 201 described above. In FIG. 13, the light source apparatus 13 is composed of, for example, the light guide 203 which is formed of plastic or the like and is provided with the light flux direction converter 204 on its surface or inside, the LED element 201 as a light source, a reflection sheet 205, a retardation plate 206, and a lenticular lens, and the liquid crystal display panel 11 including polarizing plates on its light source light incident surface and video light emission surface is attached to the upper surface of the light source apparatus 13.

Also, a film-shaped or sheet-shaped reflective polarizing plate 49 is provided on the light source light incident surface (lower surface in the drawing) of the liquid crystal display panel 11 corresponding to the light source apparatus 13, by which one polarized wave (e.g., a P-wave) 212 of the natural light flux 210 emitted from the LED element 201 is selectively reflected, is reflected by the reflection sheet 205 provided on one surface (lower side in the drawing) of the light guide 203, and is directed toward the liquid crystal display panel 11 again. Then, a retardation plate (λ/4 plate) is provided between the reflection sheet 205 and the light guide 203 or between the light guide 203 and the reflective polarizing plate 49, and the light flux reflected by the reflection sheet 205 is made to pass through the retardation plate twice, so that the reflected light flux is converted from the P-polarized light to the S-polarized light and the utilization efficiency of the light source light as video light can be improved. The video light flux (arrows 213 in FIG. 13) whose light intensity is modulated by the video signal in the liquid crystal display panel 11 enters the retroreflector 2 and is reflected and then transmitted through the window glass 105, so that an air floating image which is a real image can be obtained inside or outside the store (space) as shown in FIG. 1A.

Similar to FIG. 13, FIG. 14 is a cross-sectional layout drawing for describing the configuration and action of the light source of the present embodiment that performs polarization conversion in the light source apparatus 13 including the light guide 203 and the LED element 201. The light source apparatus 13 is similarly composed of, for example, the light guide 203 which is formed of plastic or the like and is provided with the light flux direction converter 204 on its surface or inside, the LED element 201 as a light source, the reflection sheet 205, the retardation plate 206, and the lenticular lens. The liquid crystal display panel 11 including polarizing plates on its light source light incident surface and video light emission surface is attached as the video display element to the upper surface of the light source apparatus 13.

Also, the film-shaped or sheet-shaped reflective polarizing plate 49 is provided on the light source light incident surface (lower surface in the drawing) of the liquid crystal display panel 11 corresponding to the light source apparatus 13, by which one polarized wave (e.g., a S-wave) 211 of the natural light flux 210 emitted from the LED light source 201 is selectively reflected, is reflected by the reflection sheet 205 provided on one surface (lower side in the drawing) of the light guide 203, and is directed toward the liquid crystal display panel 11 again. Then, a retardation plate (λ/4 plate) is provided between the reflection sheet 205 and the light guide 203 or between the light guide 203 and the reflective polarizing plate 49, and the light flux reflected by the reflection sheet 205 is made to pass through the retardation plate twice, so that the reflected light flux is converted from the S-polarized light to the P-polarized light and the utilization efficiency of the light source light as video light can be improved. The video light flux (arrows 214 in FIG. 14) whose light intensity is modulated by the video signal in the liquid crystal display panel 11 enters the retroreflector 2 and is reflected and then transmitted through the window glass 105, so that an air floating image which is a real image can be obtained inside or outside the store (space) as shown in FIG. 1.

In the light source apparatuses shown in FIG. 13 and FIG. 14, in addition to the action of the polarizing plate provided on the light incident surface of the corresponding liquid crystal display panel 11, the polarization component on one side is reflected by the reflective polarizing plate, and thus the contrast ratio theoretically obtained is the product of the reciprocal of the cross transmittance of the reflective polarizing plate and the reciprocal of the cross transmittance obtained by the two polarizing plates attached to the liquid crystal display panel. Therefore, high contrast performance can be obtained. In practice, it has been experimentally confirmed that the contrast performance of the display image is improved by 10 times or more. As a result, a high-quality video comparable to the video of a self-luminous organic EL can be obtained.

<Example of Display Apparatus (2)>

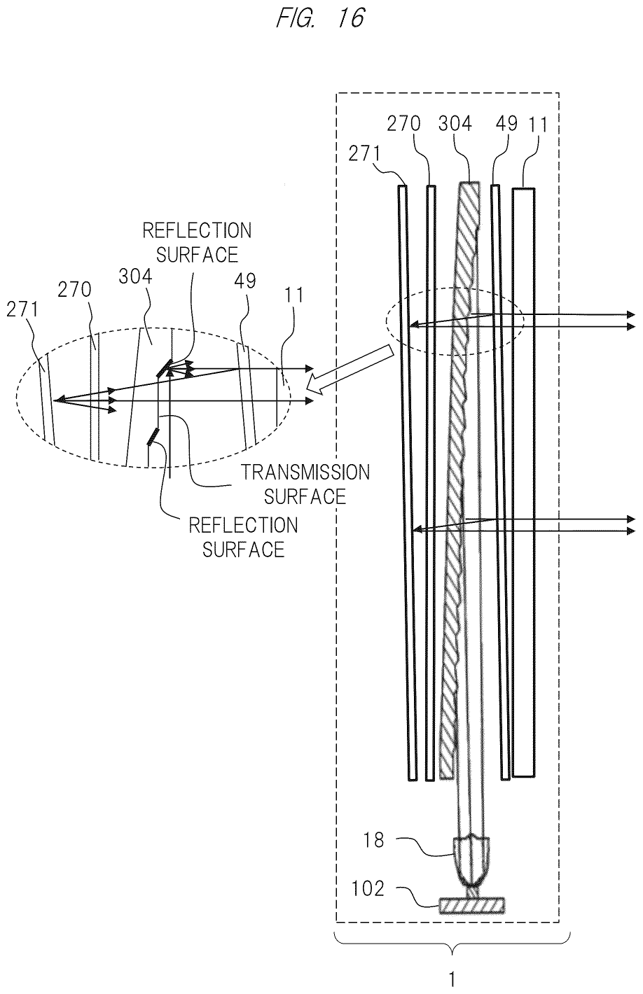

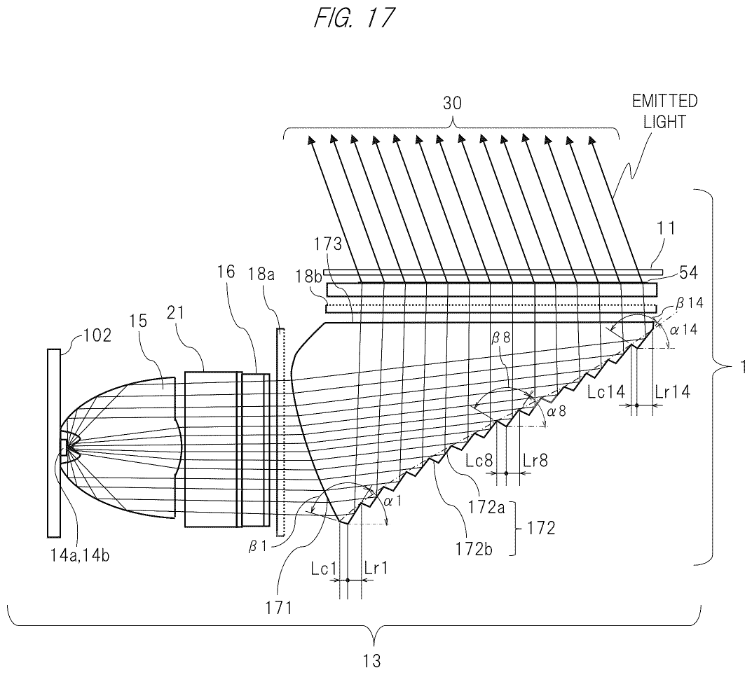

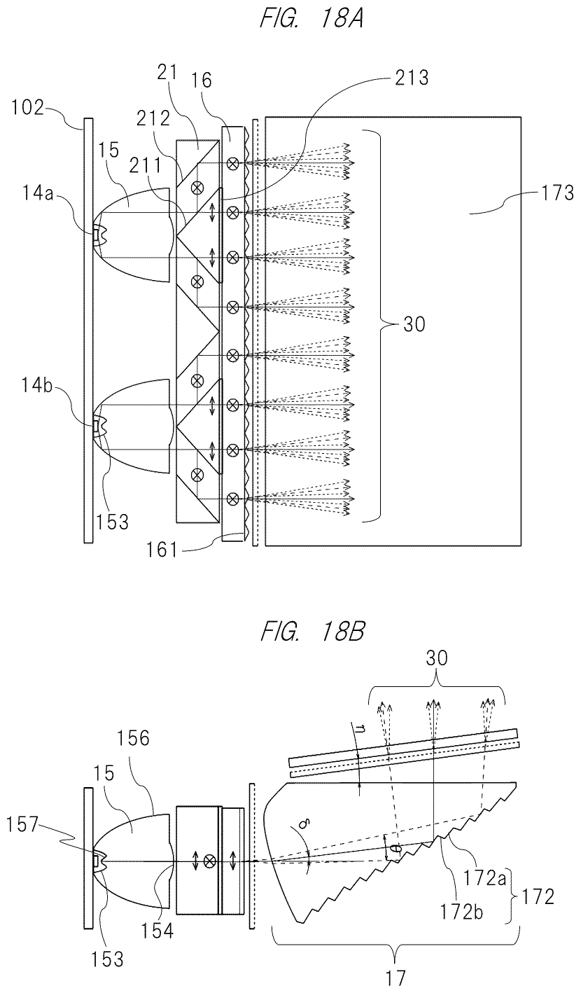

FIG. 15 shows another example of a specific configuration of the display apparatus 1. The light source apparatus 13 in FIG. 15 is the same as the light source apparatus in FIG. 17 and the like. The light source apparatus 13 is configured by accommodating an LED, a collimator, a synthetic diffusion block, a light guide, and the like in a case made of, for example, plastic, and the liquid crystal display panel 11 is attached to the upper surface thereof. Further, LED (Light Emitting Diode) elements 14a and 14b which are semiconductor light sources and an LED substrate on which a control circuit thereof is mounted are attached to one side surface of the case of the light source apparatus 13, and a heat sink 103 which is a member for cooling the heat generated in the LED elements and the control circuit is attached to an outer surface of the LED substrate (see also FIG. 17, FIG. 18A, FIG. 18B, and the like).

Also, to a frame of the liquid crystal display panel attached to the upper surface of the case, the liquid crystal display panel 11 attached to the frame, an FPC (Flexible Printed Circuits) board 403 (see FIG. 7) electrically connected to the liquid crystal display panel 11, and the like are attached. Namely, the liquid crystal display panel 11 which is a liquid crystal display element generates a display video by modulating the intensity of transmitted light based on a control signal from a control circuit (not shown here) constituting an electronic device together with the LED elements 14a and 14b which are solid-state light sources.

<Example of Light Source Apparatus (1) of Example of Display Apparatus (2)>

Subsequently, the configuration of the optical system of the light source apparatus or the like accommodated in the case will be described in detail with reference to FIG. 17, FIG. 18A, and FIG. 18B.

FIG. 17, FIG. 18A, and FIG. 18B show the LEDs 14a and 14b constituting the light source, and these LEDs are attached at predetermined positions with respect to LED collimators 15. Note that each of the LED collimators 15 is formed of, for example, a translucent resin such as acrylic. Further, as shown also in FIG. 18B, the LED collimator 15 has a conical convex outer peripheral surface 156 obtained by rotating a parabolic cross section. Also, the central portion at the top of the LED collimator 15 (on the side facing the LED substrate 102) has a concave portion 153 in which a convex portion (i.e., a convex lens surface) 157 is formed. Also, the central portion of the flat surface portion (on the side opposite to the top described above) of the LED collimator 15 has a convex lens surface 154 protruding outward (or may be a concave lens surface recessed inward). Note that the paraboloid 156 that forms the conical outer peripheral surface of the LED collimator 15 is set within a range of an angle at which light emitted from the LEDs 14a and 14b in the peripheral direction can be totally reflected inside the paraboloid, or has a reflection surface formed thereon.

Also, each of the LEDs 14a and 14b is arranged at a predetermined position on the surface of the LED substrate 102 which is a circuit board for the LEDs. The LED substrate 102 is arranged and fixed to the LED collimator 15 such that each of the LEDs 14a and 14b on the surface thereof is located at the central portion of the concave portion 153 of the LED collimator 15.

With such a configuration, of the light emitted from the LED 14a or 14b, in particular, the light emitted upward (to the right in the drawing) from the central portion thereof is condensed into parallel light by the two convex lens surfaces 157 and 154 forming the outer shape of the LED collimator 15. Also, the light emitted from the other portion toward the peripheral direction is reflected by the paraboloid forming the conical outer peripheral surface of the LED collimator 15, and is similarly condensed into parallel light. In other words, with the LED collimator 15 having a convex lens formed at the central portion thereof and a paraboloid formed in the peripheral portion thereof, it is possible to extract substantially all of the light generated by the LED 14a or 14b as parallel light, and to improve the utilization efficiency of the generated light.

Note that a polarization conversion element 21 is provided on the light emission side of the LED collimator 15. As is apparent also from FIG. 18A and FIG. 18B, the polarization conversion element 21 is configured by combining a columnar translucent member having a parallelogram cross section (hereinafter referred to as a parallelogram column) and a columnar translucent member having a triangular cross section (hereinafter referred to as a triangular column), and arranging a plurality of the combinations of the members in an array in parallel to a plane orthogonal to the optical axis of the parallel light from the LED collimator 15. Further, polarizing beam splitters (hereinafter abbreviated as “PBS films”) 211 and reflective films 212 are alternately provided at the interface between the adjacent translucent members arranged in an array. Also, a λ/2 phase plate 213 is provided on the emission surface from which light that has entered the polarization conversion element 21 and has been transmitted through the PBS films 211 is emitted.

A rectangular synthetic diffusion block 16 shown also in FIG. 18A is further provided on the emission surface of the polarization conversion element 21. Namely, the light emitted from the LED 14a or 14b becomes parallel light by the action of the LED collimator 15 to enter the synthetic diffusion block 16, and reaches the light guide 17 after being diffused by textures 161 on the emission side.

The light guide 17 is a member made of, for example, a translucent resin such as acrylic and formed in a rod shape having a substantially triangular cross section (see FIG. 18B). Also, as is apparent also from FIG. 17, the light guide 17 includes a light guide light incident portion (surface) 171 configured to face the emission surface of the synthetic diffusion block 16 with a first diffusion plate 18a interposed therebetween, a light guide light reflection portion (surface) 172 configured to form an inclined surface, and a light guide light emission portion (surface) 173 configured to face the liquid crystal display panel 11, which is a liquid crystal display element, with a second diffusion plate 18b interposed therebetween.

On the light guide light reflection portion (surface) 172 of the light guide 17, as shown also in FIG. 17 which is a partially enlarged view thereof, a large number of reflection surfaces 172a and connection surfaces 172b are alternately formed in a saw-tooth shape. Also, the reflection surface 172a (a line segment rising to the right in the drawing) forms an (n: natural number, e.g., 1 to 130 in this example) with respect to the horizontal plane indicated by the dashed-and-dotted line in the drawing, and an is here set to 43 degrees or less (however, 0 degrees or more) as an example.

The light guide light incident portion (surface) 171 is formed in a curved convex shape inclined toward the light source side. According to this, after the parallel light from the emission surface of the synthetic diffusion block 16 enters while being diffused through the first diffusion plate 18a, as is apparent also from the drawing, the light reaches the light guide light reflection portion (surface) 172 while being slightly bent (deflected) upward by the light guide light incident portion (surface) 171, and is reflected here to reach the liquid crystal display panel 11 provided on the emission surface on the upper side in the drawing.

With the display apparatus 1 described above in detail, it is possible to further improve the light utilization efficiency and its uniform illumination characteristics, and at the same time, it is possible to manufacture the display apparatus 1 including a modularized light source apparatus for S-polarized wave in a small size and at a low cost. Note that, in the above description, the polarization conversion element 21 is attached behind the LED collimator 15, but the present invention is not limited thereto, and the same function and effect can be obtained even by providing the polarization conversion element 21 in the optical path leading to the liquid crystal display panel 11.

Note that a large number of reflection surfaces 172a and connection surfaces 172b are alternately formed in a saw-tooth shape on the light guide light reflection portion (surface) 172, and the illumination light flux is totally reflected on each reflection surface 172a and directed upward. Further, since a narrow-angle diffusion plate is provided on the light guide light emission portion (surface) 173, the illumination light flux enters the light direction conversion panel 54 for controlling the directional characteristics as a substantially parallel diffused light flux, and then enters the liquid crystal display panel 11 from the oblique direction. In the present embodiment, the light direction conversion panel 54 is provided between the light guide light emission portion (surface) 173 and the liquid crystal display panel 11, but the same effect can be obtained even if the light direction conversion panel 54 is provided on the emission surface of the liquid crystal display panel 11.

<Example of Light Source Apparatus (2) of Example of Display Apparatus (2)>

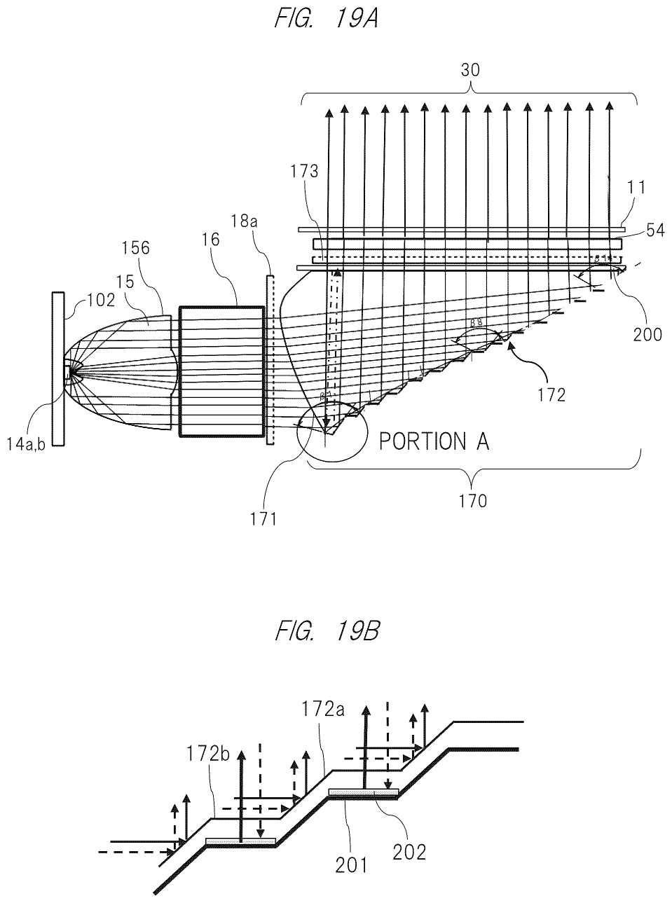

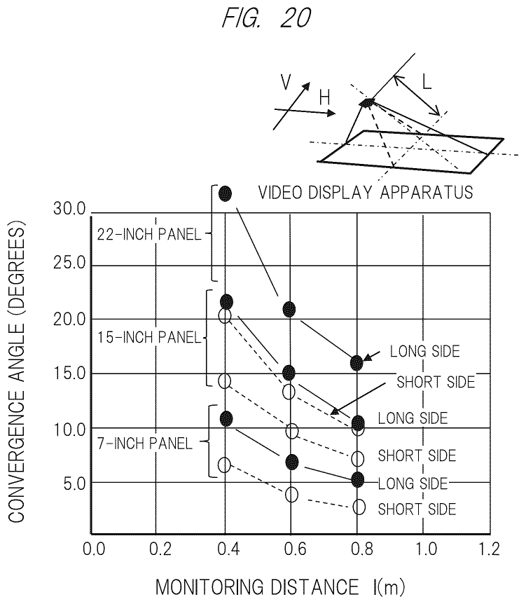

FIG. 19A and FIG. 19B show another example of the configuration of the optical system of the light source apparatus 13 or the like. As in the example shown in FIG. 18A and FIG. 18B, a plurality of (two in this example) LEDs 14a and 14b constituting the light source are shown in the example shown in FIG. 19A and FIG. 19B, and these LEDs are attached at predetermined positions with respect to the LED collimators 15. Note that each of the LED collimators 15 is formed of, for example, a translucent resin such as acrylic.

Further, as in the example shown in FIG. 18A and FIG. 18B, the LED collimator 15 shown in FIG. 19A has a conical convex outer peripheral surface 156 obtained by rotating a parabolic cross section. Also, the central portion at the top (top side) of the LED collimator 15 has a concave portion 153 in which a convex portion (i.e., a convex lens surface) 157 is formed (see FIG. 18B).

Also, the central portion of the flat surface portion of the LED collimator 15 has a convex lens surface 154 protruding outward (or may be a concave lens surface recessed inward) (see FIG. 18B). Note that the paraboloid 156 that forms the conical outer peripheral surface of the LED collimator 15 is set within a range of an angle at which light emitted from the LED 14a in the peripheral direction can be totally reflected inside the paraboloid, or has a reflection surface formed thereon.

Also, each of the LEDs 14a and 14b is arranged at a predetermined position on the surface of the LED substrate 102 which is a circuit board for the LEDs. The LED substrate 102 is arranged and fixed to the LED collimator 15 such that each of the LEDs 14a and 14b on the surface thereof is located at the central portion of the concave portion 153 of the LED collimator 15.

With such a configuration, of the light emitted from the LED 14a or 14b, in particular, the light emitted upward (to the right in the drawing) from the central portion thereof is condensed into parallel light by the two convex lens surfaces 157 and 154 forming the outer shape of the LED collimator 15. Also, the light emitted from the other portion toward the peripheral direction is reflected by the paraboloid forming the conical outer peripheral surface of the LED collimator 15, and is similarly condensed into parallel light. In other words, with the LED collimator 15 having a convex lens formed at the central portion thereof and a paraboloid formed in the peripheral portion thereof, it is possible to extract substantially all of the light generated by the LED 14a or 14b as parallel light, and to improve the utilization efficiency of the generated light.

Note that a light guide 170 is provided on the light emission side of the LED collimator 15 with the first diffusion plate 18a interposed therebetween. The light guide 170 is a member made of, for example, a translucent resin such as acrylic and formed in a rod shape having a substantially triangular cross section (see FIG. 19A). Also, as is apparent also from FIG. 19A, the light guide 170 includes the light guide light incident portion (surface) 171 configured to face the emission surface of the diffusion block 16 with the first diffusion plate 18a interposed therebetween, the light guide light reflection portion (surface) 172 configured to form an inclined surface, and the light guide light emission portion (surface) 173 configured to face the liquid crystal display panel 11, which is a liquid crystal display element, with a reflective polarizing plate 200 interposed therebetween.

For example, if the reflective polarizing plate 200 having the characteristics of reflecting P-polarized light (transmitting S-polarized light) is selected, the P-polarized light of the natural light emitted from the LED as a light source is reflected, the reflected light passes through a λ/4 plate 202 provided on the light guide light reflection portion 172 shown in FIG. 19B and is reflected again by a reflection surface 201, and is converted into S-polarized light by passing through the λ/4 plate 202 again, so that all the light fluxes entering the liquid crystal display panel 11 are unified into S-polarized light.

Similarly, if the reflective polarizing plate 200 having the characteristics of reflecting S-polarized light (transmitting P-polarized light) is selected, the S-polarized light of the natural light emitted from the LED as a light source is reflected, the reflected light passes through the λ/4 plate 202 provided on the light guide light reflection portion 172 shown in FIG. 19B and is reflected again by the reflection surface 201, and is converted into P-polarized light by passing through the λ/4 plate 202 again, so that all the light fluxes entering the liquid crystal display panel 11 are unified into P-polarized light. The polarization conversion can be realized also by the configuration described above.

<Example of Display Apparatus (3)>

Next, another example of the specific configuration of the display apparatus 1 (example of display apparatus (3)) will be described with reference to FIG. 16. The light source apparatus of the display apparatus 1 converts a divergent light flux of the light from the LED (in which P-polarized light and S-polarized light are mixed) into a substantially parallel light flux by a collimator 18, and the converted light flux is reflected by the reflection surface of the reflective light guide 304 toward the liquid crystal display panel 11. Such reflected light enters the reflective polarizing plate 49 arranged between the liquid crystal display panel 11 and the reflective light guide 304. The reflective polarizing plate 49 transmits the light of a specific polarized wave (for example, P-polarized light) and allows the transmitted polarized light to enter the liquid crystal display panel 11. Here, the polarized wave (for example, S-polarized wave) other than the specific polarized wave is reflected by the reflective polarizing plate 49 and directed toward the reflective light guide 304 again.

The reflective polarizing plate 49 is installed so as to be inclined with respect to the liquid crystal display panel 11 so as not to be perpendicular to the main light beam of the light from the reflection surface of the reflective light guide 304. Then, the main light beam of the light reflected by the reflective polarizing plate 49 enters the transmission surface of the reflective light guide 304. The light that has entered the transmission surface of the reflective light guide 304 is transmitted through the back surface of the reflective light guide 304, is transmitted through a λ/4 plate 270 as a retardation plate, and is reflected by a reflection plate 271. The light reflected by the reflection plate 271 is transmitted through the λ/4 plate 270 again and is transmitted through the transmission surface of the reflective light guide 304. The light transmitted through the transmission surface of the reflective light guide 304 enters the reflective polarizing plate 49 again.

At this time, since the light that enters the reflective polarizing plate 49 again has passed through the λ/4 plate 270 twice, the polarization thereof is converted into a polarized wave (for example, P-polarized light) that can pass through the reflective polarizing plate 49. Therefore, the light whose polarization has been converted passes through the reflective polarizing plate 49 and enters the liquid crystal display panel 11. Regarding the polarization design related to polarization conversion, the polarization may be reversed from that in the above description (the S-polarized light and the P-polarized light may be reversed).

As a result, the light from the LED is aligned into a specific polarized wave (e.g., a P-polarized light) and enters the liquid crystal panel 11. Then, after the luminance is modulated in accordance with the video signal, the video is displayed on the panel surface. As in the above-described example, a plurality of LEDs constituting the light source are provided (however, only one LED is shown in FIG. 16 due to the vertical cross section), and these LEDs are attached at predetermined positions with respect to the collimators 18.

Note that each of the collimators 18 is formed of, for example, a translucent resin such as acrylic or glass. Further, the collimator 18 may have a conical convex outer peripheral surface obtained by rotating a parabolic cross section. The top of the collimator 18 may have a concave portion in which a convex portion (i.e., a convex lens surface) is formed at its central portion. Also, the central portion of the flat surface portion thereof has a convex lens surface protruding outward (or may be a concave lens surface recessed inward). Note that the paraboloid that forms the conical outer peripheral surface of the collimator 18 is set within a range of an angle at which light emitted from the LED in the peripheral direction can be totally reflected inside the paraboloid, or has a reflection surface formed thereon.

Note that each of the LEDs is arranged at a predetermined position on the surface of the LED substrate 102 which is a circuit board for the LEDs. The LED substrate 102 is arranged and fixed to the collimator 18 such that each of the LEDs on the surface thereof is located at the central portion at the top of the conical convex portion (concave portion when there is the concave portion at the top).

With such a configuration, of the light emitted from the LED, in particular, the light emitted from the central portion thereof is condensed into parallel light by the convex lens surface forming the outer shape of the collimator 18. Also, the light emitted from the other portion toward the peripheral direction is reflected by the paraboloid forming the conical outer peripheral surface of the collimator 18, and is similarly condensed into parallel light. In other words, with the collimator 18 having a convex lens formed at the central portion thereof and a paraboloid formed in the peripheral portion thereof, it is possible to extract substantially all of the light generated by the LED as parallel light, and to improve the utilization efficiency of the generated light.

The above configuration is the same as that of the light source apparatus of the video display apparatus shown in FIG. 17, FIG. 18A, FIG. 18B, and the like. Furthermore, the light converted into substantially parallel light by the collimator 18 shown in FIG. 16 is reflected by the reflective light guide 304. The light of a specific polarized wave of such light is transmitted through the reflective polarizing plate 49 by the action of the reflective polarizing plate 49, and the light of the other polarized wave reflected by the action of the reflective polarizing plate 49 is transmitted through the light guide 304 again. The light is reflected by the reflection plate 271 located at a position opposite to the liquid crystal display panel 11 with respect to the reflective light guide 304. At this time, the polarization of the light is converted by passing through the λ/4 plate 270, which is a retardation plate, twice. The light reflected by the reflection plate 271 is transmitted through the light guide 304 again and enters the reflective polarizing plate 49 provided on the opposite surface. Since the incident light has been subjected to polarization conversion, it is transmitted through the reflective polarizing plate 49 and enters the liquid crystal display panel 11 with the aligned polarization direction. As a result, all of the light from the light source can be used, and the utilization efficiency of light in geometrical optics is doubled. Further, the degree of polarization (extinction ratio) of the reflective polarizing plate is also multiplied with the extinction ratio of the entire system, so that the contrast ratio of the overall display apparatus is significantly improved by using the light source apparatus of the present embodiment. Also, by adjusting the surface roughness of the reflection surface of the reflective light guide 304 and the surface roughness of the reflection plate 271, the reflection diffusion angle of light on each reflection surface can be adjusted. It is preferable that the surface roughness of the reflection surface of the reflective light guide 304 and the surface roughness of the reflection plate 271 are adjusted for each design such that the uniformity of the light entering the liquid crystal display panel 11 becomes more favorable.

Note that the λ/4 plate 270 which is the retardation plate in FIG. 16 does not necessarily have the phase difference of λ/4 with respect to the polarized light that has vertically entered the λ/4 plate 270. In the configuration of FIG. 16, any retardation plate may be used as long as it can change the phase by 90° (λ/2) when the polarized light is transmitted through it twice. The thickness of the retardation plate may be adjusted in accordance with the incident angle distribution of polarized light.

<Example of Display Apparatus (4)>

Further, another example (example of display apparatus (4)) of the configuration of the optical system of the light source apparatus or the like of the display apparatus will be described with reference to FIG. 25. This is a configuration example in which a diffusion sheet is used instead of the reflective light guide 304 in the light source apparatus in the example of display apparatus (3). Specifically, two optical sheets (optical sheet 207A and optical sheet 207B) for converting the diffusion characteristics in the vertical direction and the horizontal direction of the drawing are provided on the light emission side of the collimator 18, and the light from the collimator 18 is made to enter between the two optical sheets (diffusion sheets). The optical sheet may be composed of one sheet rather than two sheets. When composed of one sheet, the vertical and horizontal diffusion characteristics are adjusted by the fine shapes of the front surface and the back surface of the one optical sheet. Alternatively, a plurality of diffusion sheets may be used to share the function. Here, in the example of FIG. 25, it is preferable that the reflection diffusion characteristics by the front surface shapes and the back surface shapes of the optical sheet 207A and the optical sheet 207B are optimally designed with using the number of LEDs, the divergence angle from the LED substrate (optical element) 102, and optical specifications of the collimator 18 as design parameters such that the surface density of the light flux emitted from the liquid crystal display panel 11 is uniform. In other words, the diffusion characteristics are adjusted by the surface shapes of the plurality of diffusion sheets instead of the light guide. In the example of FIG. 25, the polarization conversion is performed in the same manner as in the example of display apparatus (3) described above. Namely, in the example of FIG. 25, the reflective polarizing plate 49 may be configured to have characteristics that reflect the S-polarized light (and transmits the P-polarized light). In this case, of the light emitted from the LED as a light source, the P-polarized light is transmitted and the transmitted light enters the liquid crystal display panel 11. Of the light emitted from the LED as a light source, the S-polarized light is reflected and the reflected light is transmitted through the retardation plate 270 shown in FIG. 25. The light that has passed through the retardation plate 270 is reflected by the reflection surface 271. The light reflected by the reflection surface 271 is converted into the P-polarized light by passing through the retardation plate 270 again. The light that has been subjected to the polarization conversion is transmitted through the reflective polarizing plate 49 and enters the liquid crystal display panel 11.

Note that the λ/4 plate 270 which is the retardation plate in FIG. 25 does not necessarily have the phase difference of λ/4 with respect to the polarized light that has vertically entered the λ/4 plate 270. In the configuration of FIG. 25, any retardation plate may be used as long as it can change the phase by 90° (λ/2) when the polarized light is transmitted through it twice. The thickness of the retardation plate may be adjusted in accordance with the incident angle distribution of polarized light. Also in FIG. 25, regarding the polarization design related to polarization conversion, the polarization may be reversed from that in the above description (the S-polarized light and the P-polarized light may be reversed).

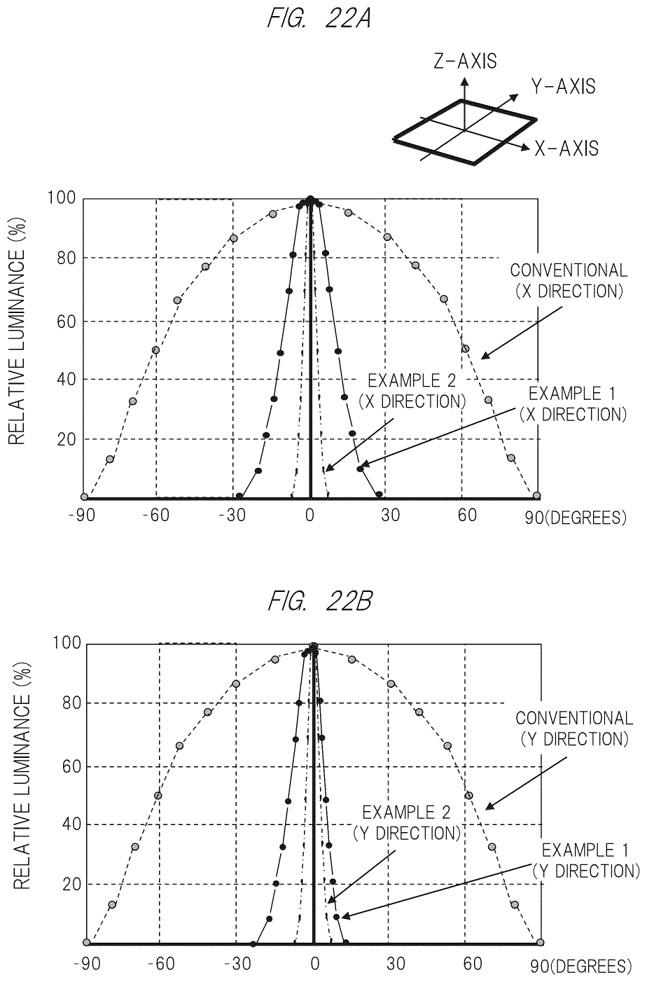

In an apparatus for use in a general TV set, the light emitted from the liquid crystal display panel 11 has similar diffusion characteristics in both the horizontal direction of the screen (indicated by the X axis in FIG. 22A) and the vertical direction of the screen (indicated by the Y axis in FIG. 22B). On the other hand, in the diffusion characteristics of the light flux emitted from the liquid crystal display panel of the present embodiment, for example, as shown in Example 1 in FIG. 22A and FIG. 22B, the viewing angle at which the luminance becomes 50% of that in front view (angle of 0 degrees) is 13 degrees, and this is ⅕ of the conventional viewing angle of 62 degrees. Similarly, the reflection angle of the reflective light guide, the area of the reflection surface, and the like are optimized such that the viewing angle in the vertical direction is made uneven in top and bottom and the viewing angle on the upper side is suppressed to about ⅓ of the viewing angle on the lower side. As a result, the amount of video light toward the viewing direction is significantly improved as compared with the conventional liquid crystal TV, and the luminance is 50 times or more.

Further, in the viewing angle characteristics shown in Example 2 in FIG. 22A and FIG. 22B, the viewing angle at which the luminance becomes 50% of that in front view (angle of 0 degrees) is 5 degrees, and this is 1/12 of the conventional viewing angle of 62 degrees. Similarly, the reflection angle of the reflective light guide, the area of the reflection surface, and the like are optimized such that the viewing angle in the vertical direction is made even in top and bottom and the viewing angle is suppressed to about 1/12 of the conventional viewing angle. As a result, the amount of video light toward the viewing direction is significantly improved as compared with the conventional liquid crystal TV, and the luminance is 100 times or more. As described above, by setting the viewing angle to a narrow angle, the amount of light flux toward the viewing direction can be concentrated, so that the utilization efficiency of light is significantly improved. As a result, even if a conventional liquid crystal display panel for TV is used, it is possible to realize a significant improvement in luminance with the same power consumption by controlling the light diffusion characteristics of the light source apparatus, and to provide the video display apparatus suitable for the information display system for bright outdoor use.

When using a large liquid crystal display panel, the overall brightness of the screen is improved by directing the light in the periphery of the screen inward, that is, toward the observer who is squarely facing the center of the screen. FIG. shows the convergence angle of the long side and the short side of the panel when the distance L from the observer to the panel and the panel size (screen ratio 16:10) are used as parameters. In the case of monitoring the screen as a vertically long screen, the convergence angle may be set in accordance with the short side. For example, in the case in which a 22-inch panel is used vertically and the monitoring distance is 0.8 m, the video light from the four corners of the screen can be effectively directed toward the observer by setting the convergence angle to 10 degrees.

Similarly, in the case in which a 15-inch panel is used vertically and the monitoring distance is 0.8 m, the video light from the four corners of the screen can be effectively directed toward the observer by setting the convergence angle to 7 degrees. As described above, the overall brightness of the screen can be improved by adjusting the video light in the periphery of the screen so as to be directed to the observer located at the optimum position to monitor the center of the screen depending on the size of the liquid crystal display panel and whether the liquid crystal display panel is used vertically or horizontally.

As a basic configuration, as shown in FIG. 16 and others described above, a light flux having narrow-angle directional characteristics is made to enter the liquid crystal display panel 11 by the light source apparatus, and the luminance is modulated in accordance with a video signal, whereby the air floating video obtained by reflecting the video information displayed on the screen of the liquid crystal display panel 11 by the retroreflector is displayed outdoors or indoors through the transparent member 100.

<Lenticular Lens>

In order to control the diffusion distribution of the video light from the liquid crystal display panel 11, the lens shape is optimized by providing a lenticular lens between the light source apparatus 13 and the liquid crystal display panel 11 or on the surface of the liquid crystal display panel 11, so that the emission characteristics in one direction can be controlled. Further, by arranging a microlens array in a matrix, the emission characteristics of the video light flux from the display apparatus 1 can be controlled in the X-axis and Y-axis directions, and as a result, it is possible to obtain a video display apparatus having desired diffusion characteristics.

The function of the lenticular lens will be described. By optimizing the lens shape, the lenticular lens can efficiently obtain an air floating image by the transmission or reflection of the light emitted from the above-described display apparatus 1 at the transparent member 100. Namely, by providing a sheet for controlling the diffusion characteristics of the video light from the display apparatus 1 by combining two lenticular lenses or arranging a microlens array in a matrix, the luminance (relative luminance) of the video light in the X-axis and Y-axis directions can be controlled in accordance with the reflection angle (the vertical direction is 0 degrees) thereof. In the present embodiment, by such a lenticular lens, the luminance (relative luminance) of light by the reflection and diffusion is enhanced by making the luminance characteristics in the vertical direction steep and changing the balance of the directional characteristics in the vertical direction (positive and negative directions of the Y-axis) as compared with the conventional case as shown in FIG. 22B, whereby the video light having a narrow diffusion angle (high straightness) and only a specific polarized component like the video light from the surface-emitting laser video source is obtained, and the air floating image by the retroreflection efficiently reaches the eyes of the observer while suppressing the ghost image that has been generated in the retroreflector in the case of using the video display apparatus of the conventional technique.

Further, with the above-described light source apparatus, directional characteristics with significantly narrower angle in both the X-axis direction and the Y-axis direction with respect to the diffusion characteristics of the light emitted from the general liquid crystal display panel shown in FIG. 22A and FIG. 22B (denoted as conventional in the drawings) are obtained, so that it is possible to realize a video display apparatus that emits light of a specific polarized wave that emits a video light flux that is nearly parallel to a specific direction.

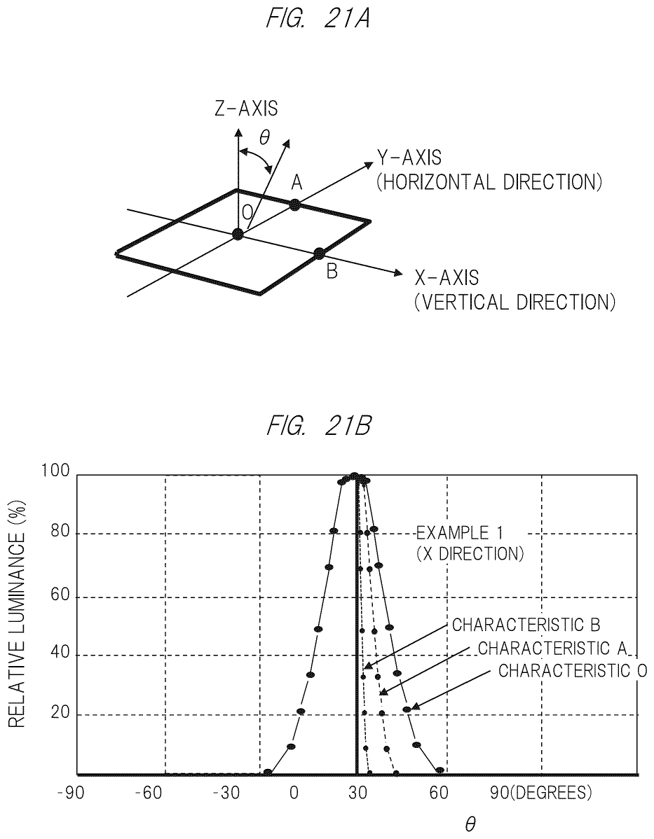

FIG. 21A and FIG. 21B show an example of the characteristics of the lenticular lens adopted in the present embodiment. In this example, in particular, the characteristics in the X direction (vertical direction) are shown, and the characteristic O indicates a vertically symmetrical luminance characteristic in which the peak in the light emission direction is at an angle of around 30 degrees upward from the vertical direction (0 degrees). Further, the characteristics A and B in FIG. 21B each indicate an example of a characteristic in which video light above the peak luminance is condensed at around 30 degrees to increase the luminance (relative luminance). Therefore, in the characteristics A and B, the luminance (relative luminance) of light is sharply reduced at an angle exceeding 30 degrees as compared with the characteristic O.

Namely, in the optical system including the above-described lenticular lens, when the video light flux from the display apparatus 1 enters the retroreflector 2, the emission angle and the viewing angle of the video light aligned at a narrow angle can be controlled by the light source apparatus 13, and the degree of freedom of installation of the retroreflection sheet (retroreflector 2) can be significantly improved. As a result, it is possible to significantly improve the degree of freedom of the relationship of the imaging position of the air floating image which is imaged at a desired position by the reflection or the transmission at the transparent member 100. As a result, light having a narrow diffusion angle (high straightness) and having only a specific polarized component can be obtained, and the air floating image can efficiently reach the eyes of an observer outdoors or indoors. According to this, even if the intensity (luminance) of the video light from the video display apparatus is reduced, the observer can accurately recognize the video light and obtain information. In other words, by reducing the output of the video display apparatus, it is possible to realize an air floating video display apparatus with lower power consumption.

<Assist Function of Touch Operation>

Next, the assist function of the touch operation for the user will be described. First, the touch operation when the assist function is not provided will be described. Here, a case where the user selects and touches one of two buttons (objects) will be described as an example, but the following contents can be favorably applied to, for example, an ATM of a bank, a ticket vending machine of a station, a digital signage, or the like.

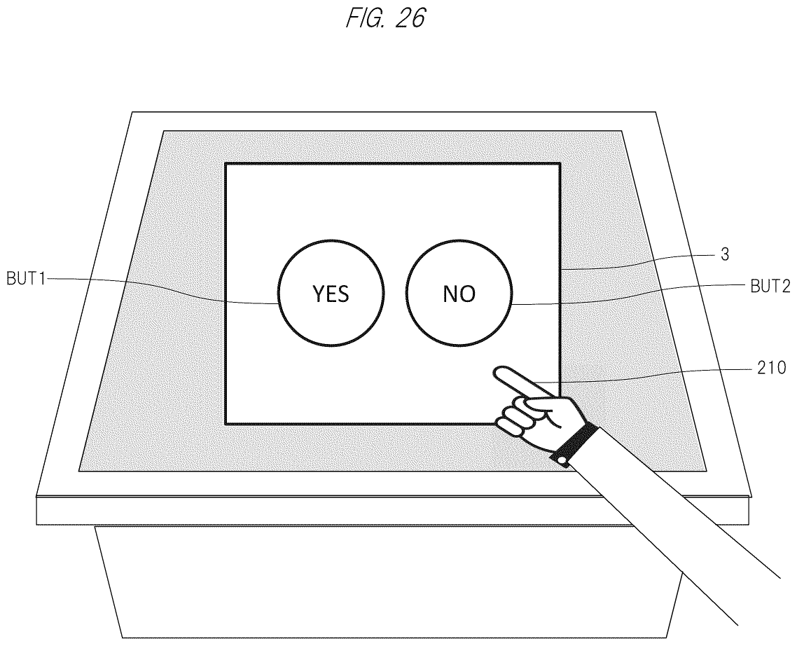

FIG. 26 is a diagram for describing a display example and a touch operation of the air floating video display apparatus 1000. The air floating video 3 shown in FIG. 26 includes a first button BUT1 displayed as “YES” and a second button BUT2 displayed as “NO”. The user selects “YES” or “NO” by moving a finger 210 toward the air floating vide 3 and touching the first button BUTT or the second button BUT2. Note that it is assumed in the example of FIG. 26 and FIG. 27A to FIG. 29B that the first button BUT1 and the second button BUT2 are displayed in different colors. Here, the region of the air floating video 3 other than the first button BUT1 and the second button BUT2 may be made transparent without displaying the video, but in that case, the range where the effect of a virtual shadow described later is exhibited is limited to only the region of the displayed buttons (display region of the first button BUT1 and display region of the second button BUT2). Therefore, in the following description, as a more favorable example, in the wider region including the display region of the first button BUT1 and the display region of the second button BUT2, the video with a different color or luminance from those of the first button BUT1 and the second button BUT2 is assumed to be displayed in the region of the air floating video 3 other than the first button BUT1 and the second button BUT2.

In a general video display apparatus with a touch panel that is not the air floating video display apparatus, buttons to be selected by the user are composed of video buttons displayed on the touch panel surface. Therefore, the user can perceive the distance between the object (for example, button) displayed on the touch panel surface and his or her finger by visually recognizing the touch panel surface. However, since the air floating video 3 is floating in the air in the case of using the air floating video display apparatus, it is sometimes difficult for the user to perceive the depth of the air floating video 3. Therefore, in the touch operation on the air floating video 3, it is sometimes difficult for the user to perceive the distance between the button displayed in the air floating video 3 and his or her finger. In addition, in a general video display apparatus with a touch panel that is not the air floating video display apparatus, the user can easily determine whether or not he or she has touched the button by the feeling of the touch. However, in the touch operation on the air floating video 3, the user may not be able to determine whether or not he or she has touched the object (for example, button) because there is no feeling of the touch on the object (for example, button). In consideration of the above situation, an assist function of the touch operation for the user is provided in the present embodiment.

In the following description, the processing based on the position of the finger of the user will be described, but a specific method of detecting the position of the finger of the user will be described later.

<<Assist of Touch Operation Using Virtual Shadow (1)>>

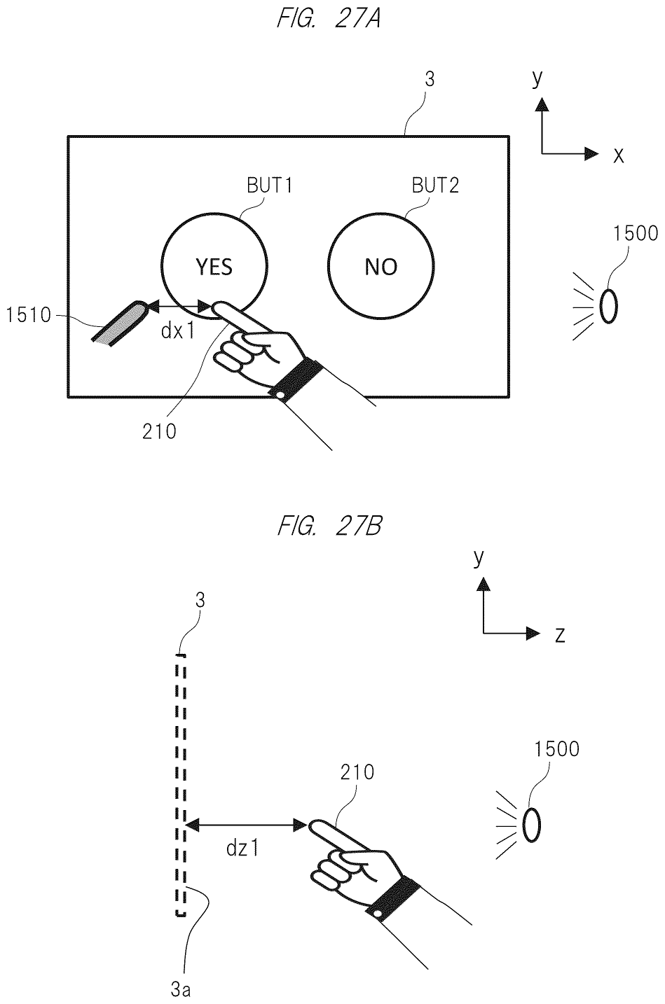

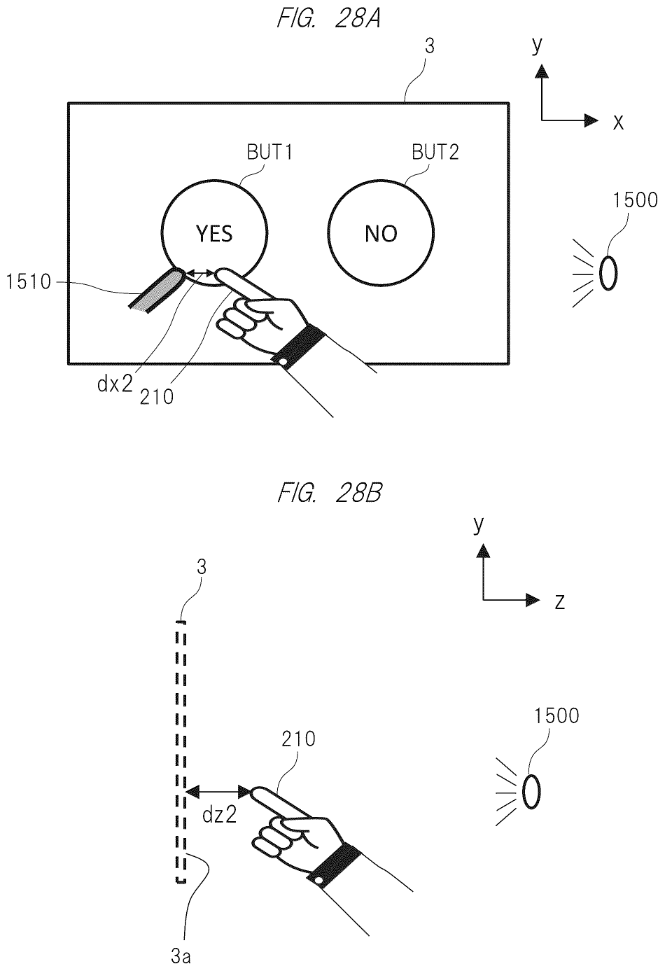

FIG. 27A to FIG. 29B are diagrams for describing an example of a method of assisting a touch operation using a virtual shadow. It is assumed that the user touches the first button BUT1 to select “YES” in the example of FIG. 27A to FIG. 29B. The air floating video display apparatus 1000 of the present embodiment assists the touch operation of the user by displaying a virtual shadow on the displayed video of the air floating video 3. Here, “displaying a virtual shadow on the displayed video of the air floating video 3” means the video display processing in which the luminance of the video signal corresponding to a partial region shaped like a finger is reduced such that it looks as if a shadow is projected on the video displayed as the air floating video 3. Specifically, the processing may be performed by calculation by the video controller 1160 or the controller 1110. In the display processing of the virtual shadow, the luminance of the video signal corresponding to a partial region shaped like a finger may be completely set to 0. However, rather than completely setting the luminance of the video signal corresponding to a partial region shaped like a finger to 0, it is more preferable to display a video with reduced luminance in this region because it is recognized as a shadow more naturally. In this case, in the display processing of the virtual shadow, not only the luminance of the video signal corresponding to a partial region shaped like a finger is reduced, but also the saturation of the video signal may be reduced.

The air floating video 3 is present in the air where there is no physical contact surface, and the shadow of the finger is not projected in a normal environment. However, according to the display processing of the virtual shadow in the present embodiment, even in the air where the shadow of the finger is not projected originally, the depth perception of the air floating video 3 and the feeling of presence of the air floating video 3 for the user can be improved by displaying the shadow as if it is present in the air floating video 3.

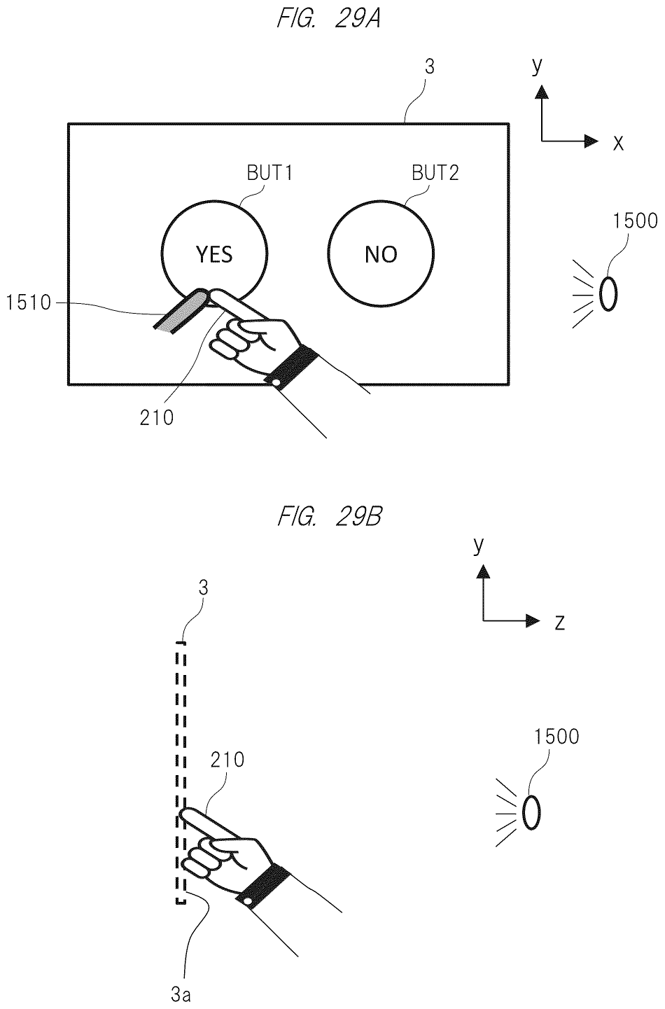

FIG. 27A and FIG. 27B show the state at the first point of time when the user tries to perform the touch operation on the first button BUT1 on a display plane 3a of the air floating video 3 with the finger 210, FIG. 28A and FIG. 28B show the state at the second point of time when the finger 210 is closer to the air floating video 3 than the case in FIG. 27A and FIG. 27B, and FIG. 29A and FIG. 29B show the state at the third point of time when the finger 210 has touched the first button BUT1 on the display plane 3a of the air floating video 3. Also, FIG. 27A, FIG. 28A, and FIG. 29A show the state when the display plane 3a of the air floating video 3 is viewed from the front (in the normal direction of the display plane 3a), and FIG. 27B, FIG. 28B, and FIG. 29B show the state when the display plane 3a of the air floating video 3 is viewed from the side (direction parallel to the display plane 3a). In FIG. 27A to FIG. 29B, the x direction is the horizontal direction on the display plane 3a of the air floating video 3, the y direction is the direction perpendicular to the x axis on the display plane 3a of the air floating video 3, and the z direction is the normal direction of the display plane 3a of the air floating video 3 (height direction with respect to the display plane 3a). In the explanatory diagrams of FIG. 27A to FIG. 33, the air floating video 3 is illustrated to have a thickness in the depth direction for ease of description, but in reality, the air floating video 3 is also a flat plane if the video display surface of the display apparatus 1 is a flat plane, and the air floating video 3 has no thickness in the depth direction. In this case, the air floating video 3 and the display plane 3a are on the same plane. In the description of the present embodiment, the display plane 3a means a plane on which the air floating video 3 can be displayed, and the air floating video 3 means a portion where the air floating video is actually displayed.

In FIG. 27A to FIG. 29B, the detection processing of the finger 210 is performed by using, for example, the captured image generated by the imager 1180 and the sensing signal of the spatial operation detection sensor 1351. In the detection processing of the finger 210, for example, the position (x coordinate, y coordinate) of the tip of the finger 210 on the display plane 3a of the air floating video 3, the height position (z coordinate) of the tip of the finger 210 with respect to the display plane 3a, and others are detected. Here, the position (x coordinate, y coordinate) of the tip of the finger 210 on the display plane 3a of the air floating video 3 is the positional coordinates of the intersection between the display plane 3a of the air floating video 3 and the perpendicular line from the tip of the finger 210 to the display plane 3a. Note that the height position of the tip of the finger 210 with respect to the display plane 3a is also depth information representing the depth of the finger 210 with respect to the display plane 3a. The arrangement and the like of the imager 1180 and the spatial operation detection sensor 1351 that detect the finger 210 and the like will be described later in detail.

At the first point of time shown in FIG. 27A and FIG. 27B, the finger 210 is assumed to be located at the position farthest from the display plane 3a of the air floating video 3 as compared with the second point of time shown in FIG. 28A and FIG. 28B and the third point of time shown in FIG. 29A and FIG. 29B. The distance (height position) between the tip of the finger 210 and the display plane 3a of the air floating video 3 at this time is defined as dz1. That is, the distance dz1 indicates the height of the finger 210 with respect to the display plane 3a of the air floating video 3 in the z direction.

As for the distance dz1 shown in FIG. 27B, a distance dz2 shown in FIG. 28B described later, and the like, the user side with respect to the display plane 3a of the air floating vide 3 is defined as the positive side, and the side opposite to the user with respect to the display plane 3a is defined as the negative side. That is, if the finger 210 is present on the user side with respect to the display plane 3a, the distances dz1 and dz2 are positive values, and if the finger 210 is present on the side opposite to the user with respect to the display plane 3a, the distances dz1 and dz2 are negative values.

In the present embodiment, it is assumed that a virtual light source 1500 is present on the user side with respect to the display plane 3a of the air floating video 3. Here, the setting of the installation direction of the virtual light source 1500 may be actually stored as information in the nonvolatile memory 1108 or the memory 1109 of the air floating video display apparatus 1000. Also, the setting of the installation direction of the virtual light source 1500 may be a parameter that exists only in design. Even if the setting of the installation direction of the virtual light source 1500 is a parameter that exists only in design, the installation direction of the virtual light source 1500 in design is uniquely determined from the relationship between the position of the finger of the user and the display position of the virtual shadow described later. Here, in the example of FIG. 27A to FIG. 29B, the virtual light source 1500 is provided on the user side with respect to the display plane 3a and on the right side of the display plane 3a as viewed from the user. Then, a virtual shadow 1510 imitating the shadow of the finger 210 formed by the light emitted from the virtual light source 1500 is displayed in the air floating video 3. In the example of FIG. 27A to FIG. 29B, the virtual shadow 1510 is displayed on the left side of the finger 210. This virtual shadow 1510 assists the user in performing a touch operation.

In the state of FIG. 27B, the tip of the finger 210 is the farthest from the display plane 3a of the air floating video 3 in the normal direction as compared with the state of FIG. 28B and the state of FIG. 29B. Therefore, in FIG. 27A, the tip of the virtual shadow 1510 is formed at the position farthest from the first button BUT1 to be touched in the horizontal direction as compared with the state of FIG. 28A and the state of FIG. 29A. Therefore, the distance in the horizontal direction between the tip of the finger 210 and the tip of the virtual shadow 1510 when the display plane 3a of the air floating video 3 is viewed from the front is the largest in FIG. 27A as compared with the state of FIG. 28A and the state of FIG. 29A. In FIG. 27A, the distance between the tip of the finger 210 and the tip of the virtual shadow 1510 in the horizontal direction of the display plane 3a of the air floating video 3 is defined as dx1.

Then, in FIG. 28B, the finger 210 is closer to the air floating video 3 than the case in FIG. 27B. Therefore, in FIG. 28B, the distance dz2 in the normal direction between the tip of the finger 210 and the display plane 3a of the air floating video 3 is smaller than dz1. At this time, in FIG. 28A, the virtual shadow 1510 is displayed at the position where the distance between the tip of the finger 210 and the tip of the virtual shadow 1510 in the horizontal direction of the display plane 3a of the air floating video 3 is dx2 which is smaller than dx1. Namely, in the case of FIG. 28A and FIG. 28B, the virtual light source 1500 is provided on the user side with respect to the display plane 3a and on the right side of the display plane 3a as viewed from the user, and thus the distance in the horizontal direction between the tip of the finger 210 and the tip of the virtual shadow 1510 when the display plane 3a of the air floating video 3 is viewed from the front changes along with the distance in the normal direction between the tip of the finger 210 and the display plane 3a of the air floating video 3.

Then, when the tip of the finger 210 comes into contact with the tip of the virtual shadow 1510, the distance in the normal direction between the tip of the finger 210 and the display plane 3a of the air floating video 3 becomes zero as shown in FIG. 29A and FIG. 29B. At this time, the virtual shadow 1510 is displayed such that the distance between the finger 210 and the virtual shadow 1510 in the horizontal direction of the display plane 3a of the air floating video 3 is zero. Thereby, the user can recognize that the finger 210 has touched the display plane 3a of the air floating video 3. At this time, if the tip of the finger 210 touches the region of the first button BUT1, the user can recognize that he or she has touched the first button BUT1. Namely, also in the case of FIG. 29A and FIG. 29B, the virtual light source 1500 is provided on the user side with respect to the display plane 3a and on the right side of the display plane 3a as viewed from the user, and thus the distance in the horizontal direction between the tip of the finger 210 and the tip of the virtual shadow 1510 when the display plane 3a of the air floating video 3 is viewed from the front changes along with the distance in the normal direction between the tip of the finger 210 and the display plane 3a of the air floating video 3. Namely, the display position of the tip of the virtual shadow 1510 is a position specified by the positional relationship between the position of the virtual light source 1500 and the position of the tip of the finger 210 of the user, and changes along with the change in the position of the tip of the finger 210 of the user.

According to the configuration and processing of the “Assist of Touch Operation Using Virtual Shadow (1)” described above, the user can more favorably recognize the distance (depth) in the normal direction between the finger 210 and the display plane 3a of the air floating video 3 from the positional relationship in the horizontal direction between the finger 210 and the virtual shadow 1510 on the display plane 3a of the air floating video 3 during the touch operation. Also, when the finger 210 has touched the object (for example, a button) that is the air floating video 3, the user can recognize that he or she has touched the object. Thereby, it is possible to provide a more favorable air floating video display apparatus.

<<Assist of Touch Operation Using Virtual Shadow (2)>>

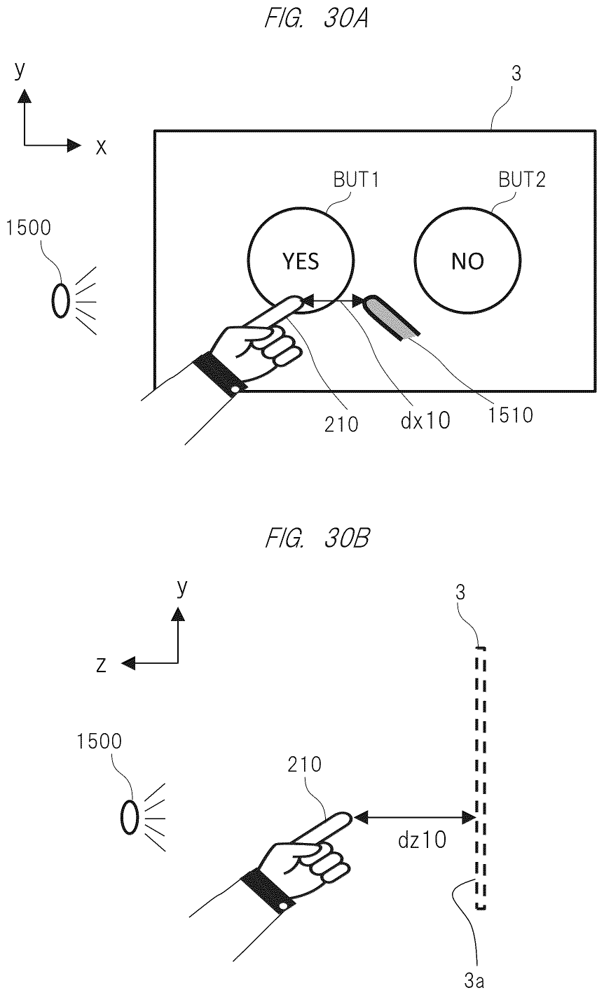

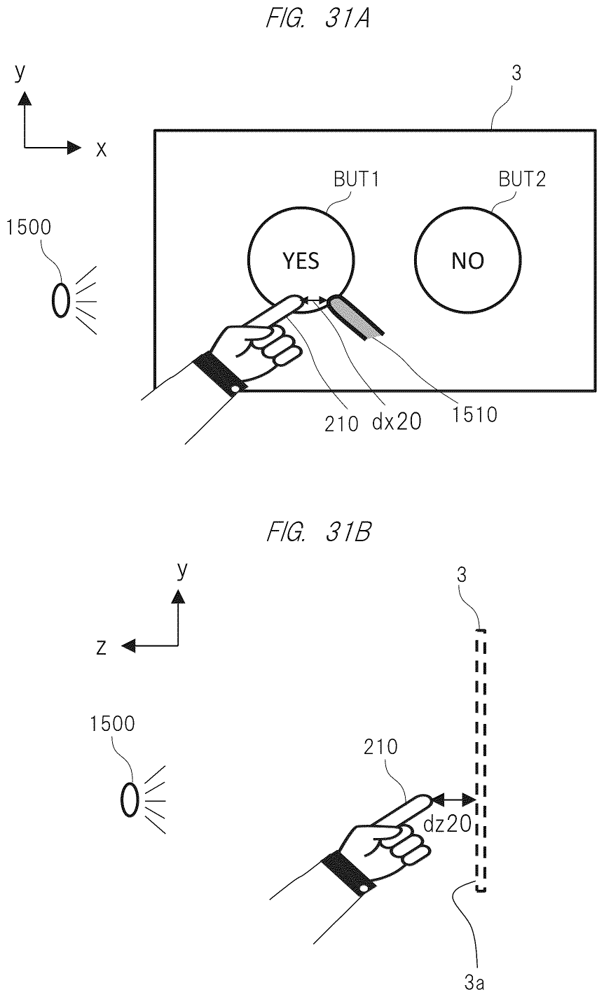

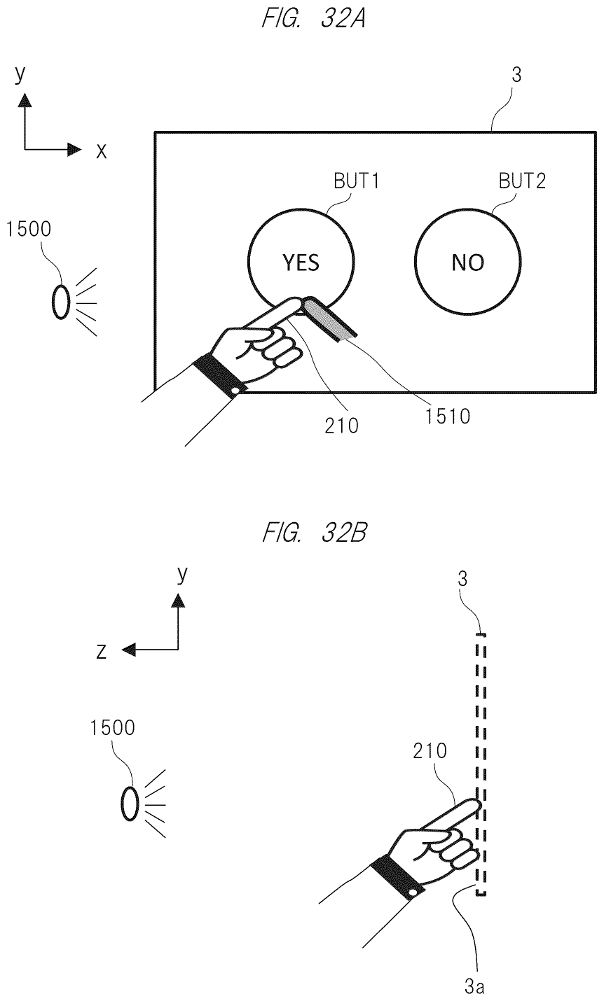

Next, as another example of the method of assisting the touch operation using the virtual shadow, the case in which the virtual light source 1500 is provided on the left side of the display plane 3a as viewed from the user will be described. FIG. to FIG. 32B are diagrams for describing another example of the method of assisting the touch operation using the virtual shadow. FIG. 30A and FIG. 30B correspond to FIG. 27A and FIG. 27B, and show the state at the first point of time when the user tries to perform the touch operation on the first button BUT1 on the display plane 3a of the air floating video 3 with the finger 210. FIG. 31A and FIG. 31B correspond to FIG. 28A and FIG. 28B, and show the state at the second point of time when the finger 210 is closer to the air floating video 3 than the case in FIG. and FIG. 30B. FIG. 32A and FIG. 32B correspond to FIG. 29A and FIG. 29B, and show the state at the point of time when the finger 210 has touched the air floating video 3. For convenience of description, FIG. 30B, FIG. 31B, and FIG. 32B show the state viewed from the direction opposite to that of FIG. 27B, FIG. 28B, and FIG. 29B.

In FIG. 30A to FIG. 32B, the virtual light source 1500 is provided on the user side with respect to the display plane 3a and on the left side of the display plane 3a as viewed from the user. Then, the virtual shadow 1510 imitating the shadow of the finger 210 formed by the light emitted from the virtual light source 1500 is displayed in the air floating video 3. In the example of FIG. 30A to FIG. 32B, the virtual shadow 1510 is displayed on the right side of the finger 210. This virtual shadow 1510 assists the user in performing a touch operation.

In the state of FIG. 30B, the tip of the finger 210 is the farthest from the display plane 3a of the air floating video 3 in the normal direction as compared with the states of FIG. 31B and FIG. 32B. In FIG. 30B, the distance in the normal direction between the tip of the finger 210 and the display plane 3a of the air floating video 3 at this time is dz10. Also, in FIG. 30A, the distance between the tip of the finger 210 and the tip of the virtual shadow 1510 in the horizontal direction of the display plane 3a of the air floating video 3 at this time is dx10.

In FIG. 31B, the finger 210 is closer to the air floating video 3 than the case in FIG. 30B. Therefore, in FIG. 31B, the distance dz20 in the normal direction between the tip of the finger 210 and the display plane 3a of the air floating video 3 is smaller than dz10. At this time, in FIG. 31A, the virtual shadow 1510 is displayed at the position where the distance between the tip of the finger 210 and the tip of the virtual shadow 1510 in the horizontal direction of the display plane 3a of the air floating video 3 is dx20 which is smaller than dx10. Namely, in the case of FIG. 31A and FIG. 31B, the virtual light source 1500 is provided on the user side with respect to the display plane 3a and on the left side of the display plane 3a as viewed from the user, and thus the distance in the horizontal direction between the tip of the finger 210 and the tip of the virtual shadow 1510 when the display plane 3a of the air floating video 3 is viewed from the front changes along with the distance in the normal direction between the tip of the finger 210 and the display plane 3a of the air floating video 3.

Then, when the tip of the finger 210 comes into contact with the tip of the virtual shadow 1510, the distance in the normal direction between the tip of the finger 210 and the display plane 3a of the air floating video 3 becomes zero as shown in FIG. 32A and FIG. 32B. At this time, the virtual shadow 1510 is displayed such that the distance between the finger 210 and the virtual shadow 1510 in the horizontal direction of the display plane 3a of the air floating video 3 is zero. Thereby, the user can recognize that the finger 210 has touched the display plane 3a of the air floating video 3. At this time, if the tip of the finger 210 touches the region of the first button BUT1, the user can recognize that he or she has touched the first button BUT1. Namely, also in the case of FIG. 32A and FIG. 32B, the virtual light source 1500 is provided on the user side with respect to the display plane 3a and on the left side of the display plane 3a as viewed from the user, and thus the distance in the horizontal direction between the tip of the finger 210 and the tip of the virtual shadow 1510 when the display plane 3a of the air floating video 3 is viewed from the front changes along with the distance in the normal direction between the tip of the finger 210 and the display plane 3a of the air floating video 3.

The same effects as those of the configuration in FIG. 27A to FIG. 29B can be obtained also in the configuration and processing of “Assist of Touch Operation Using Virtual Shadow (2)” described above.

Here, when the above-described processing of “Assist of Touch Operation Using Virtual Shadow (1)” and/or processing of “Assist of Touch Operation Using Virtual Shadow (2)” are implemented in the air floating video display apparatus 1000, the following multiple implementation examples are possible.

The first implementation example is a method in which only “Assist of Touch Operation Using Virtual Shadow (1)” is implemented in the air floating video display apparatus 1000. In this case, since the virtual light source 1500 is provided on the user side with respect to the display plane 3a and on the right side of the display plane 3a as viewed from the user, the virtual shadow 1510 is displayed on the left side of the tip of the finger 210 of the user as viewed from the user. Therefore, if the finger 210 of the user is the finger of the right hand, the visibility of the display of the virtual shadow 1510 is favorable because the virtual shadow 1510 is not blocked by the right hand or right arm of the user. Accordingly, considering the statistical tendency that there are many right-handed users, it is preferable to implement only “Assist of Touch Operation Using Virtual Shadow (1)” because the probability that the display of the virtual shadow 1510 can be favorably visually recognized is sufficiently high even when only “Assist of Touch Operation Using Virtual Shadow (1)” is implemented in the air floating video display apparatus 1000.

In addition, as the second implementation example, the configuration in which both the processing of “Assist of Touch Operation Using Virtual Shadow (1)” and the processing of “Assist of Touch Operation Using Virtual Shadow (2)” are implemented and the processing to be used is switched depending on whether the user performs the touch operation with the right hand or the left hand is also possible. In this case, it is possible to further increase the probability that the display of the virtual shadow 1510 can be favorably visually recognized and to improve the convenience for the user.

Specifically, when the user is performing the touch operation with the right hand, the virtual shadow 1510 is displayed on the left side of the finger 210 by using the configuration of FIG. 27A to FIG. 29B. In this case, the visibility of the display of the virtual shadow 1510 is favorable because it is not blocked by the right hand or right arm of the user. On the other hand, when the user is performing the touch operation with the left hand, the virtual shadow 1510 is displayed on the right side of the finger 210 by using the configuration of FIG. 30A to FIG. 32B. In this case, the visibility of the display of the virtual shadow 1510 is favorable because it is not blocked by the left hand or left arm of the user. As a result, it is possible to display the virtual shadow 1510 at the position where the user can easily visually recognize the virtual shadow 1510 in both the case where the user performs the touch operation with the right hand and the case where the user performs the touch operation with the left hand, and to improve the convenience for the user.

Here, the determination as to whether the user is performing the touch operation with the right hand or the left hand may be performed based on, for example, the captured image generated by the imager 1180. For example, the controller 1110 performs the image processing on the captured image and detects the face, arms, hands, and fingers of the user from the captured image. Then, the imager 1180 can estimate the posture or motion of the user from the arrangement of those (face, arms, hands, fingers) thus detected, and determine whether the user is performing the touch operation with the right hand or the left hand. In this determination, if the vicinity of the center of the user's body in the left-right direction can be determined from other parts, the imaging of the face is not necessarily required. Alternatively, the above determination may be made based only on the arrangement of the arms, and the above determination may be made based only on the arrangement of the hands. Further, the above determination may be made based on the combination of the arrangement of the arms and the arrangement of the hands, and the determination may be made by combining the arrangement of the face in these determinations.

Note that FIG. 27A to FIG. 29B and FIG. 30A to FIG. 32B show the virtual shadow 1510 extending at an angle corresponding to the extending direction of the actual finger 210. The extending direction of the actual finger 210 may be calculated by capturing an image of the finger by using any of the imagers described above. Here, instead of reflecting the angle corresponding to the extending direction of the finger 210, the virtual shadow 1510 whose extending direction is fixed at a predetermined angle may be displayed. Thereby, it is possible to reduce the load on the video controller 1160 or the controller 1110 that controls the display of the virtual shadow 1510.

For example, if the finger 210 is the finger of the right hand, it is natural that the user tries to extend the arm from front right of the display plane 3a of the air floating video 3 and touch the display plane 3a of the air floating video 3 in the state where the finger 210 is pointing the upper left toward the display plane 3a of the air floating video 3. Therefore, when the finger 210 is the finger of the right hand, the natural display can be achieved without reflecting the angle corresponding to the finger 210 if the shadow of the finger shown by the virtual shadow 1510 is configured to be displayed in a predetermined direction indicating the upper right direction toward the display plane 3a of the air floating video 3.

Further, for example, if the finger 210 is the finger of the left hand, it is natural that the user tries to extend the arm from front left of the display plane 3a of the air floating video 3 and touch the display plane 3a of the air floating video 3 in the state where the finger 210 is pointing the upper right toward the display plane 3a of the air floating video 3. Therefore, when the finger 210 is the finger of the left hand, the natural display can be achieved without reflecting the angle corresponding to the finger 210 if the shadow of the finger shown by the virtual shadow 1510 is configured to be displayed in a predetermined direction indicating the upper left direction toward the display plane 3a of the air floating video 3.

Note that, when the finger 210 of the user is present on the opposite side of the display plane 3a of the air floating video 3, the display capable of notifying the user that the finger 210 is on the back side of the air floating video 3 and cannot touch the air floating video 3 may be made. For example, a message notifying the user that the finger 210 is on the back side of the air floating video 3 and cannot touch the air floating video 3 may be displayed in the air floating video 3. Alternatively, for example, the virtual shadow 1510 may be displayed in a color different from normal one such as red. Thereby, it is possible to more adequately prompt the user to return the finger 210 to an appropriate position.

<<Example of Setting Condition of Virtual Light Source>>

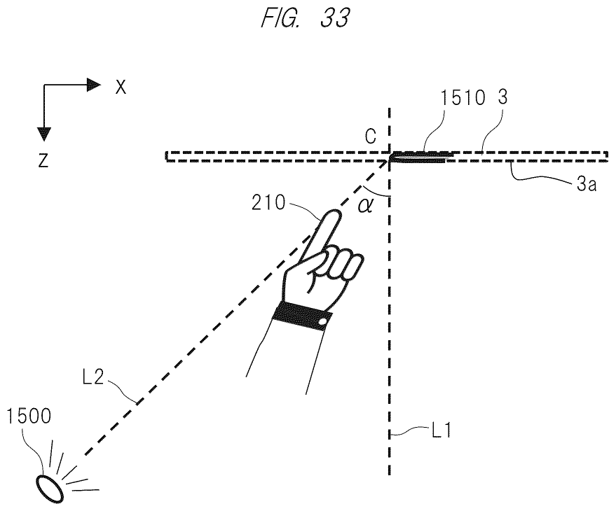

Here, a setting method of the virtual light source 1500 will be described. FIG. 33 is a diagram for describing a setting method of a virtual light source. FIG. 33 shows a case in which the user performs the touch operation with the left hand, but the contents described below are preferably applied also to the case in which the user performs the touch operation with the right hand.

FIG. 33 shows a normal line L1 of the display plane 3a extending from a center point C of the display plane 3a of the air floating video 3 toward the user, a line L2 connecting the virtual light source 1500 and the point C at which the normal line L1 intersects the display plane 3a, and a virtual light source installation angle α defined by the angle between the normal line L1 and the line L2. FIG. 33 shows the moment when the tip of the finger 210 of the user is on the line L2 for the sake of simple description.

Here, in FIG. 27A to FIG. 33, the virtual light source 1500 is illustrated to be located at the positions not far from the display plane 3a of the air floating video 3 and the finger 210 of the user for the sake of simple description. Although the virtual light source 1500 may be set at such positions, the most preferred setting example is as follows. That is, it is desirable that the distance between the virtual light source 1500 and the center point C of the display plane 3a of the air floating video 3 is set to infinity. The reason is as follows. If there is an object plane having a contact surface in the same coordinate system as the display plane 3a of the air floating video 3 in FIG. 27A to FIG. 32B and the sun is the light source instead of the virtual light source, the distance to the sun is approximated as being almost infinite, and thus the position of the tip of the finger of the user on the real object plane in the horizontal direction (x direction) changes linearly with respect to the change in the distance (z direction) between the tip of the finger of the user and the object plane. Therefore, also in the setting of the virtual light source 1500 shown in FIG. 27A to FIG. 33 of the present embodiment, the distance between the virtual light source 1500 and the center point C of the display plane 3a of the air floating video 3 is set to infinity and the position of the tip of the virtual shadow 1510 in the air floating video 3 in the horizontal direction (x direction) is configured to change linearly with respect to the change in the distance (z direction) between the tip of the finger 210 of the user and the display plane 3a of the air floating video 3, whereby it is possible to express the virtual shadow that can be recognized more naturally by the user.

If the virtual light source 1500 is set to be arranged at the position not far from the display plane 3a of the air floating video 3 and the finger 210 of the user, the position of the tip of the virtual shadow 1510 in the air floating video 3 in the horizontal direction (x direction) changes non-linearly with respect to the change in the distance (z direction) between the tip of the finger 210 of the user and the display plane 3a of the air floating video 3, and the operation for calculating the position of the tip of the virtual shadow 1510 in the horizontal direction (x direction) becomes somewhat complicated. On the other hand, if the distance between the virtual light source 1500 and the center point C of the display plane 3a of the air floating video 3 is set to infinity, the position of the tip of the virtual shadow 1510 in the air floating video 3 in the horizontal direction (x direction) changes linearly with respect to the change in the distance (z direction) between the tip of the finger 210 of the user and the display plane 3a of the air floating video 3, and it is thus possible to obtain the effect of simplifying the operation for calculating the position of the tip of the virtual shadow 1510 in the horizontal direction (x direction).

When the virtual light source installation angle α is small, the angle between the line connecting the virtual light source 1500 and the finger 210 and the normal line L1 cannot be increased as viewed from the user, so that the distance between the tip of the finger 210 and the tip of the virtual shadow 1510 in the horizontal direction (x direction) of the display plane 3a of the air floating video 3 is shortened. As a result, it becomes difficult for the user to visually recognize the change in the position of the virtual shadow 1510 when the tip of the finger 210 performs the touch operation, and the effect of the depth perception of the user in the touch operation may be lowered. In order to avoid this, it is desirable to install the virtual light source 1500 such that the angle between the line L2 connecting the virtual light source 1500 and the point C and the normal line L1 is, for example, 20° or more.

On the other hand, when the angle between the line connecting the virtual light source 1500 and the finger 210 and the normal line L1 is around 90°, the distance between the tip of the finger 210 and the tip of the virtual shadow 1510 becomes very long. Consequently, the probability that the display position of the virtual shadow 1510 is outside the range of the air floating video 3 increases, and the probability that the virtual shadow 1510 cannot be displayed in the air floating video 3 increases. Therefore, the installation angle α of the virtual light source 1500 is desirably 70° or less such that the angle between the line L2 connecting the virtual light source 1500 and the point C and the normal line L1 does not approach, for example, too much.

Namely, it is desirable that the virtual light source 1500 is installed at the position that is neither too close to the plane including the normal line passing through the finger 210 nor too close to the plane including the display plane 3a of the air floating video 3.

The air floating video display apparatus 1000 of the present embodiment can display the virtual shadow as described above. This enables the image processing that is physically more natural effect than the case in which a predetermined mark for assisting the touch operation of the user is superimposed on the video. Therefore, the technique for assisting the touch operation by displaying the virtual shadow in the air floating video display apparatus 1000 of the present embodiment described above can provide a situation in which the user can more naturally recognize the depth in the touch operation.

<<Method of Detecting Position of Finger>>

Next, a method of detecting the position of the finger 210 will be described. The configuration for detecting the position of the finger 210 of the user 230 will be specifically described below.

<<<Method of Detecting Position of Finger (1)>>>

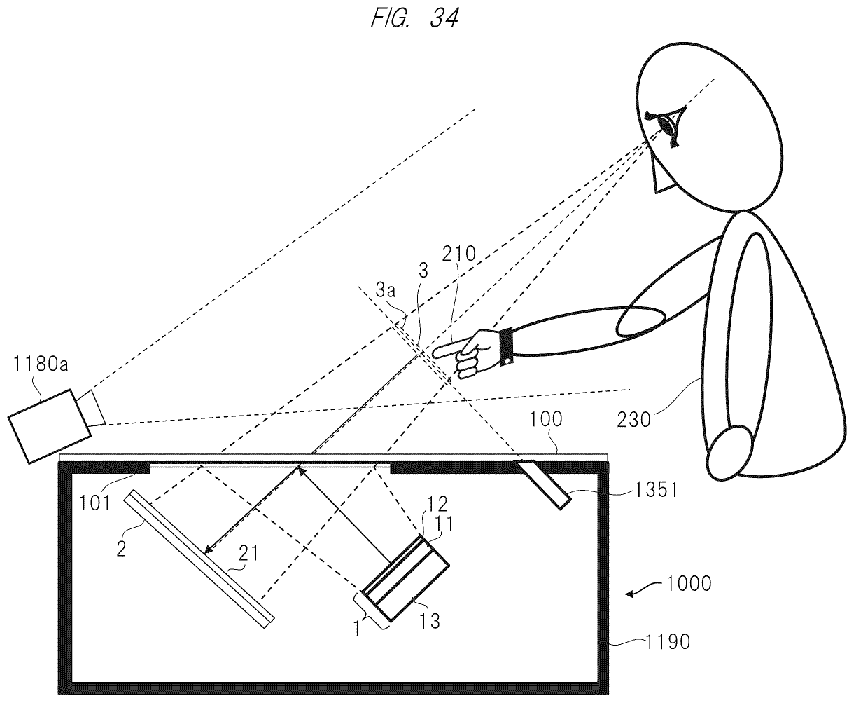

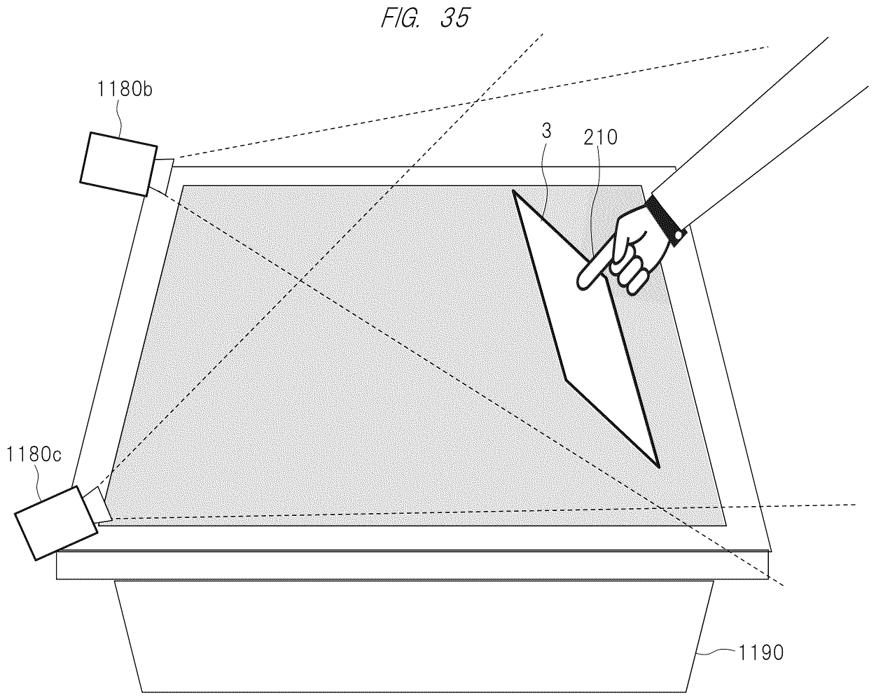

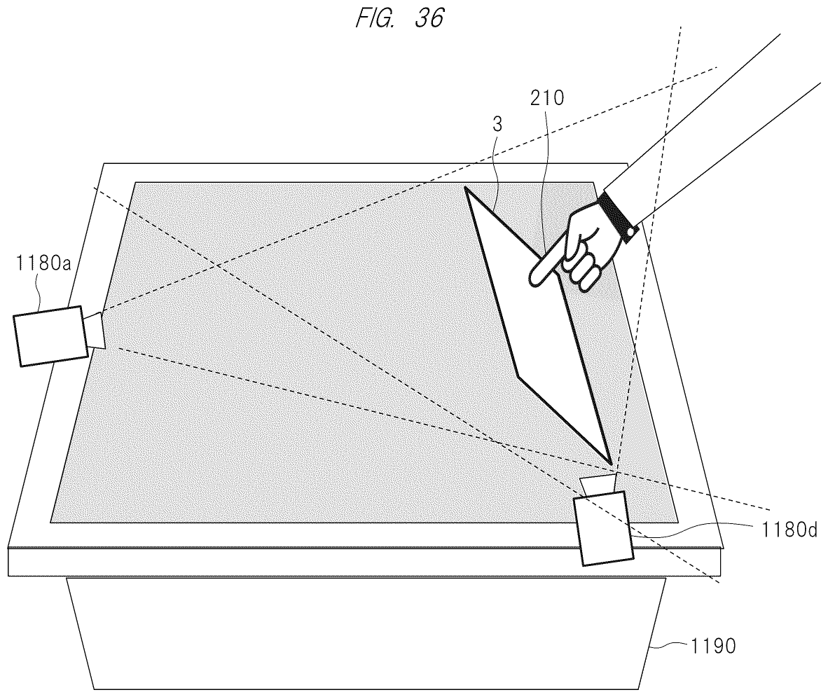

FIG. 34 is a configuration diagram showing an example of a method of detecting a position of a finger. In the example shown in FIG. 34, the position of the finger 210 is detected by using one imager 1180 and one spatial operation detection sensor 1351. Note that each imager in the embodiments of the present invention has an imaging sensor.

A first imager 1180a (1180) is installed on the side opposite to the user 230 with respect to the air floating video 3. The first imager 1180a may be installed on the housing 1190 as shown in FIG. 34, or may be installed at a position away from the housing 1190.

The imaging region of the first imager 1180a is set so as to include, for example, the display region of the air floating video 3, the fingers, hands, arms, face, and the like of the user 230. The first imager 1180a captures an image of the user 230 who performs the touch operation on the air floating video 3, and generates a first captured image. Even if the display region of the air floating video 3 is captured by the first imager 1180a, since the image is taken from the opposite side of the traveling direction of the directional light flux of the air floating video 3, the air floating video 3 itself cannot be visually recognized as a video. Here, in the example of the method of detecting the position of the finger (1), the first imager 1180a is not simply an imager, but incorporates a depth sensor in addition to the imaging sensor. Existing techniques may be used for the configuration and processing of the depth sensor. The depth sensor of the first imager 1180a detects the depth of each part (for example, the fingers, hands, arms, face, and others of the user) in the image captured by the first imager 1180a, and generates depth information.

The spatial operation detection sensor 1351 is installed at the position where it can sense the display plane 3a of the air floating video 3 as a sensing target plane. In FIG. 34, the spatial operation detection sensor 1351 is installed below the display plane 3a of the air floating video 3, but may be installed on the side or above the display plane 3a. The spatial operation detection sensor 1351 may be installed in the housing 1190 as shown in FIG. 34, or may be installed at a position away from the housing 1190.

The spatial operation detection sensor 1351 in FIG. 34 is a sensor that detects the position where the display plane 3a of the air floating video 3 and the finger 210 are in contact or overlap with each other. Namely, when the tip of the finger 210 approaches the display plane 3a of the air floating video 3 from the user side of the display plane 3a of the air floating video 3, the spatial operation detection sensor 1351 can detect the contact of the finger 210 on the display plane 3a of the air floating video 3.

For example, the controller 1110 shown in FIG. 3C reads a program for performing image processing and a program for displaying the virtual shadow 1510 from the nonvolatile memory 1108. The controller 1110 performs first image processing on the first captured image generated by the imaging sensor of the first imager 1180a, detects the finger 210, and calculates the position (x coordinate, y coordinate) of the finger 210. Based on the first captured image generated by the imaging sensor of the first imager 1180a and the depth information generated by the depth sensor of the first imager 1180a, the controller 1110 calculates the position (z coordinate) of the tip of the finger 210 with respect to the air floating video 3.

In the example of FIG. 34, a touch detector that performs the detection of the position of the finger of the user and the detection of the touch on the object of the air floating video 3 is composed of the imaging sensor and depth sensor of the first imager 1180a, the spatial operation detection sensor 1351, the spatial operation detector 1350, and the controller 1110. Thereby, the position (x coordinate, y coordinate, z coordinate) of the finger 210 is calculated. Further, the touch detection result is calculated by the detection result of the spatial operation detector 1350 or the combination of the detection result of the spatial operation detector 1350 and the information generated by the first imager 1180a.

Then, the controller 1110 calculates the position (display position) where the virtual shadow 1510 is to be displayed based on the position (x coordinate, y coordinate, z coordinate) of the finger 210 and the position of the virtual light source 1500, and generates the video data of the virtual shadow 1510 based on the calculated display position.

Note that the calculation of the display position of the virtual shadow 1510 in the video data by the controller 1110 may be performed each time the position of the finger 210 is calculated. Instead of calculating the display position of the virtual shadow 1510 in the video data each time the position of the finger 210 is calculated, the data of the display position map obtained by calculating the display positions of the virtual shadow 1510 corresponding to each of the plurality of positions of the finger 210 may be stored in the nonvolatile memory 1108 in advance, and the video data of the virtual shadow 1150 may be generated based on the data of the display position map stored in the nonvolatile memory 1108 when the calculation of the position of the finger 210 is performed. Further, by calculating the tip of the finger 210 and the extending direction of the finger 210 in advance in the first image processing and calculating the extending direction of the virtual shadow 1510 corresponding to the display position and the extending direction of the tip of the finger 210, the controller 1110 may generate the video data of the virtual shadow 1510 adjusted to the display angle corresponding to the direction of the actual finger 210 based on these.

The controller 1110 outputs the generated video data of the virtual shadow 1510 to the video controller 1160. The video controller 1160 generates video data (superimposed video data) in which the video data of the virtual shadow 1510 and other video data such as the object are superimposed, and outputs the superimposed video data including the video data of the virtual shadow 1510 to the video display 1102.

The video display 1102 displays a video based on the superimposed video data including the video data of the virtual shadow 1510, thereby displaying the air floating video 3 in which the virtual shadow 1510 and the object or the like are superimposed.

For example, the detection of the touch on the object is performed as follows. The spatial operation detector 1350 and the spatial operation detection sensor 1351 are configured as described with reference to FIG. 3A to FIG. 3C, detect the position where the finger 210 touches or overlaps the plane including the display plane 3a of the air floating video 3, and output the touch position information indicating the position where the finger 210 touches or overlaps the display plane 3a to the controller 1110. Then, when the controller 1110 receives the input of the touch position information, it determines whether the position (x coordinate, y coordinate) of the finger 210 calculated by the first image processing is included in the display range of each object displayed in the display plane 3a of the air floating video 3. Then, when the position of the finger 210 is included in the display range of any object, the controller 1110 determines that the touch on this object has been performed.

According to the detection method described above, the detection of the position of the finger 210 and the detection of the touch operation can be performed with a simple configuration in which one imager 1180 (first imager 1180a) having an imaging sensor and a depth sensor and one spatial operation detection sensor 1351 are combined.

As a modification of the method of detecting the position of the finger (1), the controller 1110 may detect the touch operation by the finger 210 based on only the first captured image generated by the imaging sensor of the first imager 1180a and the depth information generated by the depth sensor of the first imager 1180a without using the detection results of the spatial operation detector 1350 and the spatial operation detection sensor 1351. For example, the mode in which the touch operation by the finger 210 is detected by combining the captured image of the imaging sensor of the first imager 1180a, the detection result of the depth sensor, and the detection result of the spatial operation detection sensor 1351 is selected during normal operation, and when there is some problem in the operation of the spatial operation detection sensor 1351 and the spatial operation detector 1350, the mode may be switched to the mode in which the controller 1110 detects the touch operation by the finger 210 based on only the first captured image generated by the imaging sensor of the first imager 1180a and the depth information generated by the depth sensor of the first imager 1180a without using the detection results of the spatial operation detector 1350 and the spatial operation detection sensor 1351.

<<Method of Detecting Position of Finger (2)>>

FIG. 35 is a configuration diagram showing another example of the method of detecting the position of the finger. In the example shown in FIG. 35, the position of the finger 210 is detected by using two imagers. A second imager 1180b (1180) and a third imager 1180c (1180) are both provided on the side opposite to the user 230 with respect to the air floating video 3.

For example, the second imager 1180b is installed on the right side as viewed from the user 230. The imaging region of the second imager 1180b is set so as to include, for example, the air floating video 3, the fingers, hands, arms, face, and the like of the user 230. The second imager 1180b captures an image of the user 230 who performs the touch operation on the air floating video 3 from the right side of the user 230, and generates a second captured image.

For example, the third imager 1180c is installed on the left side as viewed from the user 230. The imaging region of the third imager 1180c is set so as to include, for example, the air floating video 3, the fingers, hands, arms, face, and the like of the user 230. The third imager 1180c captures an image of the user 230 who performs the touch operation on the air floating video 3 from the left side of the user 230, and generates a third captured image. As described above, in the example of FIG. 35, the second imager 1180b and the third imager 1180c constitute a so-called stereo camera.

The second imager 1180b and the third imager 1180c may be installed on the housing 1190 as shown in FIG. 35 or may be installed at positions away from the housing 1190. Alternatively, it is also possible to install one imager on the housing 1190 and install the other imager at a position away from the housing 1190.

The controller 1110 performs each of second image processing on the second captured image and third image processing on the third captured image. Then, the controller 1110 calculates the position (x coordinate, y coordinate, z coordinate) of the finger 210 based on the result of the second image processing (second image processing result) and the result of the third image processing (third image processing result). In the example of FIG. 35, a touch detector that performs the detection of the position of the finger of the user and the detection of the touch on the object of the air floating video 3 is composed of the second imager 1180b, the third imager 1180c, and the controller 1110. Then, the position (x coordinate, y coordinate, z coordinate) of the finger 210 is calculated as a position detection result or a touch detection result.

Thus, in the example of FIG. 35, the virtual shadow 1510 is generated based on the position of the finger 210 calculated based on the second image processing result and the third image processing result. Also, it is determined whether or not the object is touched based on the position of the finger 210 calculated based on the second image processing result and the third image processing result.

According to this configuration, there is no need to adopt an imager having a depth sensor. Further, according to this configuration, it is possible to improve the detection accuracy of the position of the finger 210 by using the second imager 1180b and the third imager 1180c as a stereo camera. In particular, it is possible to improve the detection accuracy of the x coordinate and y coordinate as compared with the example of FIG. 34. Therefore, it is possible to more accurately determine whether or not the object is touched.

Further, as a modification of the method of detecting the position of the finger (2), the configuration in which the detection of the position of the finger of the user (x coordinate, y coordinate, z coordinate) is performed based on the second captured image by the second imager 1180b and the third captured image by the third imager 1180c, thereby controlling the display of the virtual shadow 1510 as described above, and the touch on the object of the air floating video 3 is detected by the spatial operation detector 1350 or the controller 1110 based on the detection result of the spatial operation detection sensor 1351 is also possible. According to this modification, since the spatial operation detection sensor 1351 that senses the display plane 3a of the air floating video 3 as the sensing target plane is used, the contact of the finger 210 of the user on the display plane 3a of the air floating video 3 can be detected more accurately than the detection in the depth direction by the stereo camera including the second imager 1180b and the third imager 1180c.

<<<Method of Detecting Position of Finger (3)>>>

FIG. 36 is a configuration diagram showing still another example of the method of detecting the position of the finger. In the example shown in FIG. 36 as well, the position of finger 210 is detected by using two imagers. The example of FIG. 36 differs from the example of FIG. 35 in that a fourth imager 1180d (1180) which is one of the imagers is arranged at the position where it images the display plane 3a of the air floating video 3 from the side. Also, as in the example of FIG. 34, the first imager 1180a (1180) is installed on the side opposite to the user 230 with respect to the air floating video 3. In the example of FIG. 36, the first imager 1180a (1180) is only required to have an imaging function and does not need to have a depth sensor.

Therefore, the fourth imager 1180d is installed around the display plane 3a of the air floating video 3. In FIG. 36, the fourth imager 1180d is installed below the side of the display plane 3a of the air floating video 3, but may be installed on the side or above the display plane 3a. The fourth imager 1180d may be installed on the housing 1190 as shown in FIG. 36, or may be installed at a position away from the housing 1190.

The imaging region of the fourth imager 1180d is set so as to include, for example, the air floating video 3, the fingers, hands, arms, face, and the like of the user 230. The fourth imager 1180d captures an image of the user 230 who performs the touch operation on the air floating video 3 from the periphery of the display plane 3a of the air floating video 3, and generates a fourth captured image.

The controller 1110 performs fourth image processing on the fourth captured image, and calculates the distance (z coordinate) between the display plane 3a of the air floating video 3 and the tip of the finger 210. Then, the controller 1110 performs the processing related to the virtual shadow 1510 and the determination as to whether or not the object is touched based on the position (x coordinate, y coordinate) of the finger 210 calculated by the first image processing on the first captured image by the first imager 1180a described above and the position (z coordinate) of the finger 210 calculated by the fourth image processing.

In the example of FIG. 36, a touch detector that performs the detection of the position of the finger of the user and the detection of the touch on the object is composed of the first imager 1180a, the fourth imager 1180d, and the controller 1110. Then, the position (x coordinate, y coordinate, z coordinate) of the finger 210 is calculated as a position detection result or a touch detection result.

According to this configuration, the detection accuracy of the distance between the display plane 3a of the air floating video 3 and the tip of the finger 210, that is, the depth of the finger 210 with respect to the display plane 3a of the air floating video 3 can be improved as compared with the configuration example of the stereo camera shown in FIG. 35.

Further, as a modification of the method of detecting the position of the finger (3), the configuration in which the detection of the position (x coordinate, y coordinate, z coordinate) of the finger of the user is performed based on the first captured image by the first imager 1180a and the fourth captured image by the fourth imager 1180d, thereby controlling the display of the virtual shadow 1510 as described above, and the touch on the object of the air floating video 3 is detected by the spatial operation detector 1350 or the controller 1110 based on the detection result of the spatial operation detection sensor 1351 is also possible. According to this modification, since the spatial operation detection sensor 1351 that senses the display plane 3a of the air floating video 3 as the sensing target plane is used, the contact of the finger 210 of the user on the display plane 3a of the air floating video 3 can be detected more accurately than the detection based on the fourth captured image by the fourth imager 1180d.

<<Method of Assisting Touch Operation by Displaying Input Content>>

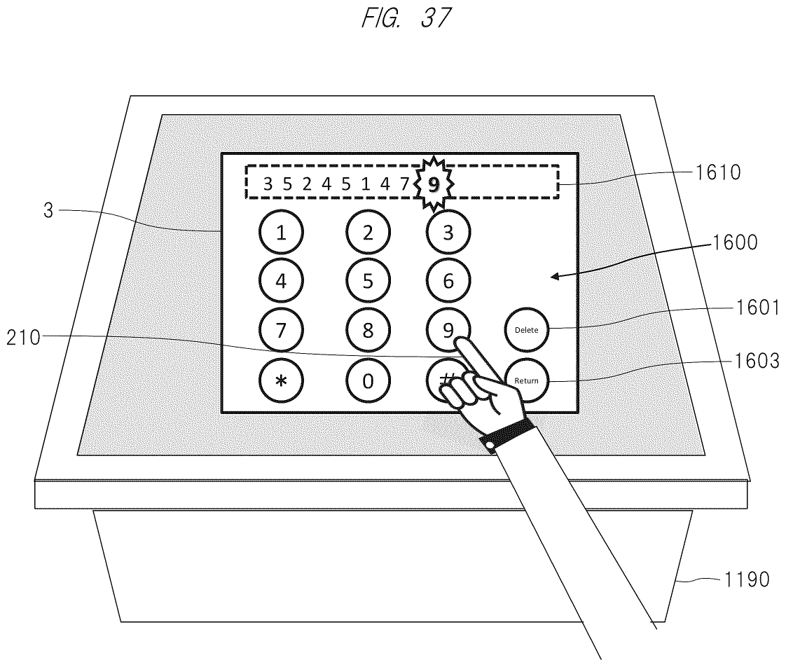

An example of assisting the touch operation of the user with another method will be described. For example, it is possible to assist the touch operation by displaying the input content. FIG. 37 is a diagram for describing a method of assisting a touch operation by displaying an input content. FIG. 37 shows a case of inputting numbers by touch operation.

The air floating video 3 in FIG. 37 includes, for example, a key input UI (user interface) display region 1600 having a plurality of objects such as a plurality of objects for inputting numbers, an object 1601 for deleting an input content, and an object 1603 for determining an input content, and an input content display region 1610 for displaying the input content.

In the input content display region 1610, the content (for example, numbers) input by the touch operation is sequentially displayed in the air floating video 3 from the left end toward the right side. The user can confirm the content input by the touch operation while looking at the input content display region 1610. Then, the user touches the object 1603 after entering all desired numbers. As a result, the input content displayed in the input content display region 1610 is registered. Unlike physical contact on the surface of the display device, the user cannot feel the touch in the touch operation on the air floating video 3. Therefore, by separately displaying the input content in the input content display region 1610, the user can favorably proceed with the operation while confirming whether the touch operation of himself/herself has been performed effectively.

On the other hand, if the user inputs a content different from the desired one by, for example, touching the wrong object, the user can delete the last input content (“9” in this case) by touching the object 1601. Then, the user continues to perform the touch operation on the objects for inputting numbers and others. The user touches the object 1603 after entering all desired numbers.

By displaying the input content in the input content display region 1610 in this manner, the user can confirm the input content, and convenience can be improved. In addition, when the user touches the wrong object, the input content can be corrected, and convenience can be improved.

<<Method of Assisting Touch Operation by Highlighting Input Content>>

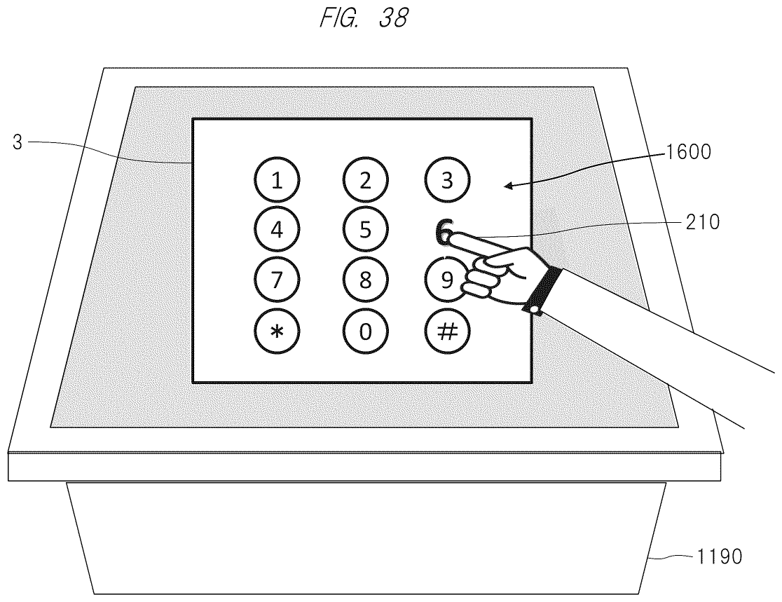

Next, it is also possible to assist the touch operation by highlighting the input content. FIG. 38 is a diagram for describing a method of assisting a touch operation by highlighting an input content.

FIG. 38 shows an example in which the number input by the touch operation is highlighted. With reference to FIG. 38, when the object corresponding to the number “6” is touched, the touched object is deleted and the input number “6” is displayed in the region where this object was displayed.

By displaying the number corresponding to the touched object instead of the object in this way, it is possible to make the user recognize that the object has been touched, and convenience can be improved. The number corresponding to the touched object may be referred to as a replacement object that is to be replaced with the touched object.

As another method of highlighting the input content, for example, the object touched by the user may be brightly lit, or the object touched by the user may be blinked. Although not shown here, by recognizing the distance between the finger 210 and the display plane 3a described in the embodiment of FIG. 27A to FIG. 28B, the object to be touched may be made brighter than surrounding objects as the finger comes closer to the display plane, and the degree of highlight may be made maximum, the object may be more brightly lit, or the object may be blinked when the finger finally touches the display plane. Also in this configuration, it is possible to make the user recognize that the object has been touched, and convenience can be improved.

<<Method of Assisting Touch Operation by Vibration (1)>>

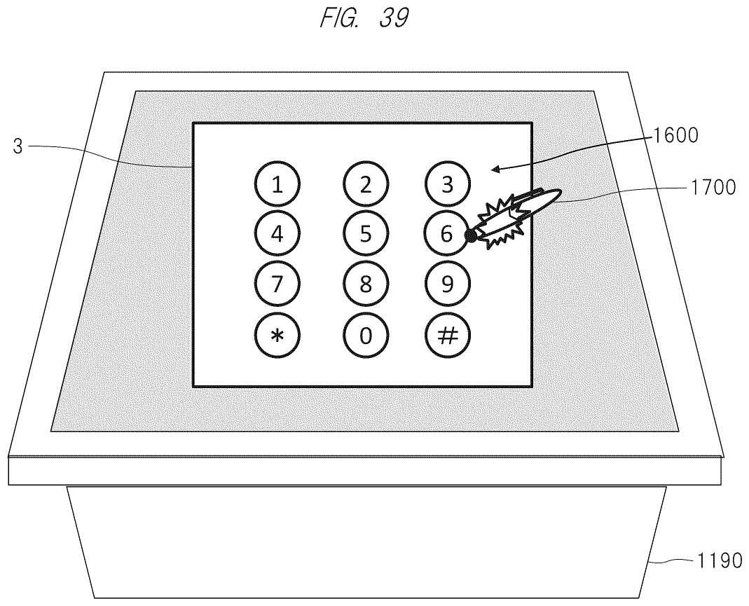

Next, a method of assisting the touch operation by vibration will be described. FIG. 39 is a diagram for describing an example of a method of assisting a touch operation by vibration. FIG. 39 shows a case where a touch operation is performed by using a touch pen (touch input device) 1700 instead of the finger 210. The touch pen 1700 includes, for example, a communication unit that transmits and receives various kinds of information such as signals and data to and from an apparatus such as the air floating video display apparatus and a vibration mechanism that vibrates based on an input signal.

It is assumed that the user operates the touch pen 1700 and touches an object displayed in the key input UI display region 1600 of the air floating video 3 with the touch pen 1700. At this time, for example, the controller 1100 transmits from the communication unit 1132 a touch detection signal indicating that a touch on the object has been detected. When the touch pen 1700 receives the touch detection signal, the vibration mechanism generates vibration based on the touch detection signal, and the touch pen 1700 vibrates. Then, the vibration of the touch pen 1700 is transmitted to the user, and the user recognizes that the object has been touched. In this way, the touch operation is assisted by the vibration of the touch pen 1700.

According to this configuration, it is possible to make the user recognize by vibration that the object has been touched.

Although the case where the touch pen 1700 receives the touch detection signal transmitted from the air floating video display apparatus has been described here, other configurations are also possible. For example, upon detecting a touch on an object, the air floating video display apparatus notifies a host apparatus of the detection of the touch on the object. The host apparatus then transmits the touch detection signal to the touch pen 1700.

Alternatively, the air floating video display apparatus and the host apparatus may transmit the touch detection signal through network. As described above, the touch pen 1700 may indirectly receive the touch detection signal from the air floating video display apparatus.

<<Method of Assisting Touch Operation by Vibration (2)>>

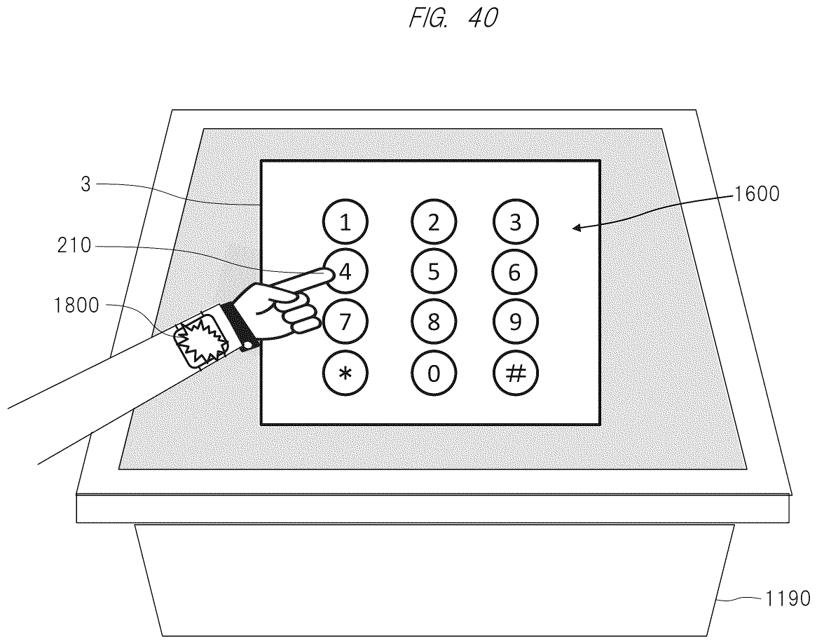

Next, another method of assisting the touch operation by vibration will be described. Here, the user is made to recognize that the object has been touched by vibrating a terminal that the user wears. FIG. 40 is a diagram for describing another example of the method of assisting the touch operation by vibration. In the example of FIG. 40, the user 230 wearing a wristwatch-type wearable terminal 1800 performs the touch operation.

The wearable terminal 1800 includes, for example, a communication unit that transmits and receives various kinds of information such as signals and data to and from an apparatus such as the air floating video display apparatus and a vibration mechanism that vibrates based on an input signal.

It is assumed that the user performs the touch operation with the finger 210 and touches an object displayed in the key input UI display region 1600 of the air floating video 3. At this time, for example, the controller 1100 transmits from the communication unit 1132 a touch detection signal indicating that a touch on the object has been detected. When the wearable terminal 1800 receives the touch detection signal, the vibration mechanism generates vibration based on the touch detection signal, and the wearable terminal 1800 vibrates. Then, the vibration of the wearable terminal 1800 is transmitted to the user, and the user recognizes that the object has been touched. In this way, the touch operation is assisted by the vibration of the wearable terminal 1800. Here, a wristwatch-type wearable terminal has been described as an example, but a smartphone or the like that the user wears may also be used.

Note that the wearable terminal 1800 may receive the touch detection signal from a host apparatus, like the touch pen 1700 described above. The wearable terminal 1800 may receive the touch detection signal through network. In addition to the wearable terminal 1800, for example, an information processing terminal such as a smartphone that the user wears can be used to assist the touch operation.

According to this configuration, it is possible to make the user recognize that the object has been touched via various terminals such as the wearable terminal 1800 that the user wears.

<<Method of Assisting Touch Operation by Vibration (3)>>

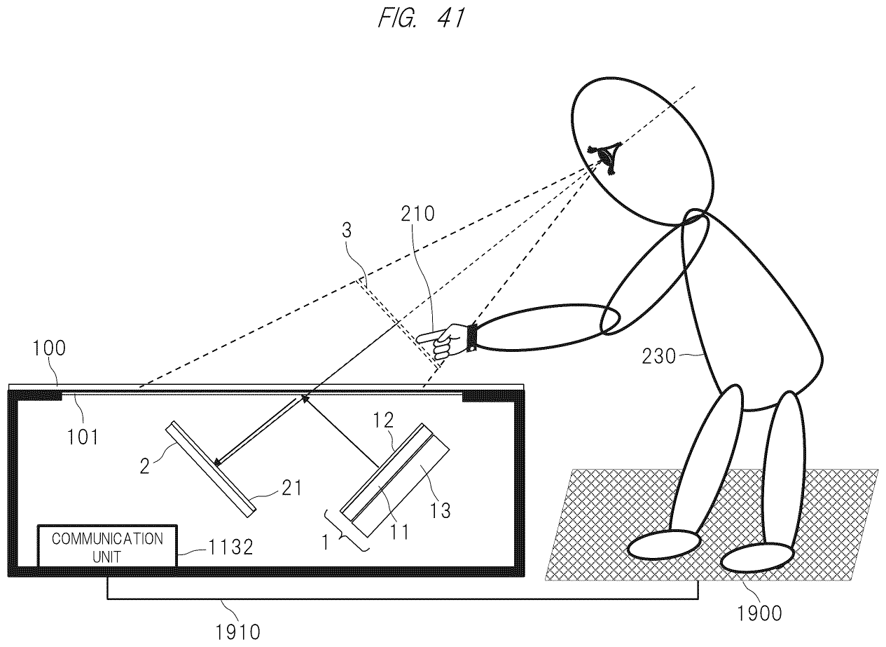

Next, still another method of assisting the touch operation by vibration will be described. FIG. 41 is a diagram for describing still another example of the method of assisting the touch operation by vibration. In the example of FIG. 41, the user 230 stands on a vibrating plate 1900 and performs the touch operation. The vibrating plate 1900 is installed at a predetermined position where the user 230 performs the touch operation. In actual usage form, for example, the vibrating plate 1900 is placed under a mat (not shown), and the user 230 stands on the vibrating plate 1900 via the mat.

As shown in FIG. 41, the vibrating plate 1900 is connected to, for example, the communication unit 1132 of the air floating video display apparatus 1000 via a cable 1910. When a touch on the object is detected, for example, the controller 1110 supplies AC voltage to the vibrating plate 1900 via the communication unit 1132 for a predetermined time. The vibrating plate 1900 vibrates while the AC voltage is being supplied. Namely, the AC voltage is a control signal for vibrating the vibrating plate 1900 output from communication unit 1132. The vibration generated by the vibrating plate 1900 is transmitted to the user 230 from the feet, and the user 230 can recognize that the object has been touched. In this way, the touch operation is assisted by the vibration of the vibrating plate 1900.

The frequency of the AC voltage is set to a value within the range where the user 230 can feel the vibration. The frequency of vibration that humans can feel is approximately in the range of 0.1 Hz to 500 Hz. Therefore, it is desirable to set the frequency of the AC voltage within this range.

In addition, it is desirable that the frequency of the AC voltage is changed as appropriate in accordance with the characteristics of the vibrating plate 1900. For example, when the vibrating plate 1900 vibrates in the vertical direction, humans are said to have the highest sensitivity to vibrations of about 410 Hz. In addition, when the vibrating plate 1900 vibrates in the horizontal direction, humans are said to have the highest sensitivity to vibrations of about 12 Hz. Furthermore, at the frequency equal to or higher than 34 Hz, humans are said to have higher sensitivity in the vertical direction than in the horizontal direction.

Therefore, when the vibrating plate 1900 vibrates in the vertical direction, the frequency of the AC voltage is desirably set to a value within a range including 410 Hz, for example. Moreover, when the vibrating plate 1900 vibrates in the horizontal direction, the frequency of the AC voltage is desirably set to a value within a range including 12 Hz, for example. Note that the peak voltage and frequency of the AC voltage may be adjusted as appropriate in accordance with the performance of the vibrating plate 1900.

With this configuration, it is possible to make the user 230 recognize by the vibration from the feet that the object has been touched. Further, in the case of this configuration, it is also possible to set the display of the air floating video 3 so as not to change even when the object is touched, whereby the possibility that the input content is known to another person is reduced even if another person looks into the touch operation, and security can be further improved.

<<Modification of Object Display (1)>>

Another example of the object display in the air floating video 3 by the air floating video display apparatus 1000 will be described. The air floating video display apparatus 1000 is configured to display the air floating video 3 which is an optical image of a rectangular video displayed by the display apparatus 1. There is a correlation between the rectangular video displayed by the display apparatus 1 and the air floating video 3. Therefore, when a video having luminance is displayed on the entire display range of the display apparatus 1, the air floating video 3 is displayed as a video having luminance on the entire display range. In this case, although it is possible to obtain the feeling of floating in the air as a whole of the rectangular air floating video 3, there is a problem that it is difficult to obtain the feeling of floating in the air of each object itself displayed in the air floating video 3. Meanwhile, there is also a method of displaying only the object portion of the air floating video 3 as a video having luminance. However, the method of displaying only the object portion as a video having luminance can favorably obtain the feeling of floating in the air of the object, but on the other hand, there is a problem that it is difficult to recognize the depth of the object.

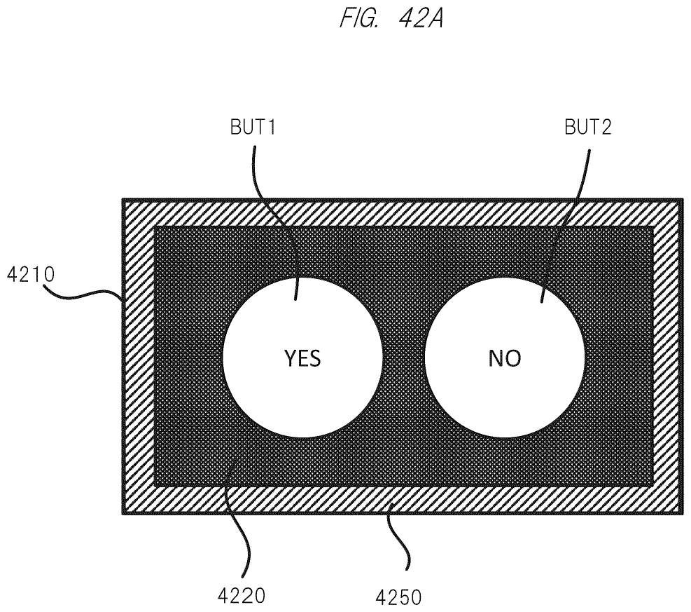

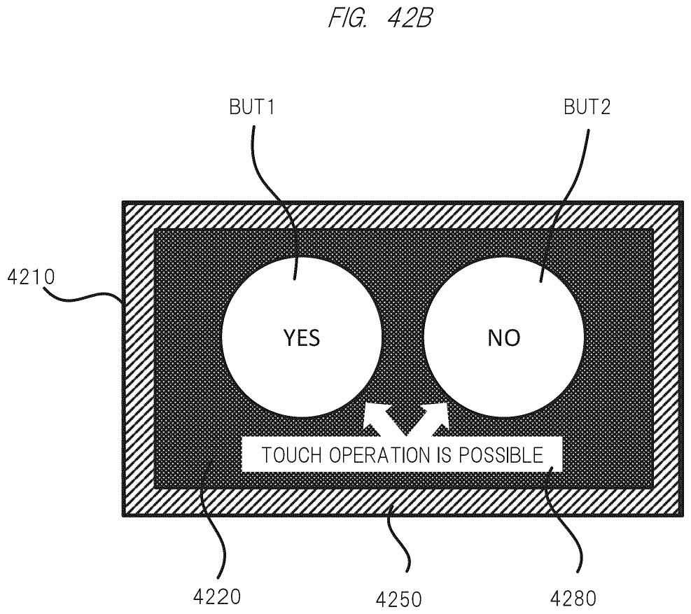

Therefore, in the display example of FIG. 42A according to the present embodiment, the two objects of the first button BUT1 displayed as “YES” and the second button BUT2 displayed as “NO” are displayed within a display range 4210 of the air floating video 3. The two object regions of the first button BUT1 displayed as “YES” and the second button BUT2 displayed as “NO” are regions in which videos having luminance are included in the display apparatus 1. A black display region 4220 is arranged around the display regions of the two objects so as to surround the display regions of the objects.

The black display region 4220 is a region in which black is displayed in the display apparatus 1. Namely, the black display region 4220 is a region having video information without luminance in the display apparatus 1. In other words, the black display region 4220 is a region in which video information having luminance is not present. The region in which black is displayed in the display apparatus 1 becomes a spatial region where nothing is visible to the user in the air floating video 3 which is an optical image. Furthermore, in the display example of FIG. 42A, a frame video display region 4250 is arranged in the display range 4210 so as to surround the black display region 4220.

The frame video display region 4250 is a region in which a pseudo frame is displayed by using a video having luminance in the display apparatus 1. Here, a frame video displayed in a single color may be used as the pseudo frame in the frame video display region 4250. Alternatively, a frame video displayed by using a designed image may be used as the pseudo frame in the frame video display region 4250. Alternatively, a frame like a dashed line may be displayed as the frame video display region 4250.

By displaying the frame video in the frame video display region 4250 as described above, the user can easily recognize the plane to which the two objects of the first button BUT1 and the second button BUT2 belong, and can easily recognize the depth positions of the two objects of the first button BUT1 and the second button BUT2. In addition, since there is the black display region 4220 in which nothing is visible to the user around these objects, it is possible to emphasize the feeling of floating in the air of the two objects of the first button BUT1 and the second button BUT2. Note that, in the air floating video 3, the frame video display region 4250 is present at the outermost periphery of the display range 4210, but it may not be the outermost periphery of the display range 4210 depending on the case.

As described above, according to the display example of FIG. 42A, both the feeling of floating in the air and the recognition of the depth position of the object displayed in the air floating video 3 can be achieved more adequately.

<<Modification of Object Display (2)>>

FIG. 42B is a modification of the object display in FIG. 42A. This is a display example in which a message indicating “touch operation is possible” is displayed near objects such as the first button BUT1 and the second button BUT2 on which the user can perform the touch operation. Here, as shown in FIG. 42B, a mark such as an arrow pointing to an object on which the user can perform the touch operation may be displayed. In this way, the user can easily recognize the objects on which the touch operation can be performed.

Here, by displaying such message and mark so as to be surrounded by the black display region 4220, the feeling of floating in the air can be obtained.

<<Modification of Air Floating Video Display Apparatus>>

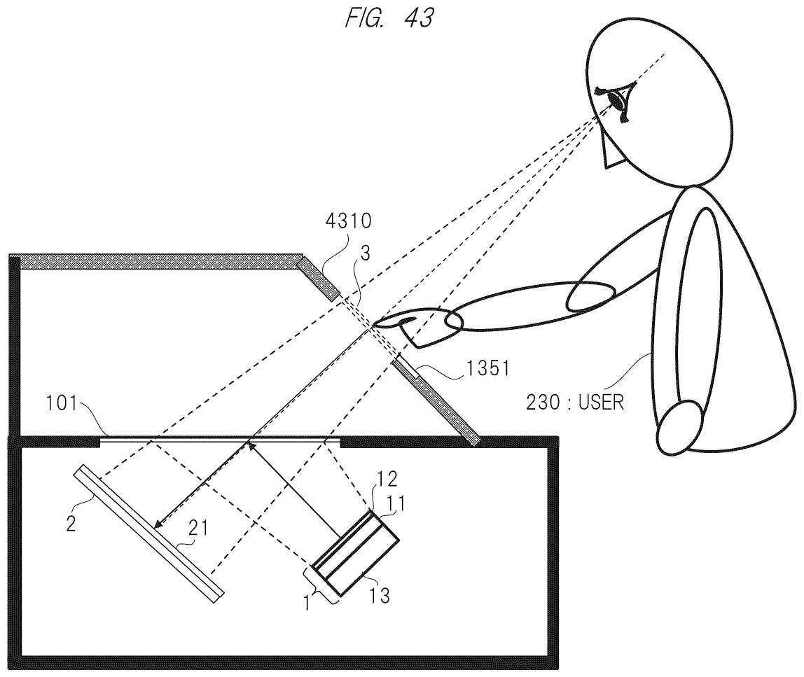

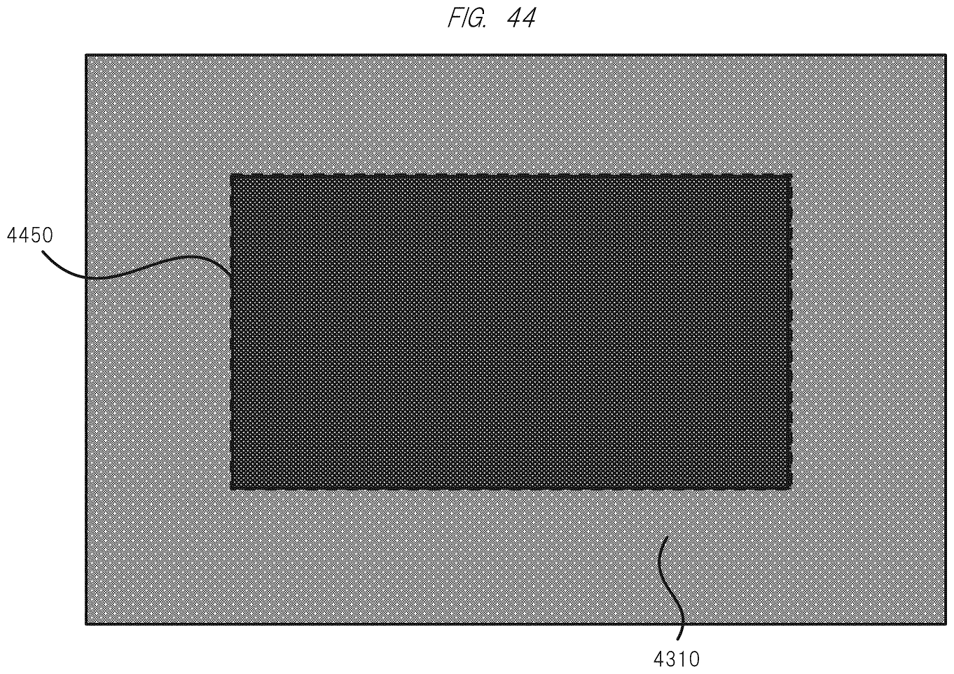

Next, a modification of the air floating video display apparatus will be described with reference to FIG. 43. The air floating video display apparatus of FIG. 43 is a modification of the air floating video display apparatus of FIG. 3A. The same components as those shown in FIG. 3A are denoted by the same reference characters. In the description of FIG. 43, the different points from the components shown in FIG. 3A will be described, and the same components as those shown in FIG. 3A have already been described in FIG. 3A, and thus repetitive descriptions thereof will be omitted.

Here, in the air floating video display apparatus of FIG. 43, the video light from the display apparatus 1 is converted into the air floating video 3 through the polarization separator 101, the λ/4 plate 21, and the retroreflector 2 as in the air floating video display apparatus of FIG. 3A.

Unlike the air floating video display apparatus of FIG. 3A, the air floating video display apparatus of FIG. 43 is provided with a physical frame 4310 formed so as to surround the air floating video 3 from the periphery. Here, in the physical frame 4310, an opening window is provided along the outer periphery of the air floating video 3, and the user can visually recognize the air floating video 3 at the position of the opening window of the physical frame 4310. When the air floating video 3 is rectangular, the shape of the opening window of the physical frame 4310 is also rectangular.

In the example of FIG. 43, the spatial operation detection sensor 1351 is provided in a part of the opening window of the physical frame 4310. The spatial operation detection sensor 1351 can detect the touch operation by the finger of the user on the object displayed in the air floating video 3 as already described with reference to FIG. 3C.

In the example of FIG. 43, the physical frame 4310 has a cover structure configured to cover the polarization separator 101 on the upper surface of the air floating video display apparatus. Note that what is covered by the cover structure is not limited to the polarization separator 101, and the cover structure may be configured to cover the housing part of the display apparatus 1 and the retroreflector 2. However, the physical frame 4310 in FIG. 43 is merely an example of the present embodiment, and does not necessarily have the cover structure.

Here, FIG. 44 shows the physical frame 4310 and the opening window 4450 of the air floating video display apparatus of FIG. 43 when the air floating video 3 is not displayed. At this time, of course, the user cannot visually recognize the air floating video 3.

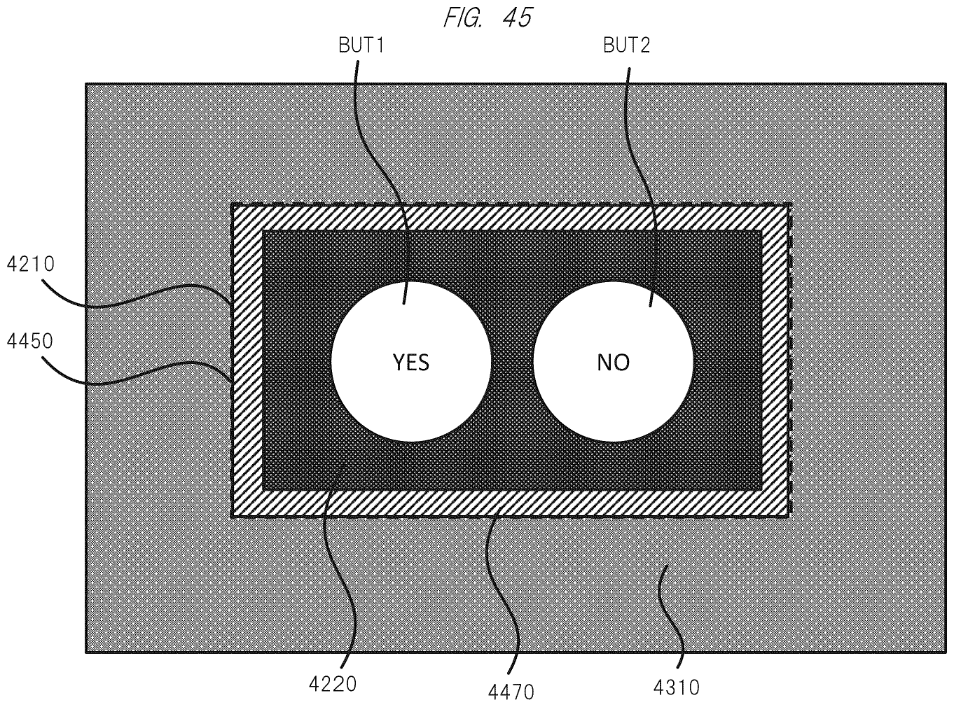

Meanwhile, FIG. 45 shows an example of the configuration of the opening window 4450 of the physical frame 4310 and the display of the air floating video 3 in the air floating video display apparatus of FIG. 43 of the present embodiment. In the example of FIG. 45, the opening window 4450 is configured to substantially match the display range 4210 of the air floating video 3.

Furthermore, in the display example of the air floating video 3 in FIG. 45, for example, an object display similar to that of the example in FIG. 42A is performed. Specifically, objects on which the user can perform the touch operation such as the first button BUT1 and the second button BUT2 are displayed. These objects on which the user can perform the touch operation are surrounded by the black display region 4220, so that the feeling of floating in the air is favorably obtained.

A frame video display region 4470 is provided on the outer periphery surrounding the black display region 4220. The outer periphery of the frame video display region 4470 is the display range 4210, and the edge of the opening window 4450 of the air floating video display apparatus is arranged so as to substantially match the display range 4210.

Here, in the display example of FIG. 45, the video of the frame of the frame video display region 4470 is displayed in a color similar to the color of the physical frame 4310 around the opening window 4450. For example, if the physical frame 4310 is white, the video of the frame of the frame video display region 4470 is also displayed in white. If the physical frame 4310 is gray, the video of the frame of the frame video display region 4470 is also displayed in gray. For example, if the physical frame 4310 is yellow, the video of the frame of the frame video display region 4470 is also displayed in yellow.

In this way, the video of the frame of the frame video display region 4470 is displayed in the color similar to the color of the physical frame 4310 around the opening window 4450, so that the spatial continuity between the physical frame 4310 and the video of the frame of the frame video display region 4470 can be emphasized and conveyed to the user.

In general, users can spatially recognize physical configurations more adequately than air floating videos. Therefore, by displaying the air floating video so as to emphasize the spatial continuity of the physical frame as in the display example of FIG. 45, the user can more adequately recognize the depth of the air floating video.

Furthermore, in the display example of FIG. 45, objects on which the user can perform the touch operation, for example, the air floating videos of the first button BUT1 and the second button BUT2 are formed on the same plane as the frame video display region 4470, and thus the user can more adequately recognize the depth of the first button BUT1 and the second button BUT2 based on the depth recognition of the physical frame 4310 and the frame video display region 4470.

Namely, according to the display example of FIG. 45, both the feeling of floating in the air and the recognition of the depth position of the object displayed in the air floating video 3 can be achieved more adequately. In addition, it is possible to easily recognize the depth position of the object displayed in the air floating video 3 more adequately than the display example of FIG. 42A.

Also in the display example of FIG. 45, a mark such as an arrow pointing to an object on which the user can perform the touch operation may be displayed as in the display example of FIG. 42B.

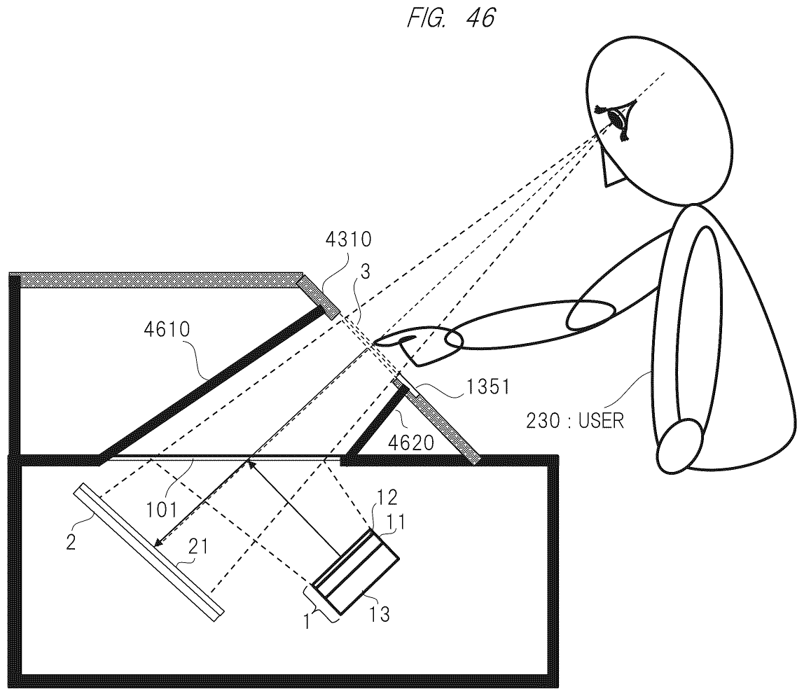

As a modification of the configuration of the air floating video display apparatus of FIG. 43, a light blocking plate 4610 and a light blocking plate 4620 having a black surface with low light reflectance may be provided inside the cover structure of the physical frame 4310 as shown in FIG. 46. By providing the light blocking plates in this way, even if the user looks into the interior of the air floating video display apparatus through the opening window, it is possible to prevent the user from visually recognizing components or the like unrelated to the air floating video 3. As a result, it is possible to prevent the occurrence of the case in which a real object unrelated to the air floating video 3 is visually recognized behind the black display region 4220 in FIG. 42A or the like, making it difficult to visually recognize the air floating video 3. Moreover, the generation of stray light based on the air floating video 3 can also be prevented.

Here, the light blocking plate 4610 and the light blocking plate 4620 form a hollow quadrangular prism corresponding to the rectangle of the air floating video 3, and may be configured to extend from the vicinity of the opening window of the air floating video display apparatus to the housing part of the display apparatus 1 and the retroreflector 2. In addition, in consideration of the divergence angle of light and securing of the degree of freedom of the viewpoint of the user, the configuration in which the opposing light blocking plates form non-parallel truncated quadrangular pyramid and extend from the vicinity of the opening window of the air floating video display apparatus to the housing part of the display apparatus 1 and the retroreflector 2 is also possible. In this case, the truncated quadrangular pyramid has a shape that gradually spreads as it extends from the vicinity of the opening window of the air floating video display apparatus toward the housing part of the display apparatus 1 and the retroreflector 2.

Note that the cover structure and the light blocking plates shown in FIG. 46 may be used also in the air floating video display apparatus that performs the display other than the display example shown in FIG. 45. Namely, it is not always necessary to display the frame video display region 4470. If the physical frame 4310 of the cover structure of the air floating video display apparatus is arranged so as to surround the display range 4210 of the air floating video 3, it can contribute to the improvement in the recognition of the depth position of the displayed object even when the frame video display region 4470 is not present in FIG. 45.

In the foregoing, various embodiments have been described in detail, but the present invention is not limited only to the above-described embodiments, and includes various modifications. For example, in the above-described embodiments, the entire system has been described in detail so as to make the present invention easily understood, and the present invention is not necessarily limited to that including all the configurations described above. Also, part of the configuration of one embodiment may be replaced with the configuration of another embodiment, and the configuration of one embodiment may be added to the configuration of another embodiment. Furthermore, another configuration may be added to part of the configuration of each embodiment, and part of the configuration of each embodiment may be eliminated or replaced with another configuration.

In the technique according to the present embodiment, by displaying the high-resolution and high-luminance video information in the air floating state, for example, the user can operate without feeling anxious about contact infection of infectious diseases. If the technique according to the present embodiment is applied to a system used by an unspecified number of users, it will be possible to provide a non-contact user interface that can reduce the risk of contact infection of infectious diseases and can eliminate the feeling of anxiety. In this way, it is possible to contribute to “Goal 3: Ensure healthy lives and promote well-being for all at all ages” in the Sustainable Development Goals (SDGs) advocated by the United Nations.

In addition, in the technique according to the present embodiment, only the normal reflected light is efficiently reflected with respect to the retroreflector by making the divergence angle of the emitted video light small and aligning the light with a specific polarized wave, and thus a bright and clear air floating video can be obtained with high light utilization efficiency. With the technique according to the present embodiment, it is possible to provide a highly usable non-contact user interface capable of significantly reducing power consumption. In this way, it is possible to contribute to “Goal 9: Build resilient infrastructure, promote inclusive and sustainable industrialization and foster innovation” and “Goal 11: Make cities and human settlements inclusive, safe, resilient and sustainable” in the Sustainable Development Goals (SDGs) advocated by the United Nations.

Further, in the technique according to the present embodiment, an air floating video by video light with high directivity (straightness) can be formed. Thus, since the air floating video is displayed by the video light with high directivity in the technique according to the present embodiment, it is possible to provide the non-contact user interface capable of reducing the risk of someone other than the user looking into the air floating video even when displaying a video requiring high security at an ATM of a bank or a ticket vending machine of a station or a highly confidential video that is desired to be kept secret from a person facing the user. In this way, it is possible to contribute to “Goal 11: Make cities and human settlements inclusive, safe, resilient and sustainable” in the Sustainable Development Goals (SDGs) advocated by the United Nations.

### REFERENCE SIGNS LIST

1 . . . Display apparatus, 2 . . . Retroreflector, 3 . . . Space image (air floating video), 105 . . . Window glass, 100 . . . Transparent member, 101 . . . Polarization separator, 12 . . . Absorptive polarizing plate, 13 . . . Light source apparatus, 54 . . . Light direction conversion panel, 151 . . . Retroreflector, 102, 202 . . . LED substrate, 203 . . . Light guide, 205, 271 . . . Reflection sheet, 206, 270 . . . Retardation plate, 300 . . . Air floating video, 301 . . . Ghost image of air floating video, 302 . . . Ghost image of air floating video, 230 . . . User, 1000 . . . Air floating video display apparatus, 1110 . . . Controller, 1160 . . . Video controller, 1180 . . . Imager, 1102 . . . Video display, 1350 . . . Spatial operation detector, 1351 . . . Spatial operation detection sensor, 1500 . . . Virtual light source, 1510 . . . Virtual shadow, 1610 . . . Input content display region, 1700 . . . Touch pen, 1800 . . . Wearable terminal, 1900 . . . Vibrating plate, 4220 . . . Black display region, 4250 . . . Frame video display region

1. An air floating video display apparatus comprising:
a display apparatus configured to display a video;
a retroreflector configured to reflect video light from the display apparatus and form an air floating video in air by the reflected light;
a sensor configured to detect a position of a finger of a user who performs a touch operation on one or more objects displayed in the air floating video; and
a controller,
wherein the controller controls video processing on the video displayed on the display apparatus based on the position of the finger of the user detected by the sensor, thereby displaying a virtual shadow of the finger of the user on a display plane of the air floating video having no physical contact surface.

2. The air floating video display apparatus according to claim 1,
wherein, when a position of a tip of the finger of the user changes in a normal direction on a front side of the display plane of the air floating video as viewed from the user, a position of a tip of the virtual shadow displayed in the air floating video changes in a left-right direction in the display plane of the air floating video.

3. The air floating video display apparatus according to claim 2,
wherein the position of the tip of the virtual shadow displayed in the air floating video in the left-right direction in the display plane of the air floating video changes linearly with respect to the change of the position of the tip of the finger of the user in the normal direction.

4. The air floating video display apparatus according to claim 1, comprising:
an imager configured to capture an image of hands or arms of the user,
wherein, when the finger of the user who performs the touch operation on one or more objects displayed in the air floating video is a finger of a right hand, the virtual shadow is displayed at a position on a left side of a tip of the finger as viewed from the user in the air floating video, and
wherein, when the finger of the user who performs the touch operation on one or more objects displayed in the air floating video is a finger of a left hand, the virtual shadow is displayed at a position on a right side of a tip of the finger as viewed from the user in the air floating video.

5. The air floating video display apparatus according to claim 1,
wherein the controller detects a position of a tip of the finger in the display plane of the air floating video and a height position of the tip of the finger with respect to the display plane by using the sensor configured to detect the position of the finger of the user.

6. The air floating video display apparatus according to claim 1,
wherein whether or not the finger of the user has touched the display plane of the air floating video is detected by a sensor different from the sensor configured to detect the position of the finger of the user.

7. The air floating video display apparatus according to claim 1,
wherein a position of the virtual shadow displayed on the display plane of the air floating video is specified from a positional relationship between a position of a virtual light source and the position of the finger of the user detected by the sensor.

8. The air floating video display apparatus according to claim 7,
wherein the position of the virtual light source is set such that a virtual light source installation angle defined as an angle between a normal line extending from a center point of the display plane of the air floating video toward a user side and a line connecting the virtual light source and the center point of the display plane of the air floating video is 20° or more.

9. The air floating video display apparatus according to claim 1,
wherein an angle of an extending direction of the virtual shadow displayed on the display plane of the air floating video changes along with an angle of the finger of the user captured by an imager provided in the air floating video display apparatus.

10. The air floating video display apparatus according to claim 1,
wherein an angle of an extending direction of the virtual shadow displayed on the display plane of the air floating video is a fixed angle without changing along with an angle of the finger of the user captured by an imager provided in the air floating video display apparatus.

11. An air floating video display apparatus comprising:
a display apparatus configured to display a video;
a retroreflector configured to reflect video light from the display apparatus and form an air floating video in air by the reflected light;
a sensor configured to detect a touch operation of a finger of a user on one or more objects displayed in the air floating video; and
a controller,
wherein, when the user performs the touch operation on the object, the controller assists the touch operation for the user based on a detection result of the touch operation by the sensor.

12. The air floating video display apparatus according to claim 11,
wherein the air floating video includes an input content display region for displaying a content input by the touch operation at a position different from the object.

13. The air floating video display apparatus according to claim 11,
wherein, when the object is touched, the touched object is deleted, and a replacement object showing a content corresponding to the touched object is displayed.

14. The air floating video display apparatus according to claim 11,
wherein, when the object is touched, the touched object is lit.

15. The air floating video display apparatus according to claim 11,
wherein, when the object is touched, the touched object is blinked.

16. The air floating video display apparatus according to claim 11,
wherein the user performs the touch operation by using a touch input device, and the touch input device is vibrated when the object is touched.

17. The air floating video display apparatus according to claim 11,
wherein a terminal that the user wears is vibrated when the object is touched.

18. The air floating video display apparatus according to claim 17,
wherein the terminal is a wearable terminal.

19. The air floating video display apparatus according to claim 17,
wherein the terminal is a smartphone.

20. The air floating video display apparatus according to claim 11,
wherein, when the object is touched, a control signal for vibrating a vibrating plate arranged at feet of the user is output from a communication unit provided in the air floating video display apparatus.

21. An air floating video display apparatus comprising:
a display apparatus configured to display a video; and
a retroreflection plate configured to reflect video light from the display apparatus and form an air floating video in air by the reflected light,
wherein a display range of the air floating video includes a region in which an object is displayed, a black display region arranged so as to surround the region in which the object is displayed, and a frame video display region arranged so as to surround the black display region.

22. The air floating video display apparatus according to claim 21,
wherein the black display region is a region in which video information having luminance is not present in a display video of the display apparatus corresponding to the air floating video.

23. The air floating video display apparatus according to claim 21, comprising:
a sensor configured to detect a position of a finger of a user who performs a touch operation on the object.

24. The air floating video display apparatus according to claim 23,
wherein a message indicating that the touch operation on the object is possible is displayed near the object.

25. The air floating video display apparatus according to claim 24,
wherein a mark pointing to the object is displayed in addition to the message.

26. The air floating video display apparatus according to claim 21, comprising:
a physical frame arranged so as to surround the air floating video.

27. The air floating video display apparatus according to claim 26,
wherein the frame video display region is displayed in a color similar to a color of the physical frame.

28. The air floating video display apparatus according to claim 26,
wherein the physical frame forms an opening window of a cover structure that covers a housing part in which the display apparatus and the retroreflection plate are accommodated.

29. The air floating video display apparatus according to claim 28,
wherein a light blocking plate extending from a vicinity of the opening window to the housing part in which the display apparatus and the retroreflection plate are accommodated is provided in the cover structure.

30. The air floating video display apparatus according to claim 29,
wherein the light blocking plate forms a hollow quadrangular prism.

31. The air floating video display apparatus according to claim 29,
wherein the light blocking plate forms a truncated quadrangular pyramid.

32. The air floating video display apparatus according to claim 31,
wherein the truncated quadrangular pyramid has a shape that gradually spreads as it extends from the vicinity of the opening window toward the housing part in which the display apparatus and the retroreflection plate are accommodated.

33. An air floating video display apparatus comprising:
a display apparatus configured to display a video;
a retroreflection plate configured to reflect video light from the display apparatus and form an air floating video in air by the reflected light; and
a physical frame arranged so as to surround the air floating video,
wherein the physical frame forms an opening window of a cover structure that covers a housing part in which the display apparatus and the retroreflection plate are accommodated, and
wherein a light blocking plate extending from a vicinity of the opening window to the housing part in which the display apparatus and the retroreflection plate are accommodated is provided.

34. The air floating video display apparatus according to claim 33,
wherein the light blocking plate forms a hollow quadrangular prism.

35. The air floating video display apparatus according to claim 33,
wherein the light blocking plate forms a truncated quadrangular pyramid.

36. The air floating video display apparatus according to claim 35,
wherein the truncated quadrangular pyramid has a shape that gradually spreads as it extends from the vicinity of the opening window toward the housing part in which the display apparatus and the retroreflection plate are accommodated.
